(19) United States
(12) Patent Application Publication
(10) Pub. No.: US 2007/0228922 A1
(43) Pub. Date: Oct. 4, 2007

(54) Electron gun and electron beam apparatus field of invention

(76) Inventor: Mamora Nakasuji, Yokohama-shi (JP)

Correspondence Address: Mamoru Nakasuji, 2-15-11, Serigaya-chou, Yokohama-shi, omitted

(21) Appl. No.: 11/703,406

(22) Filed: Feb. 8, 2007

(30) Foreign Application Priority Data
Mar. 29, 2006 (JP) 2006-119800
Jul. 26, 2006 (JP) 2006-224699

(51) Int. Cl. H01J 29/00

(52) U.S. Cl. 313/364

(57) ABSTRACT

For three types of the electron gun the brightness larger than Langmuir limit or the very high Emittance is obtained through a simulation. The first electron gun consists of a concave cathode and a convex anode, and for the gun with the cathode radius of Rc (mm) the emission current Ie (A) which give the brightness larger than Langmuir limit is in the range as,

0.733Rc−0.5≦Ie≦0.159Rc³+0.35. Rc≦2.5 mm, or

0.733Rc−0.5≦Ie≦0.255Rc³−1.17. Rc>2.5 mm.

The second electron gun consist of a flat cathode and a convex anode, and for the gun with a distance between the cathode and the anode of Dac (mm) the emission current Ie (mA) which give the brightness larger than Langmuir limit or the very high Emittance is in the range as,

0.388/Dac−0.046≦Ie≦92.8/Dac+9.28, Dac≧3 mm, or

0.388/Dac−0.046≦Ie≦22/Dac+32.7, Dac<3 mm.

The third electron gun consists of a flat cathode and a flat anode, and for the gun with a cathode radius of Rc (μm) the emission current Ie (mA) which give the brightness larger than Langmuir limit or the very high Emittance is in the range as,

0.4+0.0064Rc≦Ie≦0.116Rc (Rc≦120 μm), or

0.4+0.0064Rc≦Ie≦10.5+0.0296Rc (Rc>120 μm).

### FIELD OF INVENTION

This invention pertains to an electron gun which gives very high Emittance and very high brightness characteristics. This invention also pertains to an electron beam apparatus with the same electron gun. The apparatus include a defect detection apparatus which detect defects on a semiconductor wafers by irradiating an electron beam to a finely patterned wafer, detecting SE signal from the patterns, and forming image data.

### BACKGROUND OF INVENTION

The semiconductor manufacturing process is the era of 45 nm design rule. The production form is shifting from the small item mass production represented by DRAM to the multi item small production like SOC (Silicon on chip). According to this, the number of manufacturing process is increasing, improvement in yield in every process is essential, and an inspection of a defect which is generated in the process become very important.

According to the higher integration of a semiconductor device and the finer patterning, an inspection system of high resolution and high throughput is required. In order to check a defect on a wafer substrate of 45 nm design rule, it is necessary to inspect a pattern defect in the pattern having the line width of 40 nm and less, and further to inspect a defect of a particle. Further, it is necessary to check the electrical defect thereof. According to an increase in the manufacturing process accompanying the higher integration of a device, the amount of inspection is increased. A higher throughput is accordingly required. Further, tendency toward multilayer of a device is accelerated, an inspection system is required to have a function of detecting a contact failure (electrical defect) of a via connecting wire between layers.

In these circumstances, for the high throughput inspection system which has multiple beams around an optical axis is proposed. (Mamoru Nakasuji et al, Jpn. J. Appl., Phys., Vol 44, No. 7B 2005, p 5570). For such multiple beam system, not only high brightness, but also high Emittance electron gun is required.

Further, the electron gun for an ERL radiation optical source, a very high brightness and large beam current electron gun is required. (Nishitani et al, Extended Abstracts (The 53rd Spring Meeting, 2006); The Japanese Society of Applied Physics No. 2, p 798)

Further, it is believed that there is the maximum brightness named Langmuir limit. The maximum current density Jmax is represented as follows,

Jmax=Jc(1+eφ/kT)sin² α, (-2)

wherein Jc is the cathode current density. Therefore the maximum brightness Bmax is

Bmax=Jmax/π sin² α=Jc(1+eφ/kT)/π (-1)

### For example, Jc=10 A/cm², and φ=4500 V, as e=1.6×10⁻¹⁹, and k=1.38×10¹²³, are added to eq. (-1), then Bmax=9.23×10⁴ A/cm²sr.

However, these equation is satisfied only when the electron gun obey to an optical model. When the electron gun is not satisfy the optical model, said brightness limit is not right. That is to say, the electron gun which deviates largely from the optical model can give a much larger brightness than Langmuir limit.

### SUMMARY OF THE INVENTION

It is a purpose of this invention to obtain the electron gun with high Emittance and high brightness beams. To obtain such beams, an electron gun consists of a circular and flat cathode, a convex and spherical anode or beam drawing electrode, and a truncated cone wehnelt.

In the former electron gun, said wehnelt is designed as follows, suppose a first cone which has a top at a cross point an optical axis and the anode surface and a bottom coincide with the cathode edge, and a second cone whose cone angle is 69.4 degrees larger than that of the first cone. Outside the second cone the wehnelt in this invention is deposited.

In the former electron gun, the wehnelt cone angle is larger than that of the second cone.

In the former electron gun, the cathode radius is larger than 15 μm and smaller than 960 μm and an emission current is controlled in the following range;

0.0136Rc−0.3≧Ie≧0.111Rc−1.05, where 15≦Rc≦120 μm,

0.0226Rc−1.7≦Ie≦0.0332Rc+8.1, where 120<Rc≦480 μm, or

0.007Rc+5.9≦Ie≦0.0332Rc+8.1, where 480<Rc.

wherein Ie is the emission current (mA), Rc is the cathode radius. For above condition the high Emittance or the high brightness is obtained.

When the high brightness is required for the electron gun, the emission current is controlled in the following range;

0.0196Rc−0.5≧Ie≧0.111Rc−1.05, where 15≦Rc≦120 μm, or

0.0294Rc−1.3≦Ie≦0.0332Rc+8.1, where 120<Rc.

When the high Emittance is required for the electron gun, the emission current is controlled in the following range;

0.0136Rc−0.3≦Ie≦0.103Re−1.1, where 15≦Rc≦120 μm

0.0226Rc−1.7≦Ie≦0.0322Rc+6.8, where 120<Rc≦480 μm, or

0.007Rc+5.9≦Ie≦0.0191Rc+13.2, where 480<Rc.

In an apparatus where plural apertures are irradiated by the electron beam emitted from said electron gun, a sample surface is scanned by multiple electron beams shaped by said plural apertures, and secondary electrons (SEs) emitted from said scanned points are magnified by magnification electron optics and focused on detectors and obtaining information of said surface.

An electron gun consist of a disk cathode, wehnelt, an anode or beam drawing electrode, wherein the beam diameter decrease monotonically from the cathode surface to a front surface of the anode or the beam drawing electrode, and wherein trajectories started normally from the central part of the cathode don't cross to an optical axis from the cathode to a minimum beam diameter.

An electron gun consist of a concave spherical cathode of which radius of curvature is Rcc, a convex anode or beam drawing electrode of which radius of curvature is Rac, wherein a distance from the cathode to the anode: Dac satisfy the following relation; that is, Dac<Rcc<Dac+Rac, or 1.125Dac≦Rcc≦0.833(Dac+Rac), further consists of wehnelt with truncated double cone shape, and the cathode side cone radius is smaller at the cathode side and the anode side cone is smaller at the anode side.

The electron gun with above electrodes, the emission current Ie (A) is controlled in the range as,

0.733Rc−0.5≦Ie≦0.159Rc³+0.35, where Rc≦2.5 mm, or

0.733Rc−0.5≦Ie≦0.255Rc³−1.17, where Rc>2.5 mm.

When the high Emittance is also required, the emission current is controlled in the range as,

0.132R³−0.059≦Ie≦0.159Rc³+0.35, where Rc≦2.5 mm, or

0.132R³−0.059≦Ie≦0.255Rc³−1.17, where Rc>2.5 mm.

When the emission current is required to be small value, the emission current is controlled in the range as,

0.733Rc−0.5≦Ie≦0.132R³−0.059

An electron gun consist of a photo cathode whose work function is Φw, wherein said cathode is excited by the laser beam and wherein

hλ/C−Φw≦0.2 eV.

An electron gun consist of a disk cathode a flat anode or a beam drawing electrode and a wehnelt, wherein the emission current Ie is controlled in the range as follows,

0.4+0.0064Rc≦Ie≦0.116Rc, where Rc≦120 μm, or

0.4+0.0064Rc≦Ie≦10.5+0.0296Rc, where Rc>120 μm,

and wherein an electric field between the cathode and the anode is from 1.6 to 5.53 kV/mm.

An electron gun consist of disk cathode, an anode or a beam drawing electrode, wherein an aperture is deposited backside of the anode or the beam drawing electrode and it traps more than 70 percent of the emission current.

An electron gun consist of disk cathode, an anode or a beam drawing electrode, wherein the anode hole size is smaller than the beam size at the anode hole position, and the alignment between the wehnelt and the anode is estimated by the transmission efficiency of the anode.

An electron gun consist of a photo cathode with a negative electron affinity, a flat anode or a beam drawing electrode, truncated cone shape wehnelt, wherein the emission current: Ie (mA) is controlled in the range as,

0.5+0.0098Rc≦Ie≦2.3+0.026Rc.

wherein Rc is the cathode radius (μm).

In the same electron gun, said cathode is flat or convex or concave spherical shape whose radius of curvature is larger than 1.5 mm, and wherein the cathode radius is from 20 to 500 μm, and a distance from the cathode to the anode is from 0.8 to 3 mm.

An electron gun consists of a photo cathode, a wehnelt, and an anode or a beam drawing electrode, wherein the emission current Ie is decided as

Ie≧1.4+0.019Rc,

### Wherein Rc is the cathode radius (μm), and wherein an electric field between the cathode and the anode is larger than 1.6 kV/mm.

An electron beam control method comprising,

emitting electron from an electron gun with a disk cathode, a wehnelt, and a flat anode or beam drawing electrode, irradiating aperture by said emitted electron, scanning on a surface of the sample by a beam passed through said aperture, obtaining information of the specimen, wherein depositing two stage lenses between said electron gun and the aperture, controlling irradiating current density at said aperture not making crossover between said first lens and said aperture.

An electron beam controlling method comprising, irradiating a photocathode with laser beam of which wavelength is λ, cooling said photocathode, controlling the emission current Ie as a range,

0.0107Rc≦Ie≦0.06Rc, wherein

hλ/C−Φw≦0.1 eV.

An electron gun with a high Emittance or a high brightness beams. To obtain such beams, an electron gun consists of a disk cathode, a convex spherical anode or a beam drawing electrode, and a truncated cone wehnelt, wherein; the emission current Ie (mA) is controlled in the following range;

0.388/Dac−0.046≦Ie≦92.8/Dac+9.28, where Dac≧3 mm, or

0.388/Dac−0.046≦Ie≦22/Dac+32.7, where Dac<3 mm.

When the beam current is required to be small value,

0.388/Dac−0.046≦Ie≦17.8/Dac−1.51.

### When very high brightness is required and the high Emittance is also required,

17.8/Dac−1.51≦I≦92.8/Dac+9.28, where Dac≧3 mm, or

17.8/Dac−1.51≦Ie≦22/Dac+32.7, where Dac<3 mm.

### When the emission current Ie is controlled in the following range, very high Emittance is obtained, as

0.388/Dac−0.046≦Ie≦117/Dac−8.35, where Dac≧4 mm, or

0.388/Dac−0.046≦Ie≦12/Dac+17.8, where Dac<4 mm.

### When the beam current is required to be small value,

0.388/Dac−0.046≦Ie≦17.3/Dac−1.99,

### When very high Emittance is required and the high brightness is also required,

17.3/Dac−1.99≦Ie≦117/Dac−8.35, where Dac≧4 mm, or

17.3/Dac−1.99≦Ie≦12/Dac+17.8, where Dac<4 mm.

To obtain the brightness larger than Langmuir limit, an electron gun in this invention consist of a flat cathode, a flat anode, and a truncated cone wehnelt, wherein an emission current is controlled in the range as follows;

0.7+0.0144Rc≦Ie≦0.064Rc, and wherein Ie is mA, and Rc is μm.

And wherein, said cathode radius is from 20 to 500 μm.

An electron gun consists of a photo cathode with a negative electron affinity, a flat anode or a beam drawing electrode, and a truncated cone wehnelt, an emission current is controlled in the range as follows;

0.5+0.0098Rc≦Ie≦2.3+0.026Rc, where said Ie is mA and Rc is μm,

and wherein said cathode is convex sphere of which radius of curvature is larger than 1.5 mm, or a convex sphere of which radius of curvature is larger than 1.5 mm.

To obtain the brightness larger than Langmuir limit, an electron gun in this invention consist of, a disc cathode, a flat anode or a beam drawing electrode, and a truncated cone wehnelt, wherein the electric field formed between the cathode and the anode or the beam drawing electrode is the range from 1.6 to 5.53 kV/mm.

To obtain the brightness larger than Langmuir limit, the electron gun in this invention consist of, a disc cathode, a flat anode or a beam drawing electrode, and a truncated cone wehnelt, wherein the cathode radius is in the range from 20 μm to 500 μm, and the distance between the cathode and the anode is the range from 0.8 to 3 mm.

To obtain the brightness larger than Langmuir limit, an electron gun in this invention consist of a disc cathode, a flat anode or a beam drawing electrode, and a truncated cone wehnelt, wherein the angle difference between the wehnelt and the beam edge is a range from 69.4 to 93.2 degrees, where the beam edge is defined a cone which has a top at a cross point between an optical axis and the anode surface and a bottom coincide with the cathode edge.

To obtain the brightness larger than Langmuir limit, an electron gun in this invention consist of a flat cathode, a flat anode, a truncated cone wehnelt, and further comprising a lens, and the brightness is controlled by adjusting said lens excitation voltage or ampere turns.

An electron gun consists of a photo cathode, a wehnelt, an anode or beam drawing electrode, wherein the emission current Ie (mA) is controlled as,

0.5+0.0098Rc≦Ie≦2.4+0.026Rc,

and wherein a electric field between the anode and the cathode is larger than 1.6 kV/mm, and the cathode radius is from 20 to 500 μm.

In an apparatus where a plural apertures are irradiated by the electron beam emitted from said electron gun, a sample surface is scanned by a multiple electron beams shaped by said multiple apertures, and secondary electrons (SEs) emitted from said scanned points are magnified by a magnification electron optics and focused on detectors and obtaining information of said surface, further comprising two condenser lenses between the electron gun and the multiple aperture, no crossover is formed between the 1^{st} condenser lens and the multiple aperture is formed, and the current density at the multiple aperture is adjustable, and further comprising a magnetic objective lens, whose lens gap is the specimen side, said lens gap is formed by the inner pole and the outer pole, the inner pole is made of high saturation magnetic flux density material, said outer pole is made of high permeability magnetic material, and at connection part for these two magnetic pole the outer pole have ring shape projection, and the one surface of said projection contact with the inner magnetic pole and the other surface is the acceptance for the O-ring, and the O-ring acceptance surface is better when said surface is concave to the O-ring side. As a result, the magnetic resistance at the connection part for two magnetic poles become small and an axial magnetic field distribution have a single peak, and then no parasitic aberration generates.

An electron gun consists of a photo cathode, a flat anode or a beam drawing electrode, truncated cone shape wehnelt, wherein the emission current: Ie (mA) is controlled in the range as,

0.0107Rc≦Ie≦0.06Rc,

wherein Rc is the cathode radius (μm).

### BRIEF DESCRIPTION OF THE DRAWINGS

FIG. 1 is a schematic electron gun model in this invention.

FIG. 2 is a comparison of simulated results for this invention and for the conventional electron gun.

FIG. 3 is an electron optics for the multiple beams with two optical axis offset.

FIG. 4 is a detailed figure of only the primary optics of FIG. 3, wherein the optical axis offset and two deflections are neglected.

FIG. 5 is a detailed figure of only the secondary optics of FIG. 3, wherein the optical axis offset and three deflections are neglected.

FIG. 6 is simulated results for the electron gun with a spherical beam drawing electrode, where cathode radius is parameter.

FIG. 7 is simulated results for 30 μm cathode radius electron gun, where a wehnelt angle is varied.

FIG. 8 is simulated results of the case where the cathode is not flat but concave with a 5 mm radius of curvature.

FIG. 9 is simulated electron beam trajectories, where the radial scale is magnified. (A) is a typical case where the conventional electron gun with a convex cathode.
(B) is the beam trajectory for the electron gun with a convex beam drawing electrode and 100 μm radius concave and 5 mm radius of curvature cathode.

FIG. 10 is a real model for FIGS. 2, 6, 7 and 8, where the beam drawing electrode is convex spherical.

FIG. 11 is a second preferred embodiment for the electron gun with a spherical beam drawing electrode and a concave cathode.

FIG. 12 is simulated comparison between Pierce type and non Pierce type electron guns.

FIG. 13 is the brightness vs. Emittance curves and the brightness vs. cathode current density curves for the simulated results of FIG. 12, wherein the brightness is 10⁴ A/cm²sr and the Emittance is μmrad, and the cathode current density is A/cm².

FIG. 14 is a simulated result for the model in FIG. 11, wherein a cathode radius: Rc is varied.

FIG. 15 is the brightness vs. Emittance curves and the brightness vs. cathode current density curves for the simulated results of FIG. 14, wherein the brightness is 10⁵ A/cm²sr and the Emittance is μmrad, and the cathode current density is A/cm².

FIG. 16 is a simulated result for the model in FIG. 11, wherein the cathode temperature is 300 K and the laser photon energy minus photocathode work function is 0.2 eV, and wherein the cathode radius: Rc is varied.

FIG. 17 is the brightness vs. Emittance curves and the brightness vs. cathode current density curves for the simulated results of FIG. 16, wherein the brightness is 10⁵ A/cm²sr and the Emittance is μmrad, and the cathode current density is A/cm².

FIG. 18 is electron beam trajectories for the Pierce type electron gun and electrons are started ±45 degree from the normal to the surface.

FIG. 19 is the electron beam trajectories for the non Pierce type electron gun and the electrons are started ±45 degree from the normal to the surface.

FIG. 20 is the electron beam trajectories for the non Pierce type electron gun and the electrons are started normal to the surface, wherein the cathode temperature is 300 K and the laser photon energy minus photocathode work function is 0.2 eV

FIG. 21 is comparison between the electron gun with a convex beam drawing electrode and the conventional convex cathode electron gun, wherein the cathode temperature is 300 K and the laser photon energy minus photocathode work function is 0.2 eV, and wherein the cathode radius: Rc is varied.

FIG. 22 is the brightness vs. Emittance curves and the brightness vs. cathode current density curves for the simulated results of FIG. 21, wherein the brightness is 10⁵ A/cm²sr and the Emittance is μmmrad, and the cathode current density is A/cm².

FIG. 23 is simulated results for the model in FIG. 11, wherein the cathode temperature is 300 K and laser photon energy minus photocathode work function is 0.2 eV, and wherein the wehnelt angle is varied.

FIG. 24 is the brightness vs. Emittance curves and the brightness vs. cathode current density curves for the simulated results of FIG. 23, wherein the brightness is 10⁵ A/cm²sr and the Emittance is μmmrad, and the cathode current density is A/cm².

FIG. 25 is the simulated result for the model in FIG. 11, wherein the cathode temperature is 1800 K and the cathode work function is 2.35 eV, and wherein the cathode radius is varied.

FIG. 26 is the brightness vs. Emittance curves and the brightness vs. cathode current density curves for the simulated results of FIG. 25, wherein the brightness is 10⁵ A/cm²sr and the Emittance is μmmrad, and the cathode current density is A/cm².

FIG. 27 is the simulated results for the model in FIG. 11, wherein the distance between the cathode and the anode is 1 mm, and wherein the cathode radius is varied.

FIG. 28 is the brightness vs. Emittance curves and the brightness vs. cathode current density curves for the simulated results of FIG. 27.

FIG. 29 is the simulated result for the model in FIG. 11, wherein the distance between the cathode and the anode is 3 mm, and wherein the cathode radius is varied.

FIG. 30 is the brightness vs. Emittance curves and the brightness vs. cathode current density curves for the simulated results of FIG. 29, wherein the brightness is 10⁵ A/cm²sr and the Emittance is μmmrad, and the cathode current density is A/cm².

FIG. 31 is the emission current which give the maximum brightness or the maximum Emittance as a function of Rc.

FIG. 32 is the emission currents which give the maximum brightness or the maximum Emittance as a function of Rc, where Rc is smaller than 120 μm.

FIG. 33 is the simulated result for the model in FIG. 11, wherein the cathode radius is 15 μm, and the distance between the anode and the cathode: Dac is varied.

FIG. 34 is the brightness vs. Emittance curves and the brightness vs. cathode current density curves for the simulated results of FIG. 33, wherein the brightness is 10⁵ A/cm²sr and the Emittance is μmmrad, and the cathode current density is A/cm².

FIG. 35 is the simulated results for the model in FIG. 11, wherein the cathode radius is 960 μm, and the distance between the anode and the cathode: Dac is varied.

FIG. 36 is the brightness vs. Emittance curves and the brightness vs. cathode current density curves for the simulated results of FIG. 35, wherein the brightness is 10⁵ A/cm²sr and the Emittance is μmmrad, and the cathode current density is A/cm².

FIG. 37 is the simulated result for the model in FIG. 11, wherein the cathode radius is 120 μm, and the distance between the anode and the cathode: Dac is varied.

FIG. 38 is the brightness vs. Emittance curves and the brightness vs. cathode current density curves for the simulated results of FIG. 37, wherein the brightness is 10⁵ A/cm²sr and the Emittance is μmmrad, and the cathode current density is A/cm².

FIG. 39 is the emission currents which give the maximum brightness or the maximum Emittance as a function of 1/Dac.

FIG. 40 is the emission currents which give the maximum brightness or the maximum Emittance as a function of 1/Dac, wherein the emission current is smaller than 8 mA.

FIG. 41 is a schematic electron gun model in the second invention.

FIG. 42 is the simulated results of the model in FIG. 41, wherein the cathode radius is varied.

FIG. 43 is the brightness vs. Emittance curves and the brightness vs. cathode current density curves for the simulated results of FIG. 42.

FIG. 44 is the electron beam trajectories for the case when the brightness is smaller than Langmuir limit.

FIG. 45 is the electron beam trajectories for the case when the brightness is larger than Langmuir limit.

FIG. 46 is an electron gun model with an electrostatic lens.

FIG. 47 is the simulated result for the model in FIG. 46, wherein a lens exciting voltage is varied.

FIG. 48 is the brightness vs. Emittance curves and the brightness vs. cathode current density curves for the simulated results of FIG. 47, wherein the brightness is 10⁵ A/cm²sr and the Emittance is μmmrad, and the cathode current density is A/cm².

FIG. 49 is the electron beam trajectories for the case when the brightness is larger than Langmuir limit, and a positive voltage is applied in the electrostatic lens.

FIG. 50 is the electron beam trajectories for the case when the brightness is larger than Langmuir limit, and a negative voltage is applied in the electrostatic lens.

FIG. 51 is the simulated result for the model in FIG. 46, wherein a wehnelt angle is varied.

FIG. 52 is the brightness vs. Emittance curves and the brightness vs. cathode current density curves for the simulated results of FIG. 51.

FIG. 53 is the simulated result for the model in FIG. 46, wherein the cathode radius: Rc is varied, and wherein the brightness is 10⁵ A/cm²sr and the Emittance is μmmrad, and the cathode current density is A/cm².

FIG. 54 is the brightness vs. Emittance curve and the brightness vs. cathode current density curve for the simulated results of FIG. 53, wherein the brightness is 10⁵ A/cm²sr and the Emittance is μmmrad, and the cathode current density is A/cm².

FIG. 55 is the simulated result for the model in FIG. 46, wherein the distance from the cathode to the anode: Dac is varied.

FIG. 56 is the brightness vs. Emittance curves and the brightness vs. cathode current density curves for the simulated results of FIG. 55, wherein the brightness is 10⁵ A/cm²sr and the Emittance is μmmrad, and the cathode current density is A/cm².

FIG. 57 is the simulation result of the model in FIG. 1, wherein the cathode temperature is varied.

FIG. 58 is the brightness vs. Emittance curves and the brightness vs. cathode current density curves for the simulated results of FIG. 57, wherein the brightness is 10⁵ A/cm²sr and the Emittance is μmmrad, and the cathode current density is A/cm².

FIG. 59 is the simulated results of the model in FIG. 46, wherein a magnetic lens is added at the position of the electrostatic lens, and lens exciting AT is varied.

FIG. 60 is the brightness vs. Emittance curves and the brightness vs. cathode current density curves for the simulated results of FIG. 59.

FIG. 61 is the electron beam trajectories for the case when the brightness is larger than Langmuir limit, and the magnetic lens is operated.

FIG. 62 is an electron gun model with the photocathode in this invention.

FIG. 63 is electron optics with a high brightness electron gun in this invention.

FIG. 64 is a primary electron optics with the high brightness electron gun in this invention.

FIG. 65 is the simulated result of the model in FIG. 46, wherein the cathode radius of curvature is varied.

FIG. 66 is the brightness vs. Emittance curves and the brightness vs. cathode current density curves for the simulated results of FIG. 65, wherein the abscissa is brightness (10⁵ A/cm²sr) and the ordinate is the Emittance (μmmrad), or the cathode current density (A/cm²).

FIG. 67 is the simulated results of the gun with the photo cathode, wherein the cathode radius is varied.

FIG. 68 is the brightness vs. Emittance curves and the brightness vs. cathode current density curves for the simulated results of FIG. 67, wherein the abscissa is the brightness (10⁵ A/cm²sr) and the ordinate is an Emittance (μmmrad), or the cathode current density (A/cm²).

FIG. 69 is the simulated result of the gun with the photo cathode, wherein the cathode radius is varied and Dac is 2.5 mm.

FIG. 70 is the brightness vs. Emittance curves and the brightness vs. cathode current density curves for the simulated results of FIG. 69, wherein the abscissa is the brightness (10⁵ A/cm²sr) and the ordinate is the Emittance (μmmrad), or cathode current density (A/cm²).

FIG. 71 is the simulated results of the gun with the photo cathode, wherein the cathode radius is varied and Dac is 0.8 mm.

FIG. 72 is the brightness vs. Emittance curves and the brightness vs. cathode current density curves for the simulated results of FIG. 71, wherein the abscissa is the brightness (10⁵ A/cm²sr) and the ordinate is the Emittance (μmmrad), or the cathode current density (A/cm²).

FIG. 73 is the simulated result of the gun with the photo cathode, wherein the cathode radius is varied and Dac is 2.5 mm, wherein the brightness is 10⁵ A/cm²sr and the Emittance is μmmrad, and the cathode current density is A/cm², and wherein said cathode is cooled to a 77 degree Kelvin.

FIG. 74 is the brightness vs. Emittance curves and the brightness vs. cathode current density curves for the simulated results of FIG. 73, wherein the abscissa is the brightness (10⁵ A/cm²sr) and the ordinate is the Emittance (μmmrad), or the cathode current density (A/cm²).

FIG. 75 is the relationship between the cathode work function and the photo electron limiting wavelength.

FIG. 76 is the simulated result of the beam trajectories for the normal brightness.

FIG. 77 is the simulated result of the beam trajectories for the high brightness.

FIG. 78 is the simulated result of the beam trajectories for the very high brightness.

FIG. 79 is the simulated result of the gun, wherein the cathode temperature is 1800 K, the lens excitation is 12.5 kV, the Dac is 2.5 mm, and the cathode work function is 2.35 eV, the wehnelt angle: θw is 90.5 degree, and the cathode radius is varied.

FIG. 80 is the brightness vs. Emittance curves and the brightness vs. cathode current density curves for the simulated results of FIG. 79, wherein the abscissa is the brightness (10⁵ A/cm²sr) and the ordinate is the Emittance (μmmrad), or the cathode current density (A/cm²).

FIG. 81 is the simulated result of the electron gun, wherein the cathode radius Rc is varied, and the distance between the cathode and the anode: Dac is 0.8 mm.

FIG. 82 is the brightness vs. Emittance curves and the brightness vs. cathode current density curves for the simulated results of FIG. 81, wherein the abscissa is the brightness (10⁵ A/cm²sr) and the ordinate is an the Emittance (μmmrad), or the cathode current density (A/cm²).

FIG. 83 is the simulated result of the electron gun with a small aperture at a back surface of the anode, wherein the cathode radius Rc is varied and the distance between the cathode and the anode: Dac is constant and 2.5 mm.

FIG. 84 is the brightness vs. Emittance curves and the brightness vs. cathode current density curves for the simulated results of FIG. 83, wherein the abscissa is the brightness (10⁵ A/cm²sr) and the ordinate is the Emittance (μmmrad), or the cathode current density (A/cm²).

FIG. 85 is the emission currents which give the maximum brightness as a function of the cathode radius.

FIG. 86 is an objective lens model.

FIG. 87 is the simulated results of the gun in FIG. 11, wherein the distance between the cathode and the anode: Dac is constant: 5 mm and the cathode radius Rc is varied from 1.5 mm to 3 mm with a increment of 0.5 mm.

FIG. 88 is the brightness vs. Emittance curves and the brightness vs. cathode current density curves for the simulated results of FIG. 87, wherein the abscissa is the brightness (10⁵ A/cm²sr) and the ordinate is the Emittance (μmrad), or the cathode current density (A/cm²).

FIG. 89 is the simulation result of the gun in FIG. 11, wherein the distance between the cathode and the anode: Dac is constant: 3 mm and the cathode radius Rc is varied from 1 mm to 3 mm with a increment of 0.5 mm.

FIG. 90 is the brightness vs. Emittance curves and the brightness vs. cathode current density curves for the simulated results of FIG. 89, wherein the abscissa is the brightness (10⁵ A/cm²sr) and the ordinate is the Emittance (μmrad), or the cathode current density (A/cm²).

FIG. 91 is the simulated result of the gun in FIG. 11, wherein the distance between the cathode and the anode: Dac is constant: 4 mm and the cathode radius Rc is varied from 1.5 mm to 3 mm with a increment of 0.5 mm.

FIG. 92 is the brightness vs. Emittance curves and the brightness vs. cathode current density curves for the simulated results of FIG. 91, wherein the abscissa is the brightness (10⁵ A/cm²sr) and the ordinate is the Emittance (μmrad), or the cathode current density (A/cm²).

FIG. 93 is the emission currents which give the maximum brightness or the maximum Emittance as a function of the cathode radius, for the Dac of 5 mm.

FIG. 94 is the emission currents which give the maximum brightness as a function of the (cathode radius)³: Rc³ for the Dac of 3 and 4 mm.

FIG. 95 is the simulated results of the electron gun with a small aperture at the backside of the anode, wherein the brightness is 10⁵ A/cm²sr and the Emittance is μmmrad, and the cathode current density is A/cm².

FIG. 96 is the brightness vs. Emittance curves and the brightness vs. cathode current density curves for the simulated results of FIG. 95, wherein the abscissa is brightness (10⁵ A/cm²sr) and the ordinate is the Emittance (μmrad), or the cathode current density (A/cm²).

### BRIEF DESCRIPTION OF THE TABLE

Table I is a simulation model for an electron gun.

Table II is an electron gun model which give very high current density beam.

Table III is simulated results for obtaining high Emittance or high brightness; pert 1.

Table IV is results of simulation for obtaining high Emittance or high brightness; pert 2.

Table V is a simulation model for obtaining high brightness beam.

Table VI is an electron gun with an electrostatic lens model for obtaining high brightness beam.

### DETAILED DESCRIPTION OF A PREFERRED EMBODIMENT

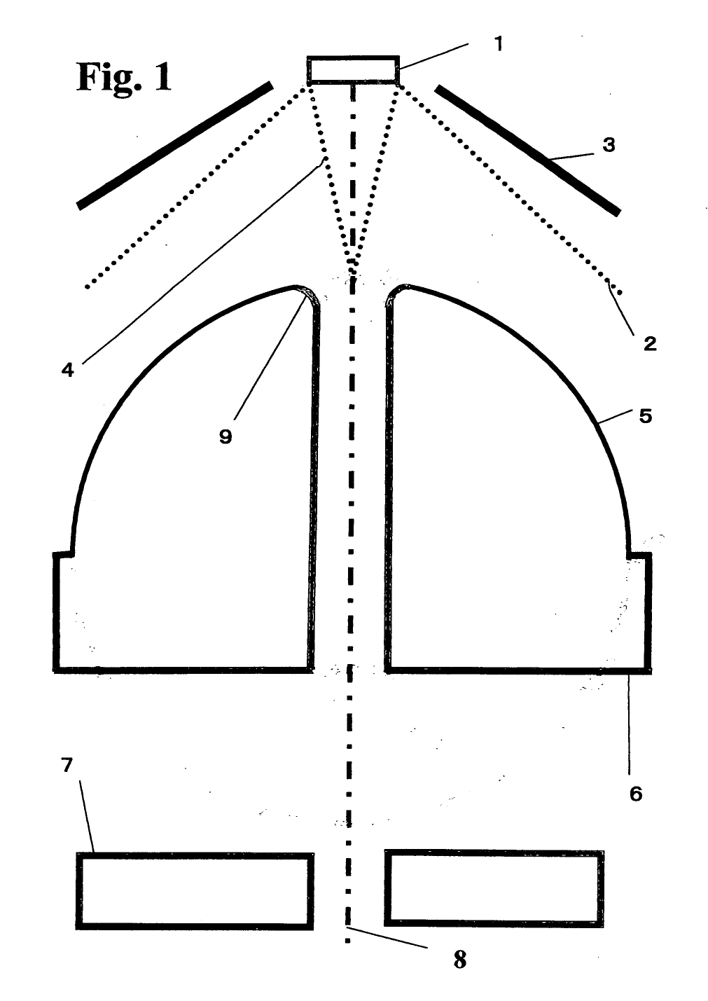

FIG. 1 is a schematic electron gun sectional model in this invention. The beam drawing electrode is a spherical shape. The electron emission area of the cathode 1 is a flat and circular and consists of a low work function material for example LaB6, CeBix, W—ZrO, or a photo cathode. Wehnelt is similar to the conventional truncated cone shape wehnelt, however its size and position is characterized as follows. A cone 4 whose bottom is the cathode edge and its top is the anode position on the optical axis is supposed. And a second cone 2 whose cathode side coincides with the cathode edge and cone angle difference to said supposed cone is 69.4 degrees is also assumed. A real wehnelt 3 is deposited outside of the second assumed cone 2. The cone 4 is approximate to a beam edge. As the real beam edge varies through an emission current variation, a fixed beam edge is assumed as said. Radius difference between the wehnelt and the second cone 2 for the same Z position is the larger for the larger Z position as shown in FIG. 1. A cathode side edge 9 of the beam drawing electrode has a curved surface to avoid break down. The beam drawing electrode 5 have a convex spherical shape whose radius of curvature is 4.4 mm, and 0.28 mm radius hole. An anode side surface of the beam drawing electrode and the anode surface are flat parallel surfaces to minimize an effect of an axial displacement between these two electrodes. The cathode 1 and the wehnelt 3 are centering adjustable before evacuation. The beam drawing electrode 5 have the same centering adjustable mechanism to the wehnelt. Between these three electrodes and the anode are centering adjustable seeing a beam monitor by a fine adjustable mechanism arranged outside of the electron gun.

Table I is an example of an electron gun model 3f.dat for FIG. 1. Simulations are done for this model by using a simulation program: “SOURCE” soled by MEBS company. Conditions for executing “SOURCEA” are also shown bottom of Table 1 as 3f.con. Bold numerals are varied as parameters in table I. Simulations are done as follows.
(1) “SOURCEV” is executed for a fixed wehnelt voltage, and then the cathode current or an emission current Ie is obtained.
(2) “SOURCEA” is executed, and then the cathode current density: Jc, a crossover diameter: Dco, and a crossover position: Zco are obtained.
(3) “SOURCEB” is executed, the brightness as a function of the beam emission angle. A beam emission angle θe for 90% or 110% of the axial brightness are obtained. The Emittance E is calculated as E=Dco×θe.

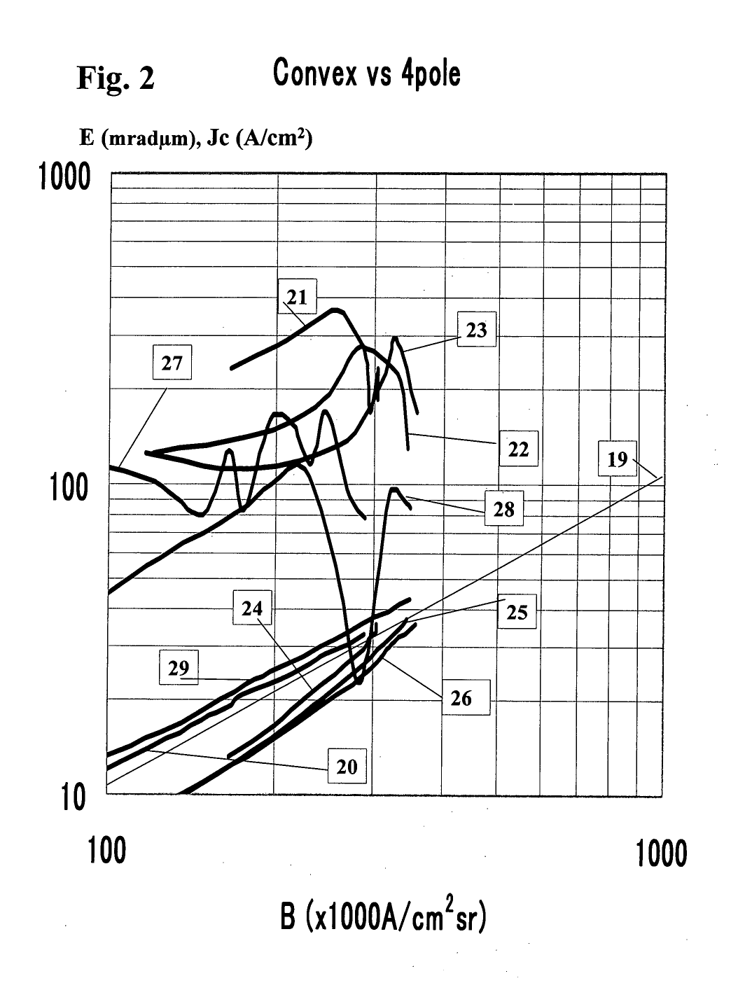

Typical simulated results are shown in FIG. 2 for the model in FIG. 1 and conventional electron guns with the convex anode. Where the anode voltage is 4.5 kV, the cathode voltage is 0 volt, the beam drawing electrode is 7 kV, and the emission current is varied by changing the wehnelt voltage. The brightness varies through changing the emission current. In FIG. 2, the abscissa is the brightness (1000 A/cm²sr), and the ordinate is the Emittance (μmmrad) or the cathode current density (A/cm²). In FIG. 1, the radius of curvature of the beam drawing electrode is 4.4 mm and the distance between the cathode and the beam drawing electrode is 1.5 mm.

The curves 21 and 24 are for the cathode radius of 80 μm, the curves 22 and 25 are for the cathode radius of 40 μm, and the curves 23 and 26 are for the cathode radius of 30 μm, for the electron gun with the convex spherical beam drawing electrode. The curves 20 and 27 are for the conventional electron gun with the convex cathode with the radius of curvature of 30 μm and a flat anode; and the curves 28 and 20 are for the same electron gun with a 15 μm cathode radius of curvature. The curves 21, 22, 23, 27, and 28 are the brightness vs. Emittance curves and the curves 20, 24, 25, 26 and 29 are the brightness vs. cathode current density characteristics. Conventionally, the electron gun characteristics are shown as three curves for the brightness vs. the emission current, the Emittance vs. the emission current, and the cathode current density vs. the emission current. In this figure, so as relationships between the brightness and the Emittance, and the brightness and the cathode current density are clearly seen, these curves are employed.

In the brightness vs. Emittance curves the righter or the upper side curve is the higher performance, and in the brightness vs. cathode current density curve, the righter or the lower curve is the higher performance. From this figure the followings are cleared.
1) The electron gun with the flat cathode and the spherical beam drawing electrode require smaller cathode current density for the same brightness than the electron gun with the convex cathode and the flat anode. This fact is clear through a comparison between curves 20 (30 μm convex cathode), 29 (15 μm convex cathode) and curves 24 (80 μm flat cathode), 25 (40 μm flat cathode), 26 (30 μm flat cathode).
2) The electron gun with the flat cathode and the spherical beam drawing electrode give larger brightness for the same brightness than the electron gun with the convex cathode and the flat anode. This fact is clear through the comparison between the curves 27 (30 μm convex cathode), 28 (15 μm convex cathode) and curves 21 (80 μm flat cathode), 22 (40 μm flat cathode), and 23 (30 μm flat cathode). Especially, for the higher brightness condition (right side in FIG. 2), the electron gun with the flat cathode and the spherical beam drawing electrode give overwhelmingly larger Emittance than the electron gun with the convex cathode and the flat anode.
3) Line 19 is Langmuir limit which is explained later, for 1800 K of the cathode temperature and 4.5 keV of beam energy. The brightness vs. cathode current density curve for the conventional electron gun with the convex cathode and the flat anode is never right side of the line 19. However, the same curve for the electron gun with the flat cathode and the spherical beam drawing electrode is the righter side of the curve 19. This result shows that the electron gun with the flat cathode and the spherical beam drawing electrode is good electron gun.

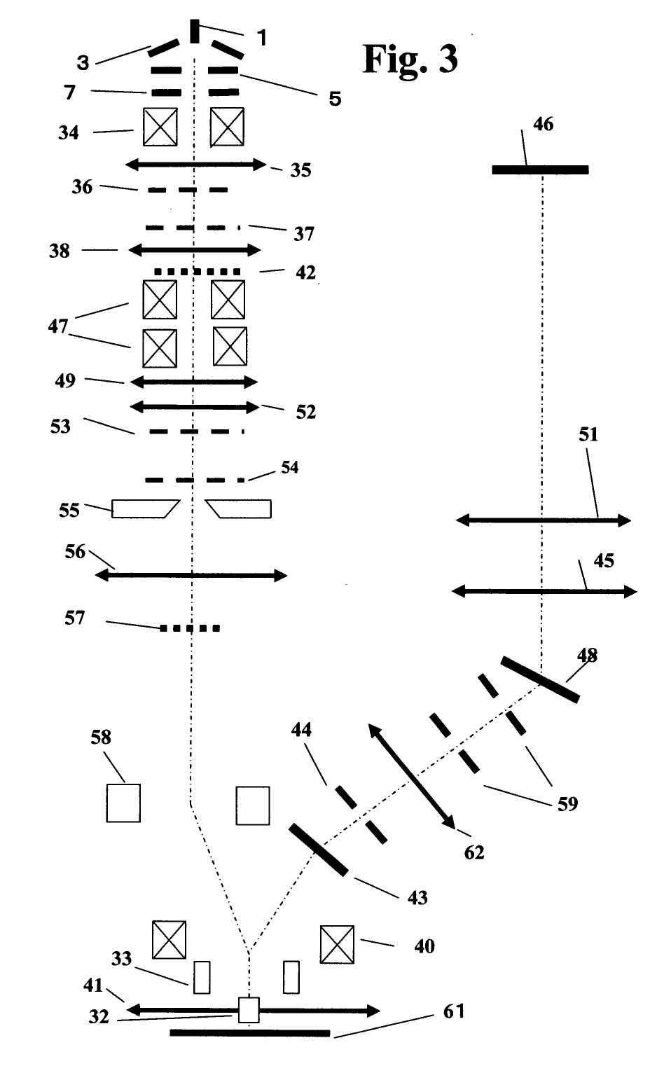

FIG. 3 is the electron optical system using the high brightness and high Emittance electron gun in this invention. The electron optics consists of a primary optics and a secondary optics. At each the primary and the secondary optics there is an optical axis offset from left to right as shown in FIG. 3. By utilizing said high Emittance many multiple beams can be formed around the optical axis. As a matter of course some beams are formed at distant position from the optical axis, then a finer cares are required than a single beam case. The electron gun consists of the cathode 1, the wehnelt 3, the convex spherical beam drawing electrode 5 and the anode 7. The electron beam emitted from the electron gun is aligned to a condenser lens 35 by an alignment deflector 34. The condensed beam by the condenser lens 35 is aligned to a 2^{nd} condenser lens 38 and multiple apertures by 2 stage alignment deflectors 36 and 37. Multiple beams formed by the multiple apertures 42 are reduced by rotation lenses 49 and 52, and aligned to a NA aperture 55 and a reduced lens 56 by the 2 stage deflectors 53 and 54; and form multiple beam images at position 57, where the distance between the NA aperture and the reduced lens 56 is nearly equal to the distance between the lens 56 and the image position 57. The optical axis offset in the primary optics is corrected by an electrostatic deflector 58 and an electromagnetic deflector 40, and the multiple beams enter to an objective lens 41 normally, and irradiate and scan to a specimen surface 61. The scanning to the specimen is done by a scanning signal added to the electrostatic deflectors 58 and 33. A cylindrical electrode 32 is designed for reduce an axial chromatic aberration of the multiple beams and a positive high voltage is applied. The SEs emitted from the scanned specimen is separated from the primary optics by the electromagnetic deflectors 40 and 43 and corrected normal by the electromagnetic deflector 48. The SE images from each multiple beam are magnified by the objective lens 41, the electrostatic lens 62, and two stage lenses 45 and 51; and detected by detectors 46 independently.

The objective lens 41 is an electromagnetic lens with a lens gap at the specimen side and then has the small axial chromatic aberration. By applying the positive high voltage to the cylindrical electrode the axial chromatic aberration is still more reduced.

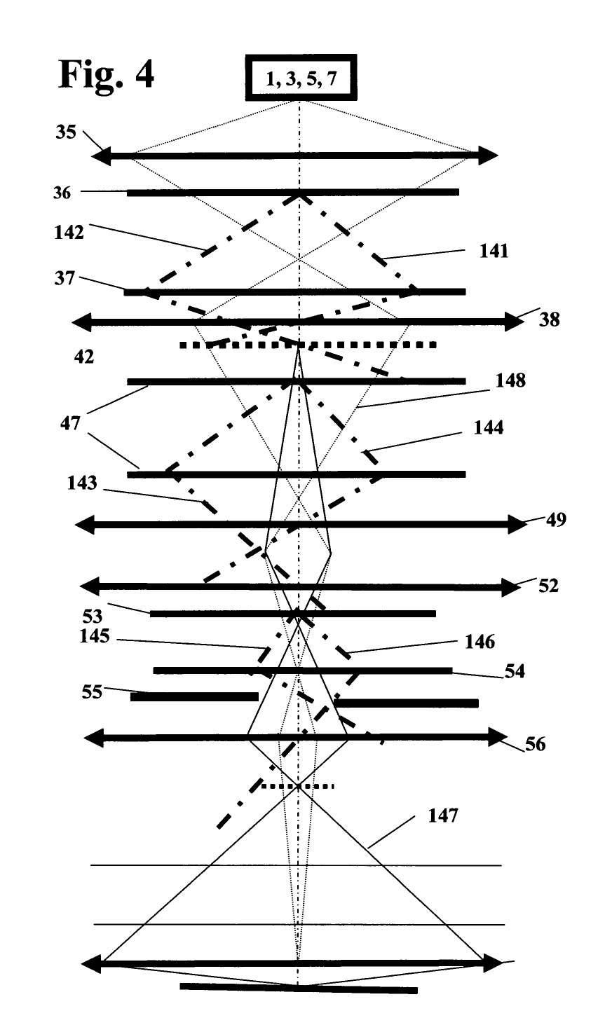

FIG. 4 is a detailed figure of only the primary optics of FIG. 3, wherein the optical axis offset and two deflections are neglected. In FIG. 4, the line 147 is an image line for the multiple apertures, and the line 148 is the image line for the crossover image. The electron beam emitted from the electron gun pass through two stage lenses 35 and 38 and makes a magnified crossover after the multiple apertures 42, and the magnification is adjustable. As a results, the cathode current density at the multiple aperture become large and a uniform irradiation intensity area can be adjustable just cover the multiple apertures area.

The distance between the condenser lens 38 and the multiple apertures 42 is so small that no alignment deflector can be deposited between them. Before the lens 38 two stage deflectors 36 and 37 are designed, and the alignment trajectories 142 or 141 can be selectable, where a deflection pivot of the former trajectory 142 is the multiple apertures and that of the latter trajectory 141 is the lens 38. Therefore, the alignment to the aperture does not change a lens center, and the alignment to the lens does not change the alignment for the aperture.

The rotation adjustable lenses 49 and 52 are deposited so close by that no alignment deflector can be placed between these lenses. Therefore, before these lenses two stage deflectors 47 are designed; and when the trajectory 144 with the deflection pivot at the lens 49 is selected, the alignment to the lens 52 do not change the lens center of the lens 49, and when the trajectory 143 is selected, the alignment to the lens 49 do not change the lens center of the lens 52.

The NA aperture 55 and the reduced lens 56 are deposited close by, before the NA aperture two stage deflectors 53 and 54 are designed, and two trajectories 145 and 146 are selectable. As a results, the alignment to the reduced lens 56 do not change the alignment to the NA aperture, and the alignment to the NA aperture do not change the lens center of the lens 56. Like this, as two optical parts are deposited close by, an optical path become short and then a beam blur due to a space charge effect can be kept small. As two stages of the deflectors are deposited before the two optical parts, the alignment to the two optical parts is easy.

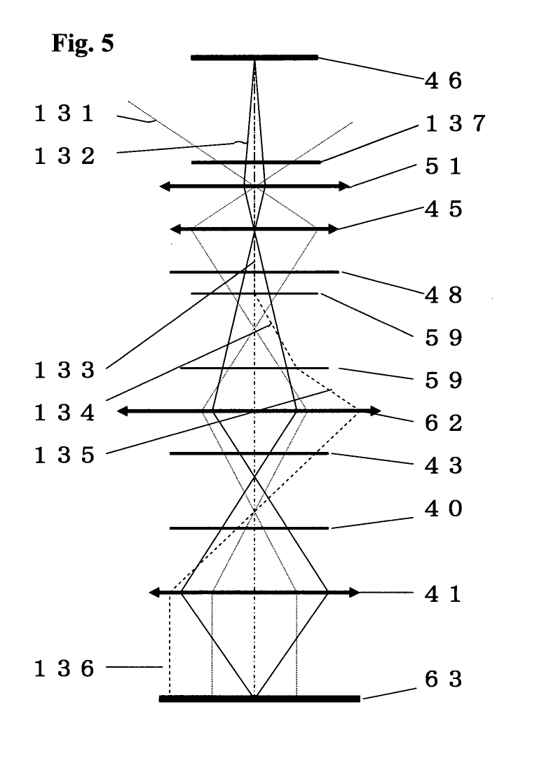

FIG. 5 is a detailed figure of only the secondary optics of FIG. 3, wherein the optical axis offset and the three deflections are neglected. The solid line 132 shows an imaging condition for the SE image. The dotted lines 131 are the trajectory of the SE emitted normally to the specimen surface and the lens excitations are adjusted so that these trajectories cross each other at the principal plane of the final magnification lens 51. As a result, the SE images for the distant multiple beams from the optical axis can be focused to the detectors with a small aberration, and then the SE detection efficient for this SE image are the same as the SE image from the axial beam. Two stage deflectors 59 are designed by the electrostatic deflectors, and deflect the SE synchronized to the primary scanning so that the axis to the detector keep constant and independent to the primary beam scanning. An adjustment of these two stage deflectors is done as follows. The primary beam is fixed at the edge of scanning field. Firstly, a deflection ratio 1 between two deflectors, which satisfy the deflection pivot is the lens 45, and the deflection ratio 2 between two deflectors, which satisfy the deflection pivot is the lens 51 are studied, secondly the lens center for the lens 45 is adjusted by two deflectors 59 keeping the deflection ratio 2, thirdly the lens center for the lens 51 is adjusted by two deflectors 59 keeping the deflection ratio 1. Deflection voltages for two deflectors 59 are decided. For a fixed position in the scanning field the deflection voltage for two deflectors 59 are decided by interpolation of distance from the optical axis. The trajectory after adjustment is shown as the line 134. After the latter deflector 59, the trajectory 134 coincides with the optical axis 133. The deflector 137 is designed after the lens 51, a more precise positioning to the detectors is possible.

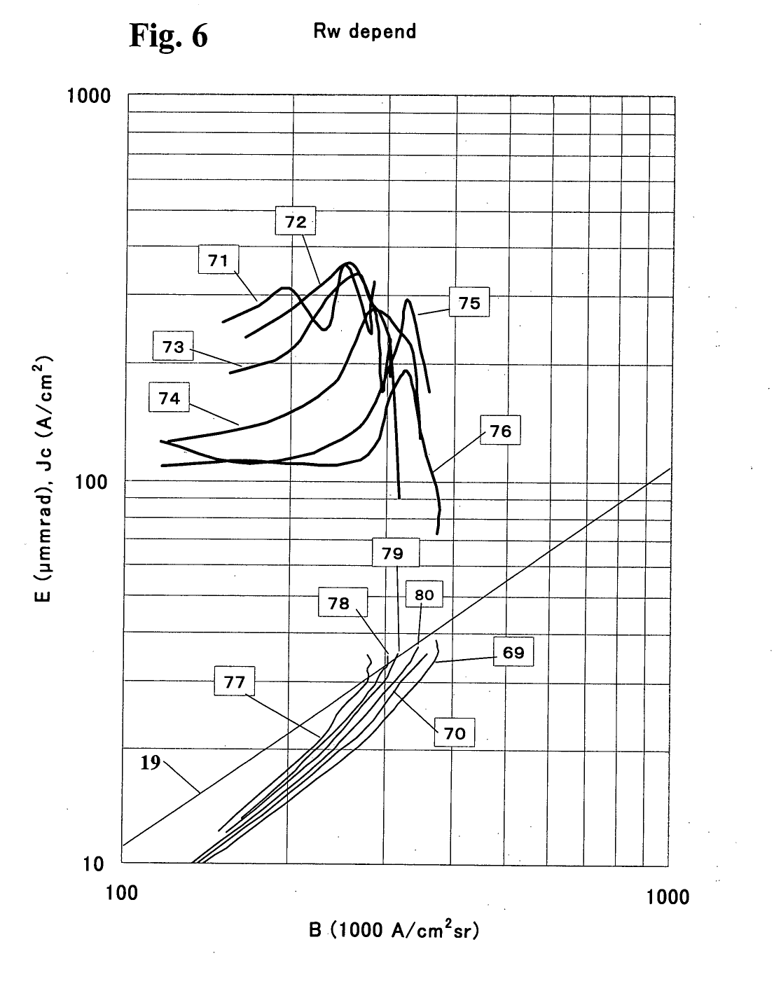

FIG. 6 is the simulated results for the electron gun with the spherical beam drawing electrode, where the cathode radius is parameter. The anode voltage is 4.5 kV, the beam drawing electrode voltage is 7 kV, and the emission current is varied by changing the wehnelt voltage. In FIG. 6, the abscissa is the brightness (1000 A/cm²sr), and the ordinate is the Emittance (μmmrad) or the cathode current density (A/cm²). In FIG. 1, the radius of curvature of the beam drawing electrode is 4.4 mm and the distance between the cathode and the beam drawing electrode is 1.5 mm.

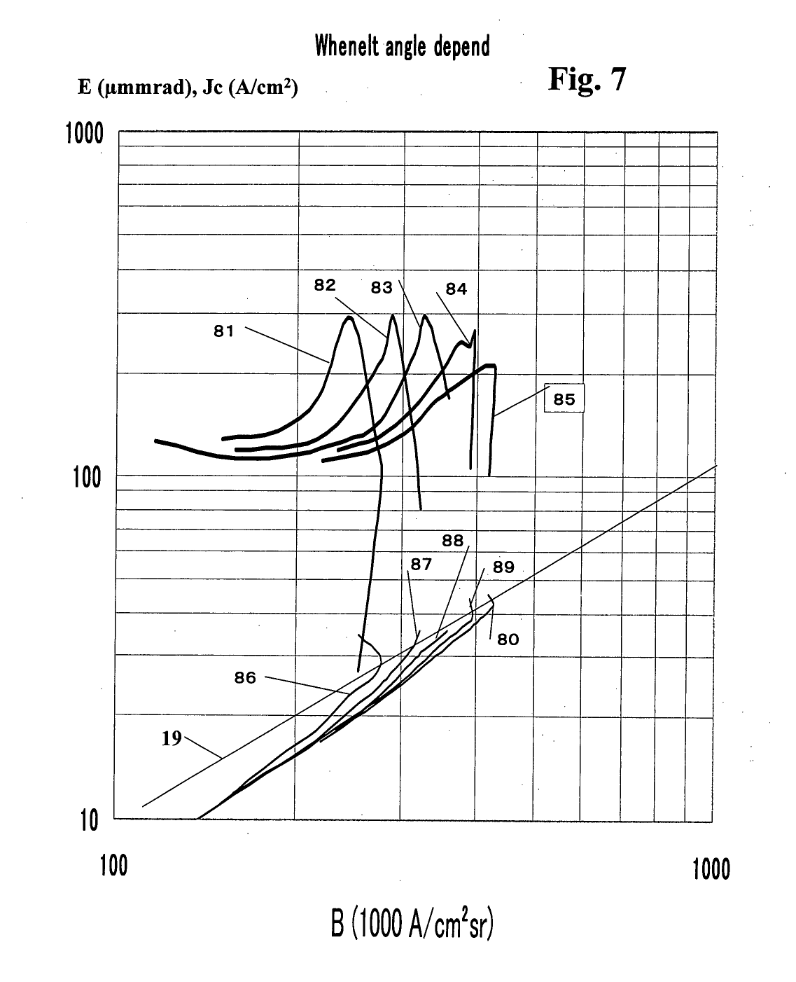

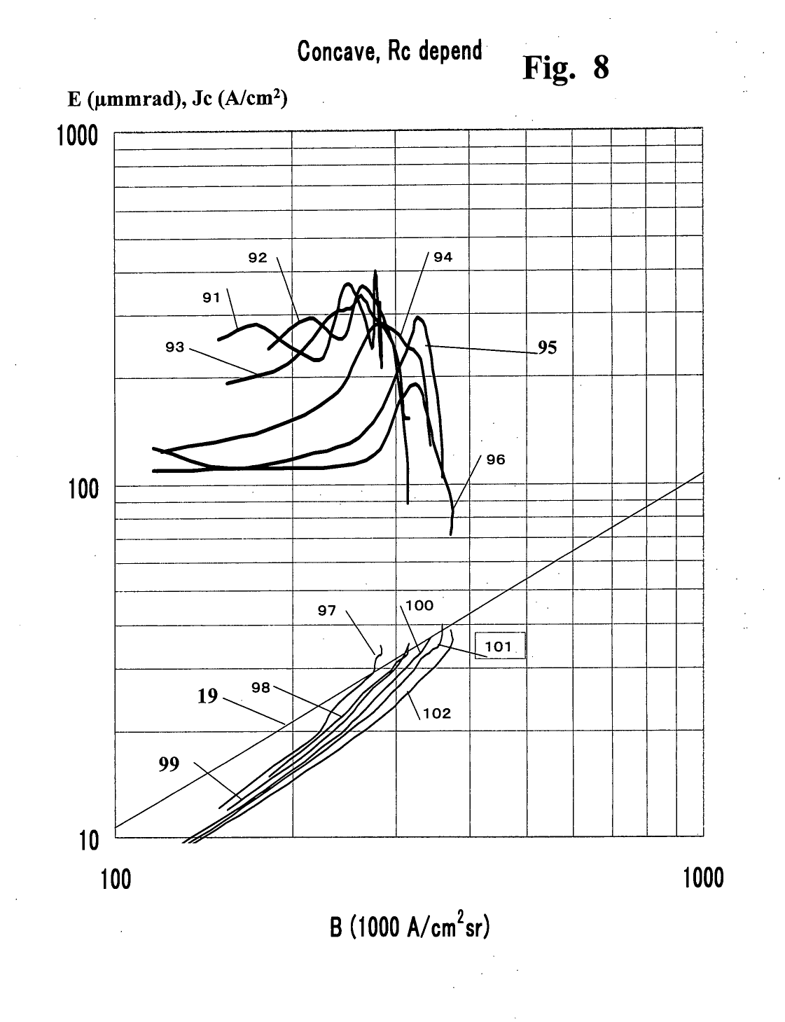

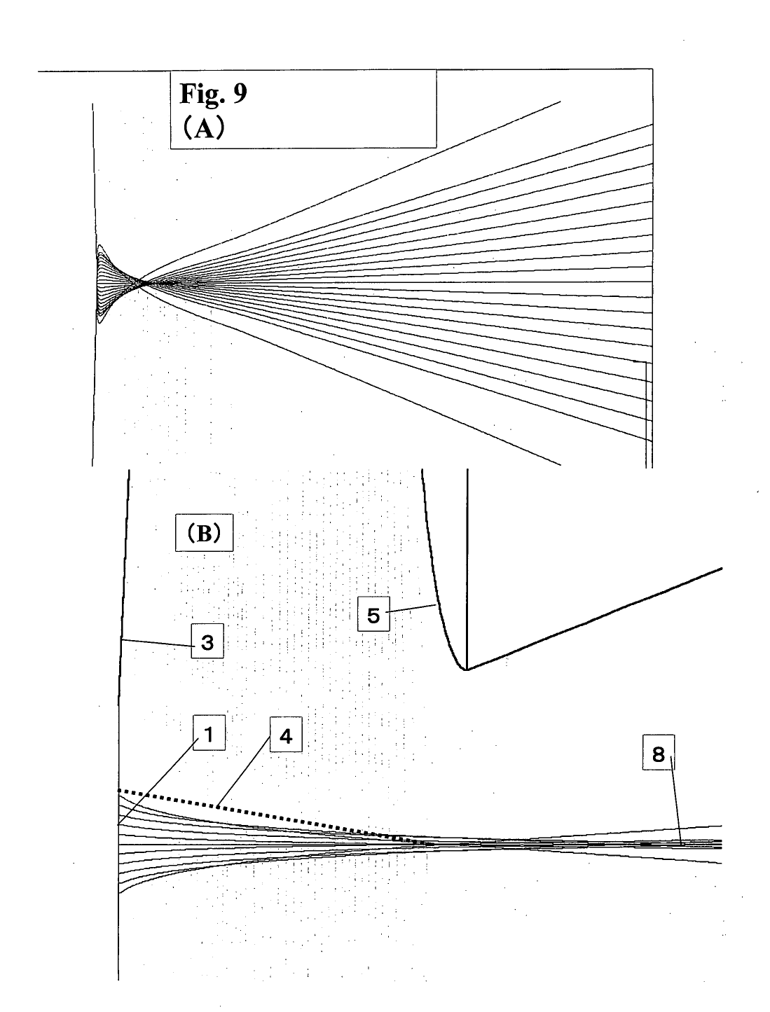

The curves 71 and 77 are for the cathode radius of 100 μm, the curves 72 and 78 are for the cathode radius of 80 μm, the curves 73 and 79 are for the cathode radius of 60 μm, the curves 74 and 80 are for the cathode radius of 40 μm, the curves 75 and 70 are for the cathode radius of 30 μm, the curves 76 and 69 are for the cathode radius of 20 μm, for the electron gun with the convex spherical beam drawing electrode. The upper side curves are the brightness vs. Emittance curves and the lower side curves are the brightness vs. cathode current density characteristics, and these are common for FIG. 2, FIG. 7 and FIG. 8. In these figure the curves 73 and 74 are the brightness vs. Emittance characteristics for 60 and 40 μm cathode radiuses, respectively and; the curves 79, 80, 70 and 69 are the brightness vs. cathode current density characteristics for the 60, 40, 30, and 20 μm radius cathodes, respectively.

When the curves 77, 78, 79, 80, 70, and 69 are seen, it is clear that the smaller cathode radius electron gun have the higher brightness for the constant cathode current density Jc. And the larger cathode radius electron gun has the higher Emittance. Therefore, when the higher brightness is required, the smaller cathode radius is selected, and when the higher Emittance is required, then the larger cathode radius is selected. If we see detail FIG. 6, it is clear that the brightness vs. Emittance curve 75 for the 30 μm cathode radius have 1.5 times larger Emittance than for the same curve 76 for 20 μm cathode radius, and then for the multiple beam the 30 μm radius cathode is clearly better than the 20 μm cathode radius. In the brightness vs. Emittance curves, there is little difference between the curve 71 for the 100 μm cathode radius and the curve 72 for 80 μm cathode radius; and in the brightness B vs. cathode current density Jc curve, the curve 78 for the 80 μm cathode radius require smaller cathode current density than the curve 77 for the 100 μm cathode radius. Therefore, 80 μm cathode radius is better than the 100 μm cathode radius. After all, it is clear that from the 30 μm to 80 μm cathode radius is desirable for the multiple beams, which is important the brightness or the Emittance decide cathode radius.

For a system with small numbers multiple beam or a single beam, the 20 μm radius cathode is desirable, because the brightness curve reach to 3.8×10⁵ A/cm²sr.

FIG. 7 is the simulated result for the 30 μm cathode radius electron gun, where the wehnelt angle is varied. The abscissa, the ordinate, and the brightness variation method are same as in FIG. 2, or FIG. 6. An anode side radial coordinate Rwa of the wehnelt are varied as 8.5, 9.5, 10.5, 11.5, and 12.5 mm, and these results are shown as curves 81 and 86, 82 and 87, 83 and 88, 84 and 89, and 85 and 80, respectively. The angle differences from the supposed cone 4 are 66.5, 68.1, 70.5, 72, 74 degrees respectively. Compare to the angle difference 69.4 degrees which is thought conventionally to be optimum, the Rwa of 8.5 mm is smaller, and the Rwa of 9.5, 10.5, 11.5, and 12.5 mm are larger angle than 69.4 degrees.

It is clear that the larger Rwa has higher brightness in which the Emittance is the maximum, when the curves 81, 82, 83, 84 and 85 are compared. Therefore, the angle difference between the wehnelt and the supposed cone 4 in FIG. 1 is larger than the 69.4 degree which is thought to be optimum, the better performance is obtained. That is to say, for the radius difference between the wehnelt and the supposed cone, the wehnelt where the anode side is larger than the cathode side is better. And, for the Rwa of 12.5 mm, the Emittance is small, however the brightness is large as 4.3×10⁵ A/cm²sr, and then the electron gun is useful for the electron beam system with small number multiple beam or the single beam.

FIG. 8 is the case where the cathode is not flat but concave with 5 mm radius of curvature. The anode side radial coordinates of wehnelt Rwa is fixed to 10.5 mm. The curves 91, 92, 93, 94, 95 and 96; and the curves 97, 98, 99, 100, 101 and 102 correspond to the cathode radius of 100, 80, 60, 40, 30 and 20 μm, respectively. The curves from 91 to 96 are the brightness vs. Emittance characteristics and those from 97 to 102 are the brightness vs. cathode current density characteristics, where the ordinate is the cathode current density (A/cm²). The curve 96 for 20 μm of the cathode radius have smaller Emittance than that for the curve 96 of the 30 μm cathode radius for the same brightness, and then 20 μm cathode radius is no good. From the 30 μm to 100 μm cathode radius the brightness is decrease as increase of the cathode radius, and the Emittance is increasing as the cathode radius increase. Especially, the curve 91 for 100 μm cathode radius the brightness reaches to 400 μmmrad at the brightness of 2.8×10⁵ A/cm²sr. The 20 μm radius cathode is useful in the case where especially, high brightness is required. After all, the electron gun with a concave cathode and a convex beam drawing electrode has good performance where the cathode radius is in the range 20 μm and 100 μm. It will discuss that especially, these electron gun is expected small energy width beam.

FIG. 9 is a simulated electron beam trajectories, where radial scale is magnified. (A) is a typical case where the conventional electron gun with a convex cathode. Fine lines normal to the optical axis is equi-potential surfaces, and these potentials are from the cathode surface as 0, 50, 100, 150, 200, 250, and 300 V, in order. The crossover is formed at position where the potential is 50V. In this case, the cathode current density is large when the beam energy is small yet, then the cross-section of collision is large, and the energy width may become large.

(B) is the beam trajectory for the electron gun with the convex beam drawing electrode of the 100 μm radius concave and 5 mm radius of curvature cathode. Numeral 1 is cathode, 4 is supposed cone which is defined in FIGS. 1, and 5 is the beam drawing electrode. The beam diameter is the maximum at the cathode surface, it decrease until the beam drawing electrode 5, and make a minimum beam radius at backside of the beam drawing electrodes. It is clear from the brightness vs. current density curve that the electron gun with the convex beam drawing electrode has a higher brightness than that for the conventional electron gun for the same cathode current density. Around the cathode the cathode current density is small, where the beam energy is small, the cathode current density become large in the backside of the beam drawing electrode, and where the electrons have a high speed. Therefore, the electron-electron interaction is small and then the energy width may be small. Also, when the cathode is a photo cathode and the difference between the photon energy and the work function of the cathode is smaller than 0.2 eV, then the beam energy width is smaller, because the cathode can be operated at room temperature.

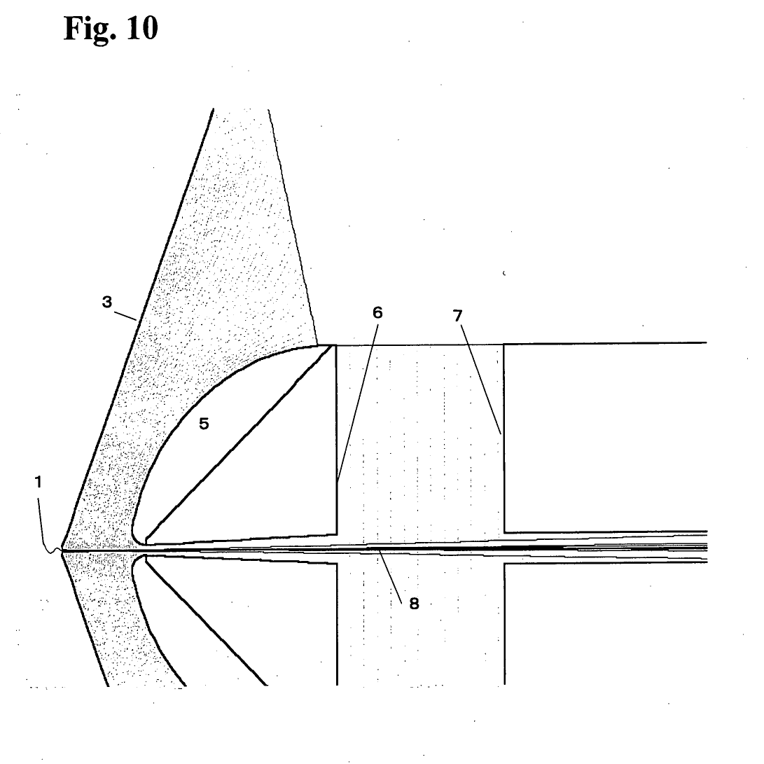

FIG. 10 is the real model for FIGS. 2, 6, 7 and 8, where the beam drawing electrode is spherical. The beam trajectories started normal to the cathode and the equi-potential surfaces are also shown. The simulations are done by “SOURCE” sold by MEBS company, where the cathode temperature is 1800 K, the cathode work function is 2.35 eV, Richardson constant is 43, and the Space charge: on. The position and the shape of the wehnelt and other parameters are shown as follows.

The cathode side wehnelt coordinate Zwc: 0.5 mm=cathode Z position, Rwc: 0.12 mm; the beam drawing electrode side wehnelt coordinate: Zwa: 4.5 mm, Rwa: 10.5 mm, however, in FIG. 7, Rwa varied from 8.5 to 12.5 mm. Mesh numbers are 200 (Z direction) and 60 (R direction). The beam energy is 4.5 keV, the wehnelt voltage is the range from −10 V to −800 V, and the emission current is the range from 0.001 mA to 5 mA, where the wehnelt voltage is varied so that the brightness become to the values shown in the figures. Other electron gun sizes which are not close to the beam characteristics may be estimated from this figure.

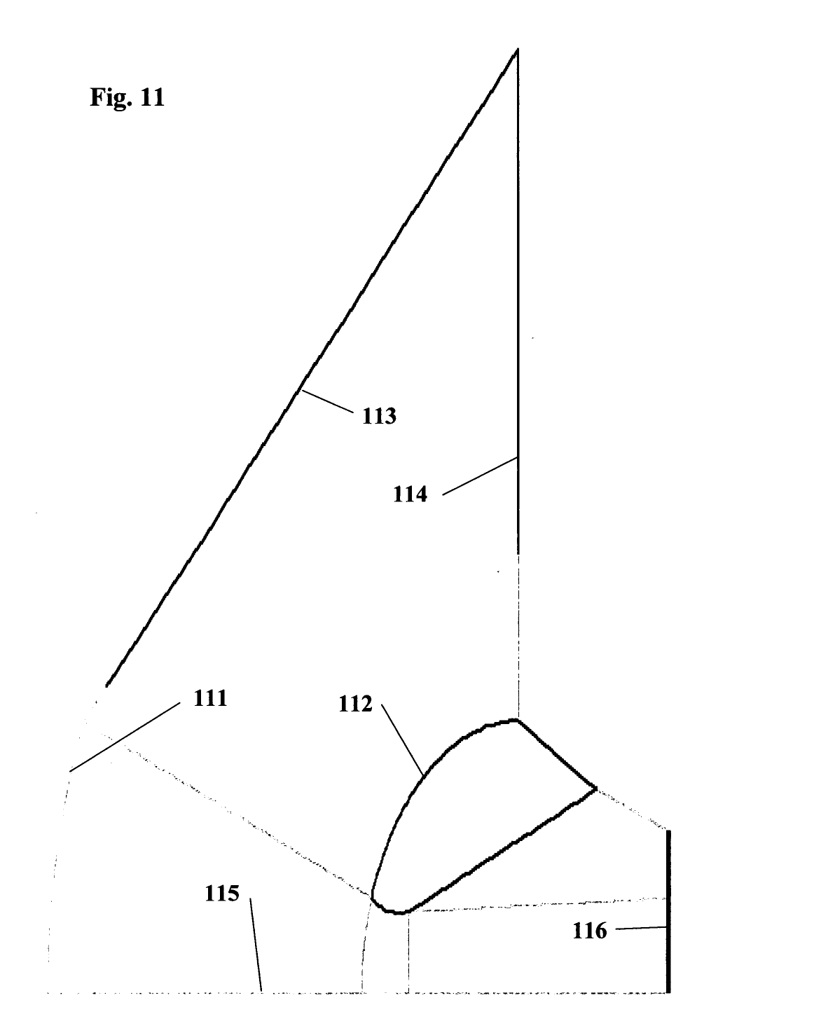

FIG. 11 is a second preferred embodiment for the electron gun with the spherical beam drawing electrode and the concave cathode. This type of the electron gun is an electron source for the X-ray, the high brightness and large current electron gun, or a high brightness and large current electron gun such as an injector for a SOR.

Numeral 111 is the cathode, 112 is the beam drawing electrode, 113 and 114 are wehnelt, 114 is the optical axis, 116 is a target and the electron gun is axially symmetrical around the optical axis. The wehnelt consists of truncated double cone shape, and the cathode side cone is 113 and the anode side cone is 114. Here, the anode side truncated cone is a flat plate, and this is a special case of the truncated cone.

Detail of this model are shown in Table II. The simulation procedure is as follows.
(4) “SOURCEV” is executed for fixed wehnelt voltage and the beam drawing electrode voltage, then the cathode current or the emission current Ie is obtained.
(5) “SOURCEA” is executed, and then the cathode current density Jc, the crossover diameter Dco, and the crossover position Zco is obtained.
(6) “SOURCEB” is executed, the brightness as a function of beam emission angle. The beam emission angle θe for 90% or 110% of axial brightness are obtained. The Emittance E is calculated as E=Dco×θe.

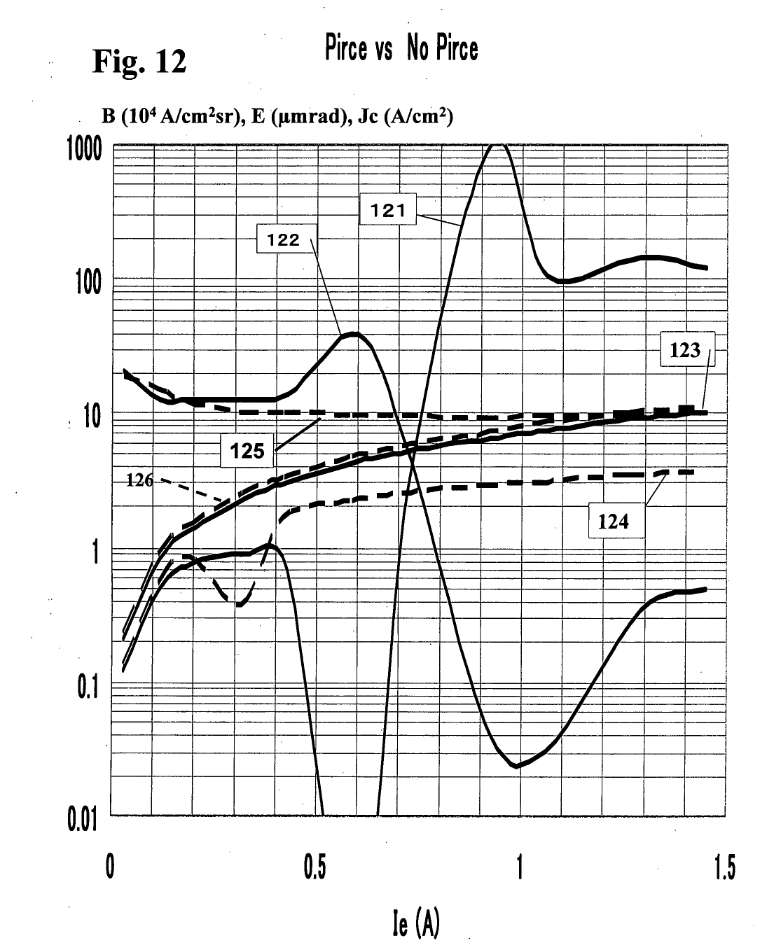

FIG. 12 is the simulation for comparison between Pierce type and the non Pierce type electron guns. The former electron gun satisfy

Rcc=Dac+Rac,

where, Rcc is the cathode radius of curvature, Dac is the distance between the anode and the cathode, and Rac is the anode radius of curvature and where Rcc is 6 mm, Dac is 4 mm and Rcc is 2 mm. For the latter electron gun, Rcc, Dac and Dac are 5 mm, 4 mm and 2 mm, respectively. And then Rcc<Dac+Rac.
The curves 121, 122, 123 are the brightness (10⁴ A/cm²sr), the Emittance (μmrad) and the cathode current density (A/cm²), respectively for the non Pierce type electron gun. The curves 124, 125 and 126 are the brightness (10⁴ A/cm²sr), the Emittance (μmrad) and the cathode current density (A/cm²), respectively for Pierce type electron gun. It is clear that in the condition where the emission current is larger than 0.9 A, the brightness for the non Pierce type electron gun is 10 times larger than that for Pierce type electron gun, when the curves 121 and 124 are compared. Both types have nearly equal cathode current density, and the Emittance for the non Pierce type electron gun have a smaller value than that for Pirce type electron gun, in the emission range where the former gun have larger brightness. For the electron gun, where the high brightness is required, the non Pierce type electron gun, which satisfy Rcc<Dac+Rac, is much useful than Pierce type electron gun, especially, when the emission current is larger than 0.8 A, where the cathode current density is 6 A/cm², the non Pierce type electron gun is much useful.

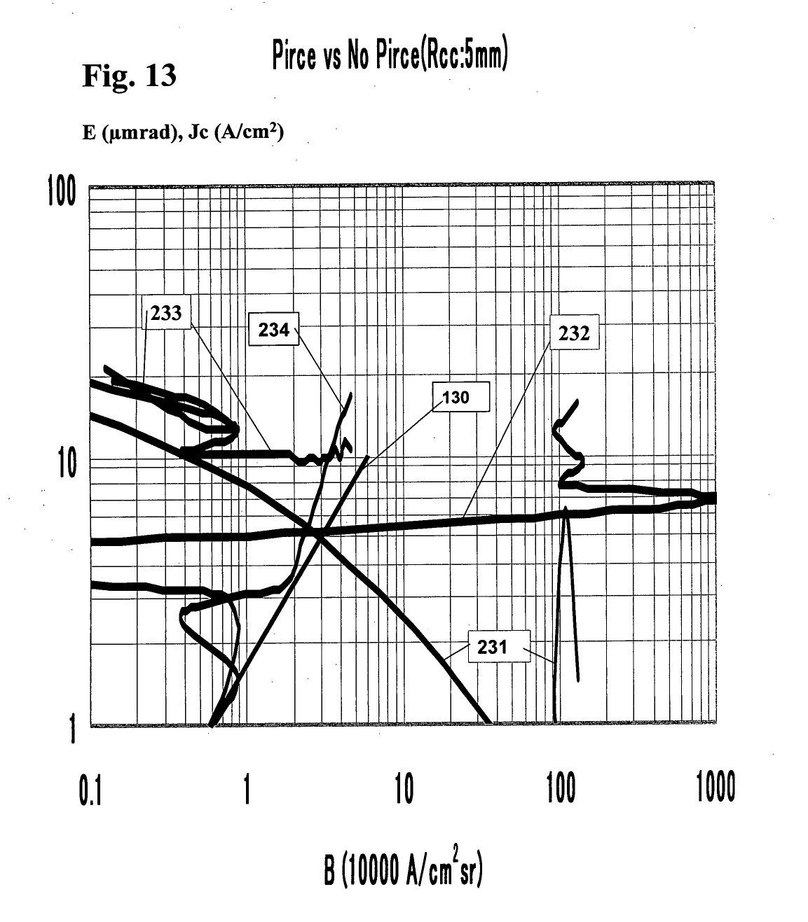

FIG. 13 is the brightness vs. Emittance curves (roughly decreasing function of the brightness) and the brightness vs. cathode current density curves for the simulated results of FIG. 12, where the abscissa is the brightness (10⁴ A/cm²sr) and the ordinate is the Emittance (μmrad) or the cathode current density (A/cm²). The curves 231 and 232 are the brightness vs Emittance curve and brightness vs cathode current density curve respectively for the non Pierce type electron gun. The line 130 is Langmuir limit which satisfy the equation (-1), and is the conventional theoretical maximum brightness, where Jc is the cathode current density (A/cm²), e is the electron charge (1.6×10⁻¹⁹ C), Φ is the beam energy (eV), k is Boltzman constant (1.38×10⁻²³ J/K), and T is the cathode temperature. For the conventional theory, the brightness vs cathode current density curve must be in the left side of this line. The brightness vs cathode current density curve: 232 for the non Pierce type electron gun is in the right side of line 130, and the brightness vs cathode current density curve: 234 for Pierce type electron gun is not in the right side of line 130. The curve 233 is the brightness vs Emittance characteristics.

It may be explained why non Pierce type electron gun does not obey to the conventional theory, that is: the equation (-1) is right only when the electron gun is substantiated to an optical model, for instant when the electron gun is similar to a laminar flow model, which will be shown as beam trajectory, the equation (-1) never satisfied. In the optical model, the electron trajectories from the cathode make a crossover and after that make a cathode image, and then the trajectories cross each other and they cross to the optical axis. On the other side, in the laminar flow model it is a special feature that the trajectories do not cross each other and they do not cross to the optical axis. Therefore, it is not strange that the electron gun, which is approximate to the laminar flow model, have brightness much larger than Langmuir limit. From this point of view, to obtain very high brightness, it is useful that the electron trajectory is controlled to approximate the laminar flow model.

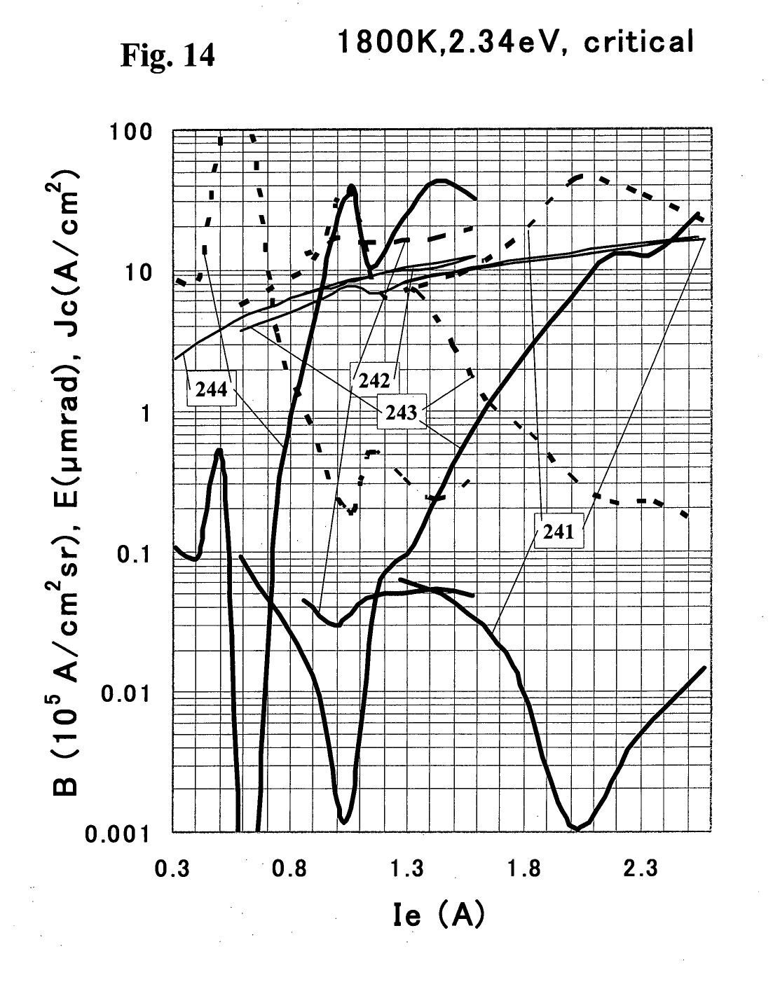

To study what a range of the cathode radius of curvature the brightness exceed Langmuir limit, the radius of curvature is varied from 4 mm to 6 mm with a 0.2 mm increment, and the simulations are done. FIG. 14 is a simulated result for the model in FIG. 11, wherein the cathode radius of curvature: Rcc is varied as 4.2, 4.4, 5.6 and 5.8 mm. The anode to the cathode distance: Dac is 4 mm and the anode radius of curvature is fixed to 2 mm. The curves 241, 242, 243 and 244 are the case where the cathode radius of curvatures is 4.2, 5.8, 4.4 and 5.6 mm, respectively. The solid curves are the brightness as a function of the emission current: Ie, the broken line curves are the Emittance as a function of Ie, and the fine solid curves are the cathode current density: Jc as a function of Ie. For the cases where Rcc are 4.2 and 5.8 mm, as shown in the solid curves 241 and 242, the brightness are much smaller than that for the other two cases. Especially, for the large Ie, 243 and 244 of which Rcc are 4.4 and 5.6 mm, respectively have 100 times larger brightness than that for the electron gun with the 4.2 mm of Rcc. The cathode current density: Jc for these three Rcc case is similar to each other. The Emittance for the 4.2 mm of Rcc is larger than the other Rcc case, when the brightness is smaller than that for the other two Rcc cases. When the high brightness is required, the electron gun with Rcc from 4.4 to 5.6 mm is good. The curve 241 is the case where Rcc is equal to 1.05 Dac, and 242 and 243 are the case where Rcc>1.1 Dac.

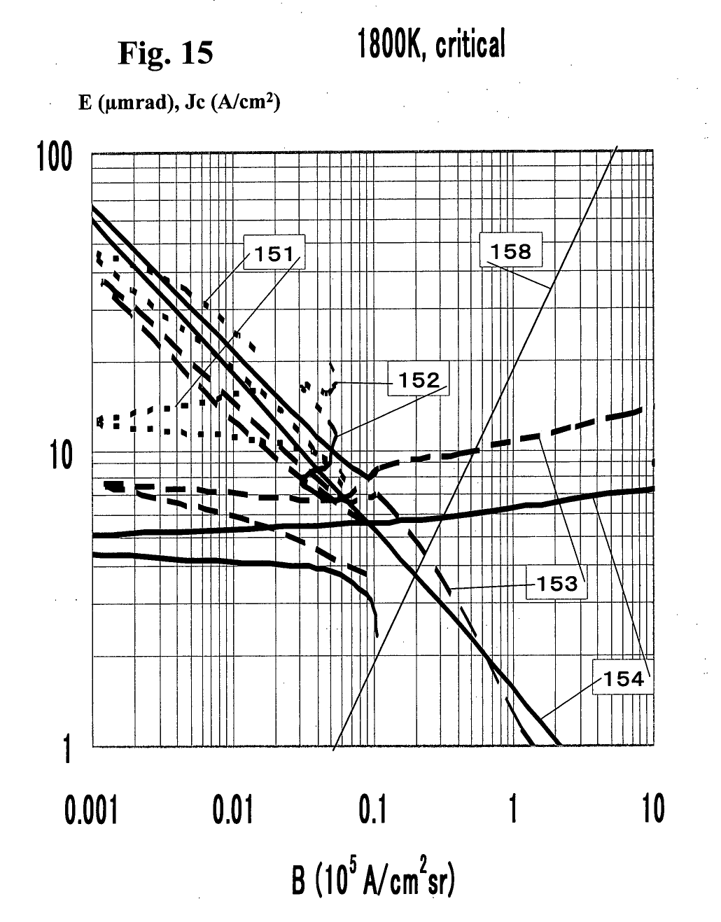

FIG. 15 is the brightness vs Emittance curves and the brightness vs cathode current density curves for the simulated results of FIG. 14, wherein the brightness is 10⁵ A/cm²sr and the Emittance is μmrad, and the cathode current density is A/cm². The decreasing function curves are the brightness vs Emittance: B-E characteristics for the Rcc of 4.2, 4.4, 5.6 and 5.8 mm. The line 158 is Langmuir limit for 1850 K of the cathode temperature and 3 keV of the beam energy. The B-Jc characteristics 151 and 152 are not at the right side of the line 158, the curves 153 and 154 are at the right side of the line 158. Therefore, when Rcc is from 4.4 to 5.6 mm, very high brightness is obtained.

From this result and that from FIGS. 12 and 13, it is expected that the following Inequality regarding Rcc is satisfied, the very high brightness is obtained, that is:

Dac<Rcc<Rac+Dac,

and for the following case the very high brightness is shown through the simulation,

1.1Dac≦Rcc≦0.933(Rac+Dac) (0)

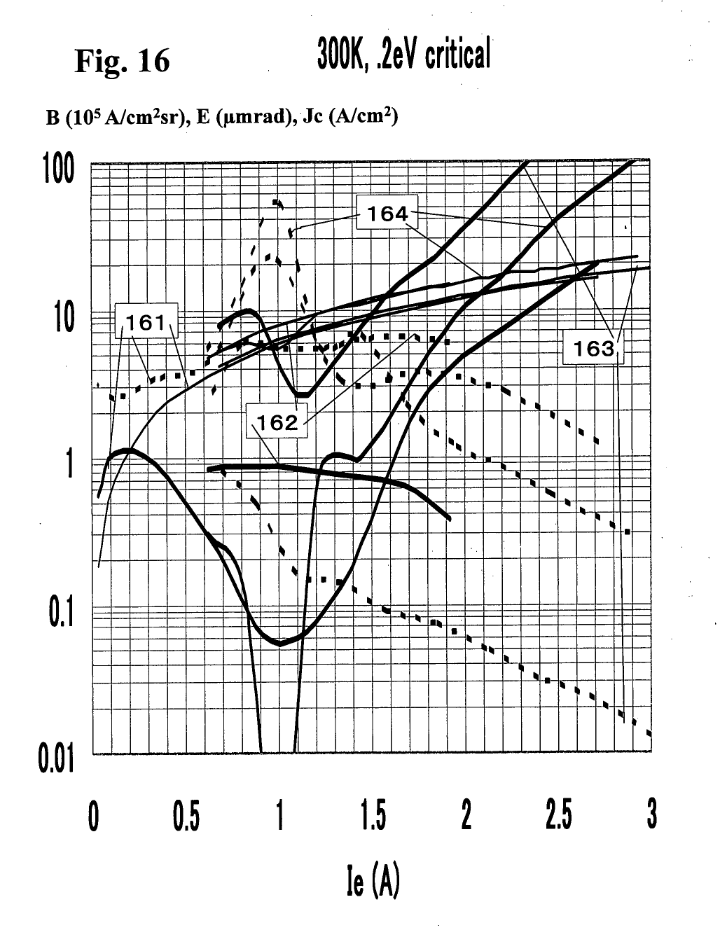

In the case of the photocathode the cathode can be operated in room temperature, the electron energy width is small and the high brightness is expected. FIG. 16 is the simulated result for the model in FIG. 11, wherein the cathode temperature is 300 K and laser photon energy minus photocathode work function is selected to be smaller than 0.2 eV, and wherein the cathode radius: Rc is varied. For example, this selection is CeBix and Kr (Krypton) laser or LaB6 and Ar laser. The curves 161, 162, 163, and 164 are the case where Rcc is 4, 5.6, 4.2, and 5.4 mm, respectively, and the solid curves are the brightness as a function of the emission current: Ie, and the broken curves are the Emittance and the fine solid curve is the cathode current density. The cathode to the anode distance: Dac and the anode radius of curvature are fixed to 4 mm and 2 mm, respectively. If we attend to the brightness characteristics, contrary to the curves 161 and 162 are smaller than 2×10⁶ A/cm²sr, the curves 163 and 164 have the brightness larger than 1×10⁷ A/cm²sr. As Dac is 4 mm and Rac is 2 mm, the curve 161 is the case where Rcc=Dac, and the curves 164 is the case where Rcc=0.9 (Dac+Rac). For the curves 162 and 163, Rcc is in the range larger than 1.05 Dac and smaller than 0.9(Dac+Rac). The broken line: Emittance is high in the low brightness and small in the high brightness, and this result shows that the simulation is right. The cathode current density around the optical axis: Jc are nearly equal values for all four conditions, detailed study show that for the same Ie, the Jc is increased from 4, 4.2, 5.4 to 5.6 mm. This is because when the cathode radius of curvature becomes large, the distance between the cathode periphery and the anode become large, then the emission from the cathode periphery become smaller.

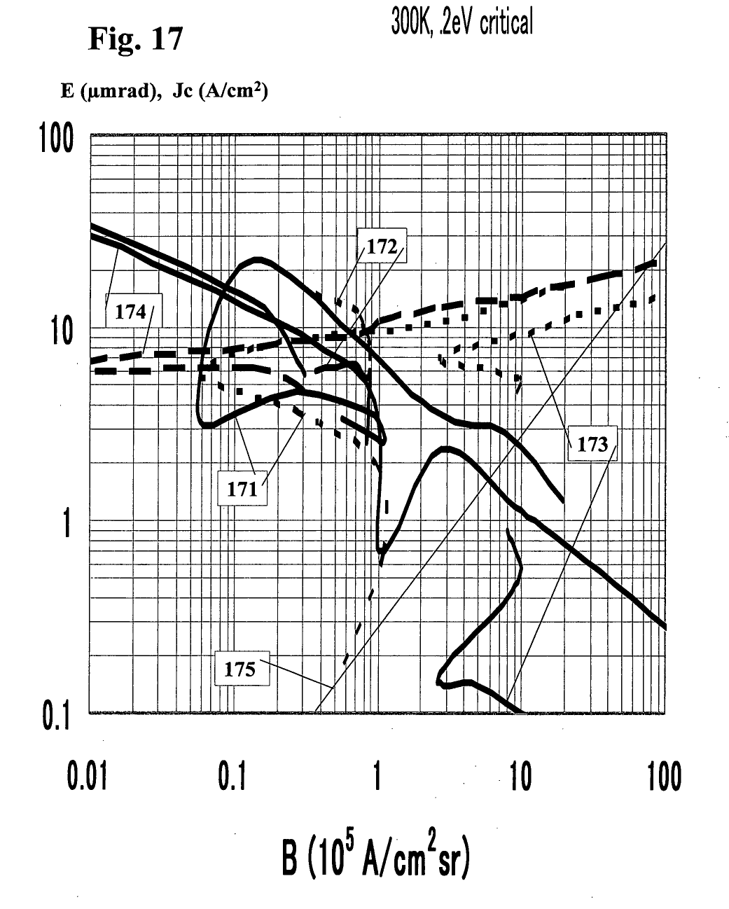

FIG. 17 is the brightness vs. Emittance curves (roughly decreasing function of the brightness) and the brightness vs. cathode current density curves for the simulated results of FIG. 16, where the abscissa is the brightness (10⁵ A/cm²sr) and the ordinate is the Emittance (μmrad) or the cathode current density (A/cm²). The curves 171, 172, 173 and 174 correspond to the Rcc of 4, 5.6, 4.2 and 5.4 mm, respectively. A little increasing function curves are the brightness vs cathode current density curves. The line 175 is Langmuir limit for 3 keV and 300 K, and the B vs. Jc curve in the right side of this line exceeds the limit. The solid curves 171 and 172 are not in the right side of line 175, and for the curves 173 and 174 that are the electron gun with cathode radius of curvature are 4.2 and 5.4 mm, the brightness which exceed Langmuir limit is obtained. Therefore the cathode radius of curvature satisfies the Inequality (2), as same explain as in FIG. 16, the high brightness is obtained.

1.05Dac≦Rcc≦0.9(Rac+Dac)

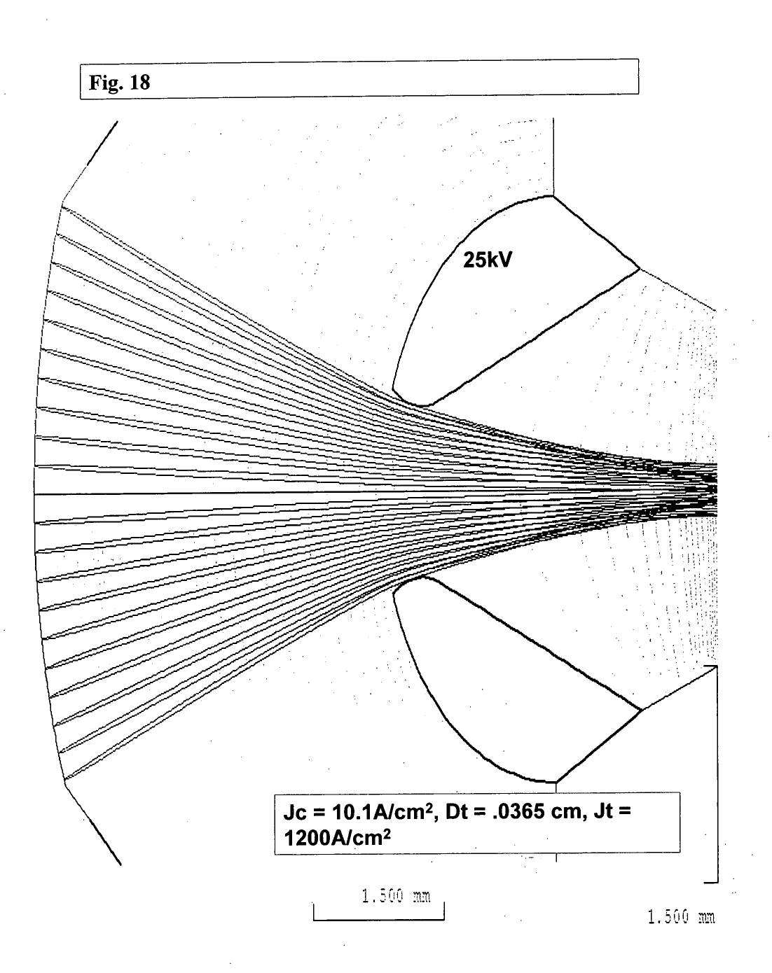

FIG. 18 is the electron beam trajectories for Pierce type electron gun and the electron are started ±45 degree from the normal to the surface with an initial energy of 0.158 eV which correspond to 1850 K cathode temperature. The cathode current density: Jc, a beam diameter at the target: Dt and the current density at the target: Jt values are shown. All the electrons emitted from the cathode are focused on the target within a Dt: 365 μmΦ. This model is the result through that the wehnelt in FIG. 11 are separated into a truncated cone 113 and a flat plate 114, and the cone angle for the truncated cone 113 is optimized. If the emission current of 1.26 A is distributed uniformly inside of the circle of 365 μmΦ, the current density at the target is 1200 A/cm². As real distribution is not uniform, and then a few times larger current density is expected in the central area. The cathode current density is 10.1 A/cm², and then 120 times larger current density is obtained at the target.

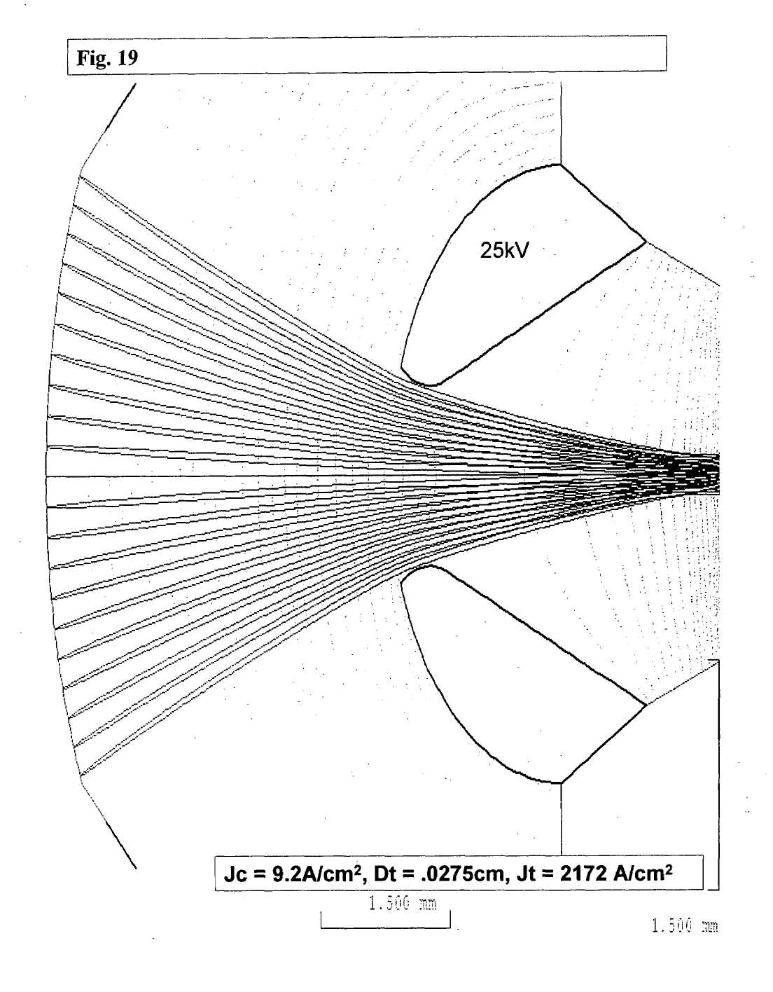

FIG. 19 is the electron beam trajectories for the non Pierce type electron gun, that is, the cathode radius of curvature is 4.5 mm and electron are started ±45 degree from the normal to the surface. The cathode current density: Jc, a beam diameter at the target: Dt and the current density at the target: Jt values are shown. The cathode current density and the target current density are 9.2 and 2172 A/cm², respectively and then 236 times larger current density is obtained.

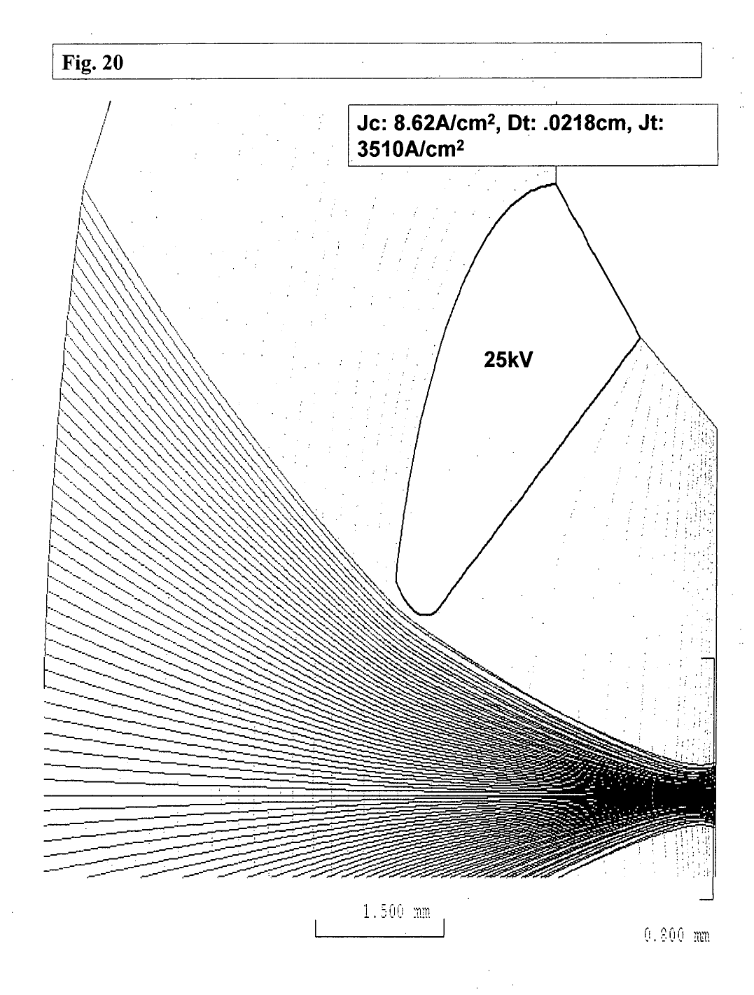

FIG. 20 is the electron beam trajectories for the non Pierce type electron gun with a photocathode and the electron are started normal to the surface, wherein the cathode temperature is 300 K and the laser photon energy minus photocathode work function is 0.2 eV, wherein the photocathode and the laser are LaB6 and Ar laser. The cathode current density is 8.62 A/cm² and the target current density is 3510 A/cm², then the current density is multiplied to 407 times. As this, for the photocathode when the cathode radius of curvature satisfies the Inequality (2), high current density is obtained.

When the electron beam is controlled that the beam diameter decrease monotonically from the cathode to the beam drawing electrode and form a minimum beam radius at the backside of the beam drawing electrode, then the electron-electron interaction is small and the energy spread due to a space charge effect is relatively small, because around the cathode where the current density is small and at the minimum beam diameter the electron have high speed. When the minimum beam diameter the trajectories do not cross each other, the energy width due to the space charge effect is small, and then much smaller beam width is expected than the beam, which forms the crossover, where the beam trajectory cross each other. Regarding this effect, in the case where the electron from the cathode periphery are trapped by the aperture in the electron optics, it is sufficient that at least the trajectory which start from the central part of the cathode and emitted normal to the cathode do not cross each other.

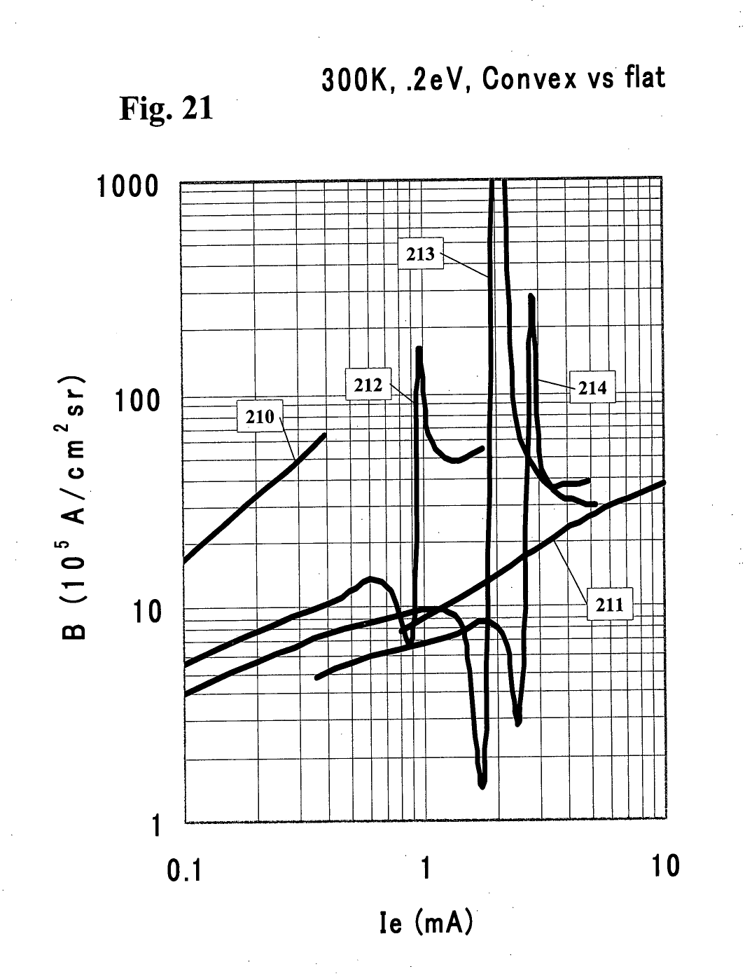

FIG. 21 is the comparison between the electron gun with the convex beam drawing electrode and the conventional convex cathode electron gun, wherein the cathode temperature is 300 K and the laser photon energy minus photocathode work function is 0.2 eV, and wherein the cathode radius: Rc is varied. The curves 210 and 211 are the electron gun with 15 and 30 μm convex radius of curvature cathode, respectively, the curves 212, 213, 214 are the electron gun with 30, 60 and 80 μm, respectively the flat cathode and convex anode. For the conventional convex cathode and the flat anode electron gun: the curves 210 and 211, the brightness are monotonically increasing function of Ie, and are not reach to 1×10⁷ A/cm²sr, however in the curves 212, 213 and 214 for the electron gun with the flat cathode and the convex anode, the brightness much larger than 1×10⁷ A/cm²sr are obtained by relatively smaller emission current than 3 mA.

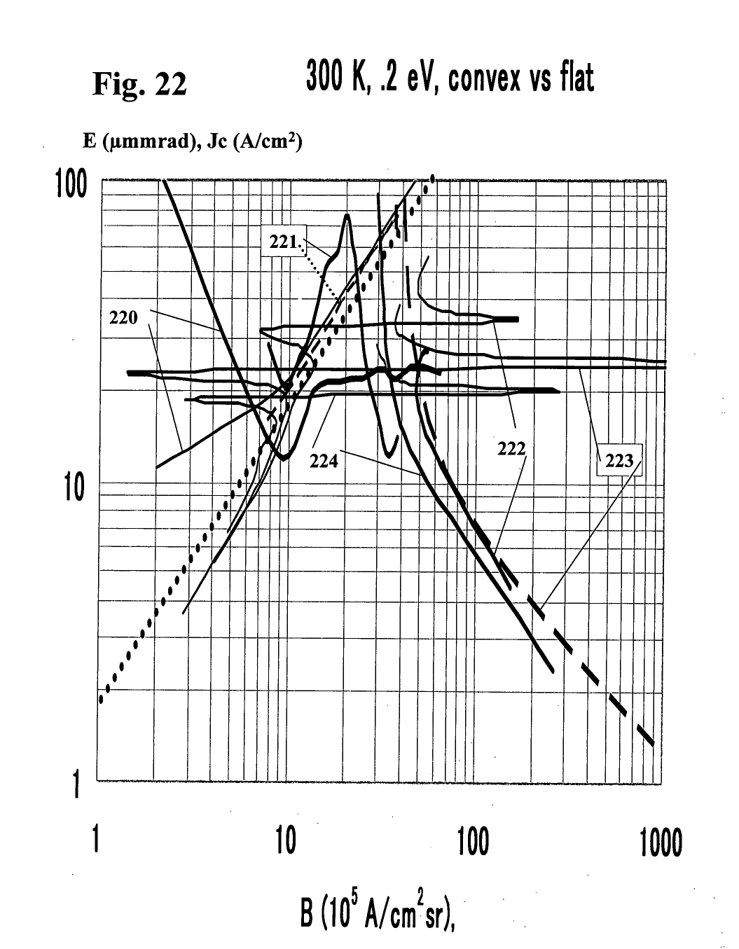

FIG. 22 is the brightness vs Emittance curves (solid curves and broken curve) and the brightness vs cathode current density curves (fine curves) for the simulated results of FIG. 21, wherein the brightness is 10⁵ A/cm²sr and the Emittance is μmmrad, and the cathode current density is A/cm². The curves 220 and 221 are the electron gun with 15 and 30 μm radius of curvature of the convex cathode, respectively and the curves 222, 223 and 224 are the electron gun with the 30, 60 and 80 μm radius cathode, respectively and the convex anode. The dotted line is Langmuir limit for 300 K and 4.5 keV. All the fine curves 220 and 221 for the brightness vs cathode current density of the convex cathode are left side of Langmuir limit, however, the fine curves 222, 223, and 224 for the convex anode electron gun are right side of Langmuir limit and high brightness is obtained by small cathode current density. For the Emittance, 80 μmmrad with the brightness of 2×10⁶ A/cm²sr in 224 and 3×10⁶ A/cm²sr in 223 are obtained.

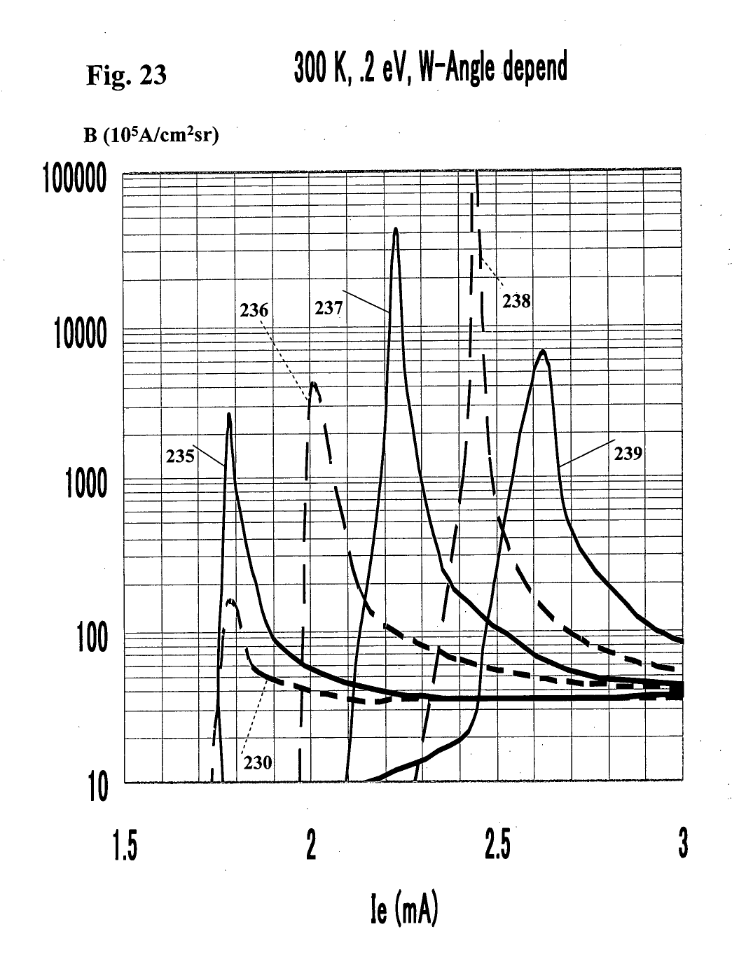

FIG. 23 is the simulated result for the 60 μm radius cathode model in FIG. 1, wherein the cathode temperature is 300 K and the laser photon energy minus photocathode work function is 0.2 eV, and wherein the distance between the anode and the cathode: Dac is fixed to 1.5 mm and the wehnelt angle is varied. The cathode side coordinates of the wehnelt: (Zwc, Rwc) are fixed to (0.5, 0.11) mm, and the anode side coordinate Rwa is fixed to 10 mm and the anode side Z coordinate of the wehnelt: Zwa is varied as 1, 2, 3, 4, 4.5 and 5.5 mm. The wehnelt angles to the optical axis are 87.1, 81.4, 75.8, 70.5, 68 and 63.2 degrees, respectively. The cone angle for the cone whose bottom is the cathode edge and the top is the optical axis at the anode is 2.3 degree. This angle is added to the former cone angles, the angle difference between the beam edge and the wehnelt are obtained, and these values are 89.4, 83.7, 78.1, 72.8, 70.3, and 65.5 degrees, and for these angle differences, the simulations are done. The results are shown in the curves 239, 238, 237, 236, 235 and 230, and these curves correspond to 89.4, 83.7, 78.1, 72.8, 70.3, 68 and 65.6 degrees, respectively. It is seen that the smaller angle difference between the beam edge and the wehnelt, by the smaller emission current, the high brightness is obtained. Except 89.4 degree, the smaller angle difference tends to smaller maximum brightness. Especially, in the case of 65.5 degree the emission current which gives the maximum brightness is nearly equal to that for the 70.3 degree case, and the maximum brightness is smaller than that for the 70.3 degree case. From this result the angle difference between the beam edge and the wehnelt is desirable larger than 69.4 degree, which angle is thought conventionally best, and for the former angle difference the brightness exceed 1×10⁸ A/cm²sr.

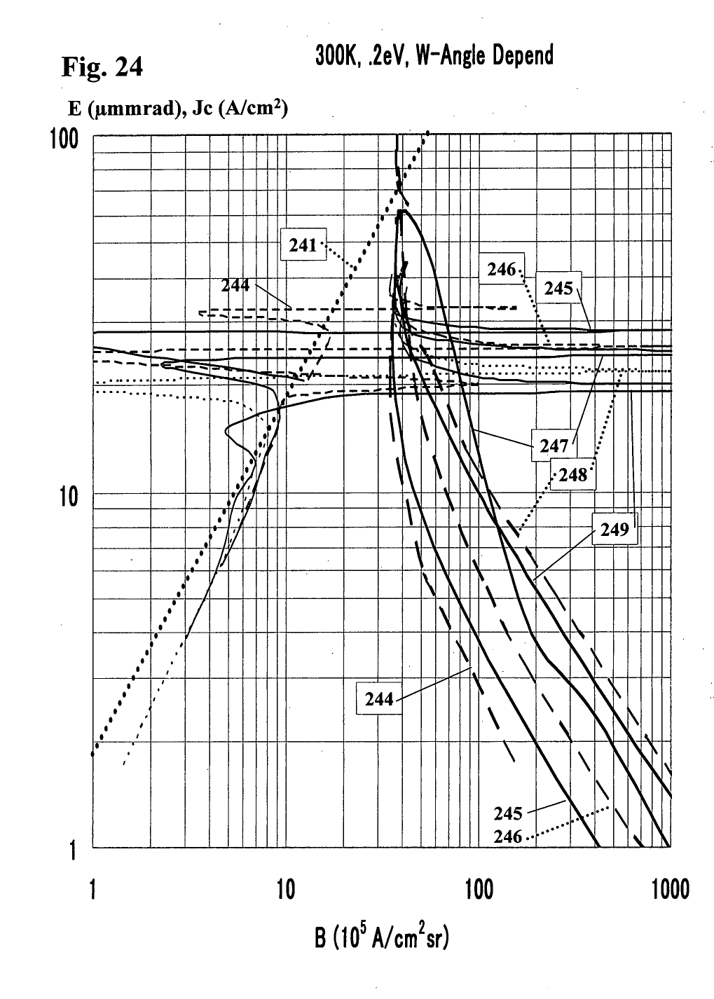

FIG. 24 is the brightness vs Emittance curves (solid and broken curves) and the brightness vs cathode current density curves (fine curves) for the simulated results of FIG. 23, wherein the brightness is 10⁵ A/cm²sr and the Emittance is μmmrad, and the cathode current density is A/cm², where the abscissas is the brightness and the ordinate is the Emittance or the cathode current density. The line 241 is Langmuir limit for 300 K and 4.5 keV. The curves 249, 248, 247, 246, 245 and 244 correspond to the angle difference between the beam edge and the wehnelt of 89.4, 83.7, 78.1, 72.8, 70.3, and 65.5 degree, respectively. For the 65.5 degree the brightness exceeds Langmuir limit. When the wehnelt shape reaches to the flat plate, the cathode current density which give the maximum brightness become smaller. This fact apparently seems inconsistency to FIG. 23, where the flatter wehnelt electron gun have larger emission current which give the maximum brightness. However, as the cathode current density is not a mean value but a value around the optical axis, there is no inconsistency. That is, when the wehnelt reaches to flat, the cathode current density at the periphery increases, the emission current increase, even if the cathode current density, which is the cathode current density at around the optical axis, is small. For the angle of 65.5 degree the brightness exceed Langmuir limit, however the cathode current density is large as 30 A/cm², the Emittance for the same brightness condition is small and then it is not useful to obtain large beam current. After all, from the results of FIGS. 23 and 24, the electron gun with the angle difference between the wehnelt and the beam edge is larger than 69.4 degree give better performance.

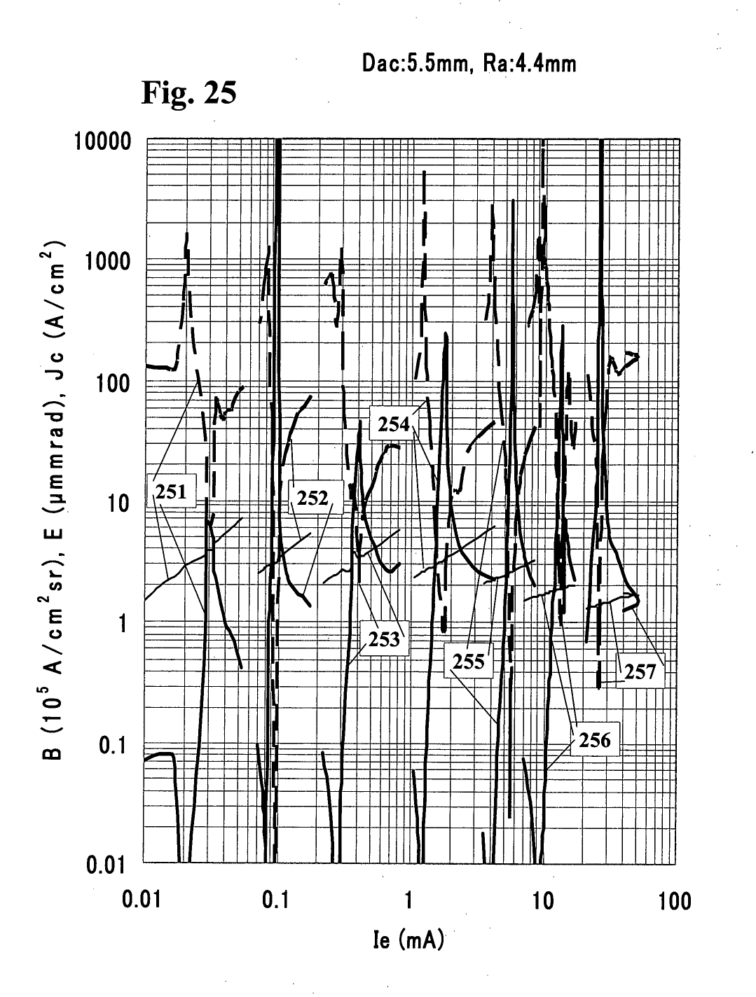

Next, the angle difference between the wehnelt and the beam edge is fixed to 75.4 degree and the condition that the very high brightness or the very high Emittance is obtained, where the cathode radius and the cathode to the anode distance Dac are varied and the anode radius of curvature is fixed to 4.4 mm. FIG. 25 is the simulated result for the model in FIG. 1, wherein the cathode temperature is 1800 K and the cathode work function is 2.35 eV, and wherein the Dac is 5.5 mm and the cathode radius is varied from 15 μm to 960 μm and the increment is twice. Solid curve is the brightness as a function of the emission current Ie. The curves 251, 252, 253, 254, 255, 256 and 257 correspond to the cathode radius of 15, 30, 60, 120, 240, 480 and 960 μm, respectively. All the electron guns with these cathode radii, when the emission current increased from zero, the very high Emittance are obtained firstly and secondary very high brightness are obtained. In the cathode radius range from 15 μm to 120 μm, the cathode current density which give very high brightness are very proximity each other, however in the Rc range from 120 μm to 960 μm, the cathode current density, which give the very high brightness, decrease as the cathode radius increase. The emission current values which give the maximum brightness and the maximum Emittance for each cathode radius are read from FIG. 25 and write in Table III.

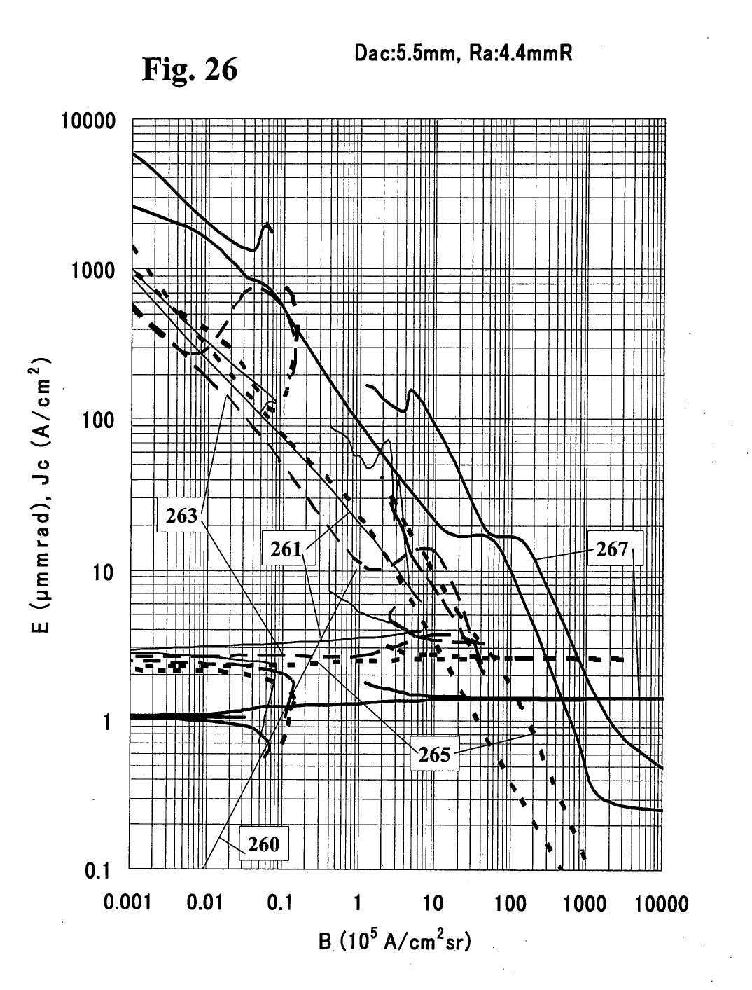

FIG. 26 is the brightness vs. Emittance curves (roughly decreasing function of the brightness) and the brightness vs. cathode current density curves for the simulated results of FIG. 25, where the abscissa is the brightness (10⁵ A/cm²sr) and the ordinate is the Emittance (μmmrad) or the cathode current density (A/cm²). The line 260 is Langmuir limit for the cathode temperature of 1800 K and the beam energy of 4.5 keV. The curves 261, 263, 265 and 267 correspond to the cathode radius of 15, 60, 240 and 960 μm, respectively. The electron gun with larger cathode radius tend to have high brightness and high Emittance condition with smaller cathode current density, and to have higher Emittance with a same brightness. For this Dac condition for example, the Emittance is small as 100 μmmrad for a brightness of 1×10⁵ A/cm²sr, and then when high Emittance is required this Dac condition is not useful. Also, when the Emittance is 1000 μmmrad, the brightness is small as 2.5×10⁻² A/cm²sr, then the high brightness and high Emittance are required, this Dac condition is not useful.

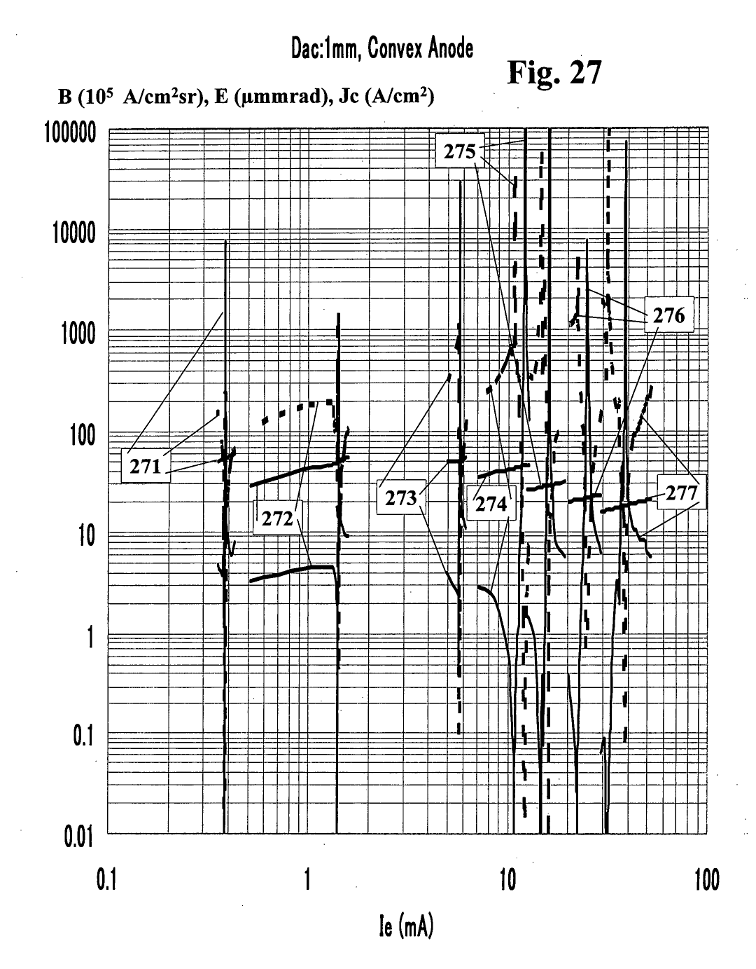

FIG. 27 is the simulated result for the model in FIG. 1, wherein the distance between the cathode and the anode is fixed to 1 mm, and wherein the cathode radius is varied from 15 μm to 960 μm with a increment of 2 times. The solid curves are the brightness as a function of the emission current, the broken curves are the Emittance as a function of the emission current and the short solid curves are the cathode current density as a function of the emission current. The curves 271, 272, 273, 274, 275, 276 and 277 correspond to the cathode radius of 15, 30, 60, 120, 240, 480 and 960 μm, respectively. All the electron guns with these cathode radii, when the emission current increased from zero, the very high Emittance is obtained firstly and secondly very high brightness is obtained. In the cathode radius range from 15 μm to 120 μm, the cathode current density which give very high brightness are very proximity each other, however in the Rc range from 120 μm to 960 μm, the cathode current density, which give the very high brightness, decrease as the cathode radius increase. The emission current values which give the maximum brightness and the maximum Emittance for each cathode radius are read from FIG. 27 and write in table III.

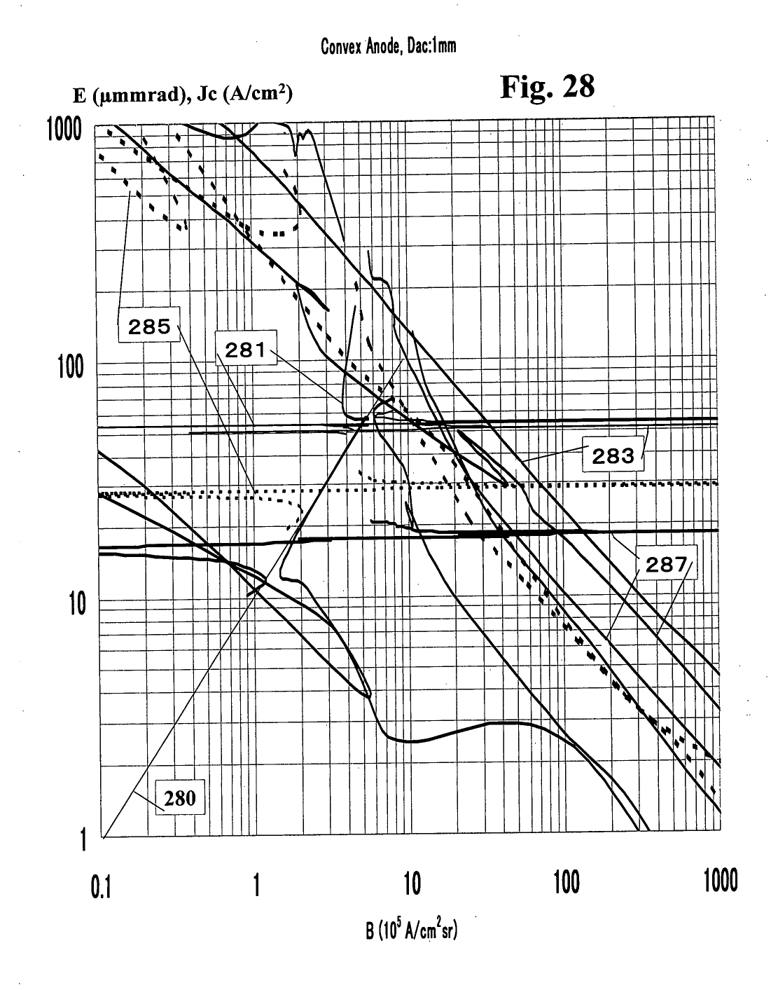

FIG. 28 is the brightness vs. Emittance curves (roughly decreasing function of the brightness) and the brightness vs. cathode current density curves for the simulated results of FIG. 27, where the abscissa is the brightness (10⁵ A/cm²sr) and the ordinate is the Emittance (μmmrad) or the cathode current density (A/cm²). The line 280 is Langmuir limit for the cathode temperature of 1800 K and the beam energy of 4.5 keV. The curves 281, 283, 285 and 287 correspond to the cathode radius of 15, 60, 240 and 960 μm, respectively. The electron gun with larger cathode radius tend to have high brightness and high Emittance condition with the smaller cathode current density, and to have higher Emittance with a same brightness. This Dac condition has a problem that the cathode current density is large as from 19 to 55 A/cm².

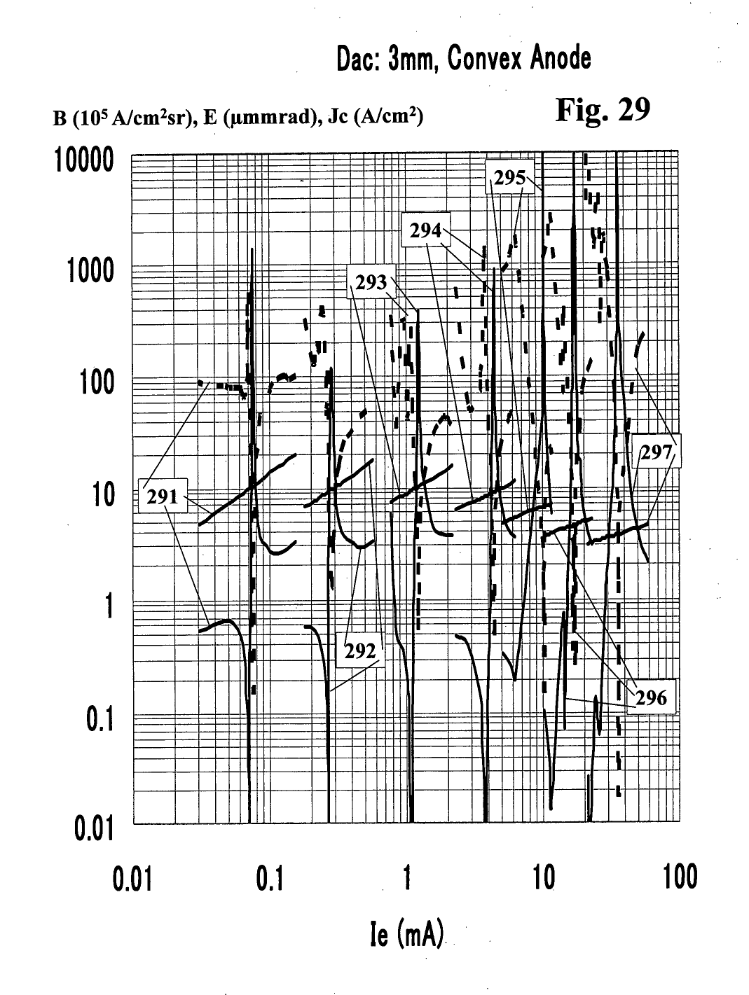

FIG. 29 is the simulated result for the model in FIG. 1, wherein the distance between the cathode and the anode is fixed to 3 mm, and wherein the cathode radius is varied from 15 μm to 960 μm with an increment of twice. The curves 291, 292, 293, 294, 295, 296 and 297 correspond to the cathode radius of 15, 30, 60, 120, 240, 480 and 960 μm, respectively. All the electron guns with these cathode radii, when the emission current increased from zero, the very high Emittance are obtained firstly and secondly the very high brightness condition are obtained. The electron gun with larger cathode radius tend to have high brightness and high Emittance condition with smaller cathode current density, and to have higher Emittance with a same brightness. The emission current values which give the maximum brightness and the maximum Emittance for each cathode radius are read from FIG. 27 and write in Table III.

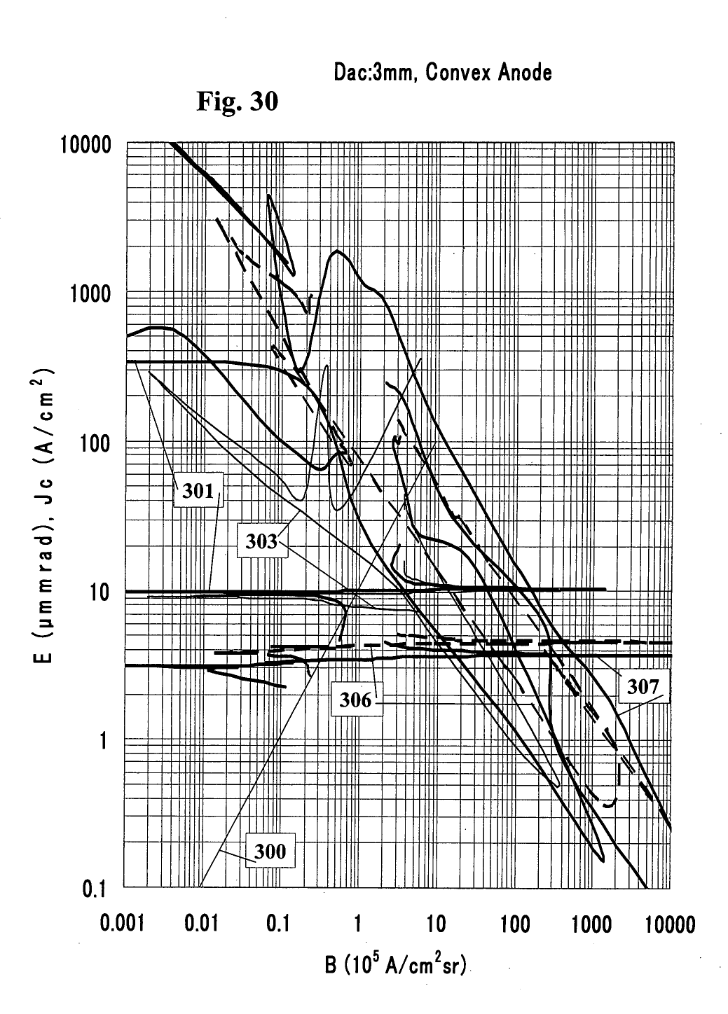

FIG. 30 is the brightness vs. Emittance curves (roughly decreasing function of the brightness) and the brightness vs. cathode current density curves for the simulated results of FIG. 29, where the abscissa is the brightness (10⁵ A/cm²sr) and the ordinate is the Emittance (μmmrad) or the cathode current density (A/cm²). The line 300 is Langmuir limit for the cathode temperature of 1800 K and the beam energy of 4.5 keV. The curves 301, 303, 305 and 307 correspond to the cathode radius of 15, 60, 240 and 960 μm, respectively. The electron gun with larger cathode radius tend to have high brightness and high Emittance condition with smaller cathode current density, and to have higher Emittance with the same brightness. For this Dac condition the cathode current density is not large as smaller than 10 A/cm², the Emittance is 1000 μmmrad at the brightness of 1×10⁵ A/cm²sr, and then there is no problem, even if both high Emittance and the high brightness are required.

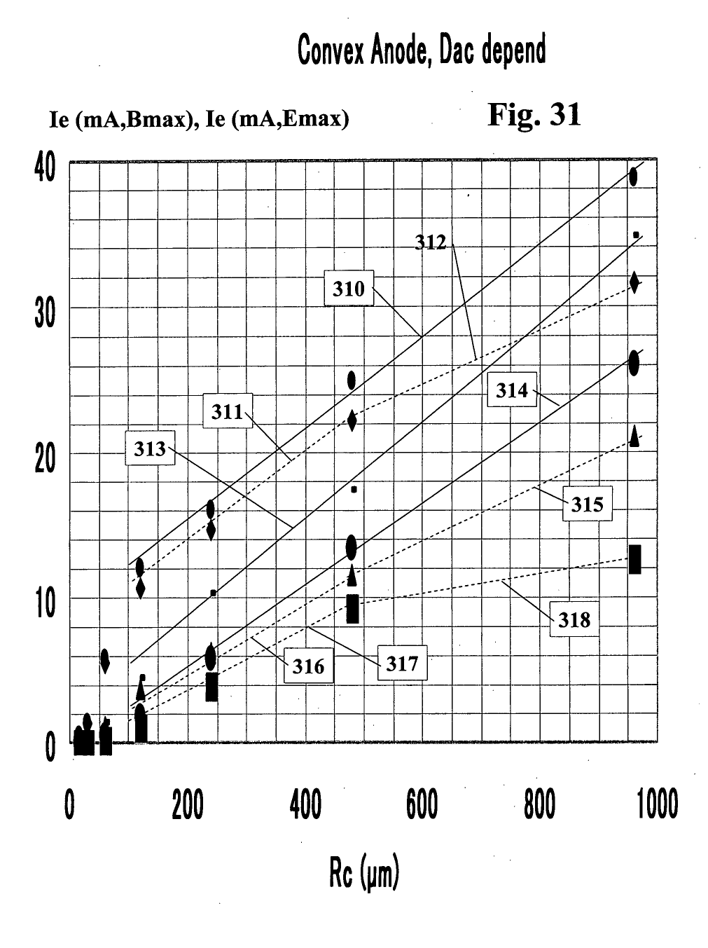

FIG. 31 is the emission currents which give the maximum brightness or the maximum Emittance as a function of Rc, and this graph is made from the values in Table III. The abscissa is the cathode radius (μm) and the ordinate is the emission current Ie(Bmax) or Ie(Emax) (mA), which give the maximum brightness or the maximum Emittance, and the former is shown as solid lines, and the latter is shown as broken lines. The line 310 for Dac of 1 mm is made using distribution of Ie (Bmax) values in the Rc range from 120 to 960 μm and the method of least square. The lines 313 and 314 for Dac of 3 and 5.5 mm, respectively are made using distribution of Ie (Bmax) values in the Rc range from 120 to 960 μm and the method of least square. The emission current which gives the maximum Emittance for each cathode radius: Ie(Emax) is distributed around one line in the range from 120 to 480 μm, however for 960 μm radius is not on the former line, and then show on another line. For Dac of 1 mm Ie(Emax) is shown in the lines 311 and 312, for Dac of 3 mm Ie(Emax) is shown in the lines 316 and 315, and for Dac of 5.5 mm Ie(Emax) is shown in the lines 317 and 318. These lines are represented as following equations.

The line 310: Ie(Bmax)=0.0332Rc+8.1, where Rc is μm and Ie is mA.

The line 314: Ie(Bmax)=0.0294Rc−1.3. The line 313: Ie(Bmax)=0.0353Rc+0.8.

The line 311: Ie(Emax)=0.0322Rc+6.8. The line 312: Ie(Emax)=0.0191Rc+13.2.

The line 316: Ie(Emax)=0.0255Rc−1.2. The line 315: Ie(Emax)=0.0202Rc+1.6.

The line 317: Ie(Emax)=0.0226Rc−1.7. The line 318: Ie(Emax)=0.007Rc+5.9.

When Dac is 1 mm, the emission current: Ie(Bmax), which the maximum brightness is obtained, is as following equation, Ie(Bmax)=0.0332Rc+8.1,

and when Dac is 5.5 mm, the emission current: Ie(Bmax), which the maximum brightness is obtained, is as following equation, Ie(Bmax)=0.0294Rc−1.3, and then for the range of Dac from 1 mm to 5.5 mm, the emission current which give the maximum brightness is in the range as following Inequality;

0.0294Rc−1.3≦Ie≦0.0332Rc+8.1 (1)

When the emission current is required to be small value, it is better that Dac is from 3 to 5.5 mm, as shown in the description of FIG. 30, and then the right side in Inequality (1) is changed by the equation for the line 313;

0.0294Rc−1.3≦Ie≦0.0353Rc+0.8. (2)

When the Emittance is also required high value, it is better that Dac is from 1 to 3 mm, as shown in the description of FIG. 30, and then the left side in Inequality (1) is changed by the equation for the line 313;

0.0353Rc+0.8≦Ie≦0.0332Rc+8.1 (3)

When Dac is 1 mm, the emission current: Ie(Emax), which the maximum Emittance is obtained, is as follows,

Ie(Emax)=0.0322Rc+6.8, where 120≦Rc≦480 (μm), or

Ie(Emax)=0.0191Rc+13.2, where 480<Rc,

and when Dac is 5.5 mm, the emission current: Ie(Emax), which the maximum Emittance is obtained, is as follows,

Ie(Emax)=0.0226Rc−1.7, where 120≦Rc≦480 (μm), or

Ie(Emax)=0.007Rc+5.9, where 480<Rc,

and therefore when Dac is the range from 1 mm to 5.5 mm, the emission current which give the maximum Emittance is in the range as follows;

0.0226Rc−1.7≦Ie≦0.0322Rc+6.8, where 120≦Rc≦480 (μm), or (4)

0.007Rc+5.9≦Ie≦0.0191Rc+13.2, where 480<Rc. (5)

When the emission current is required to be small value, it is better that Dac is the range from 3 to 5.5 mm, as shown in the description of FIG. 30, and then the right side in Inequalities (4) and (5) are changed by the equations for the lines 315 and 316;

0.0226Rc−1.7≦Ie≦0.0255Rc−1.2, where 120≦Rc≦480 (μm), or (6)

0.007Rc+5.9≦Ie≦0.0202Rc+1.6 where 480<Rc. (7)

When the brightness is also required high value, it is better that Dac is the range from 1 to 3 mm, as shown in the description of FIG. 30, and then the left side in Inequality (4) and (5) are changed by the equations for the lines 311 and 312;

0.0255Rc−1.2≦Ie≦0.0322Rc+6.8, where 120≦Rc≦480 (μm) or (8)

0.0202Rc+1.6≦Ie≦0.01191Rc+13.2 where 480<Rc. (9)

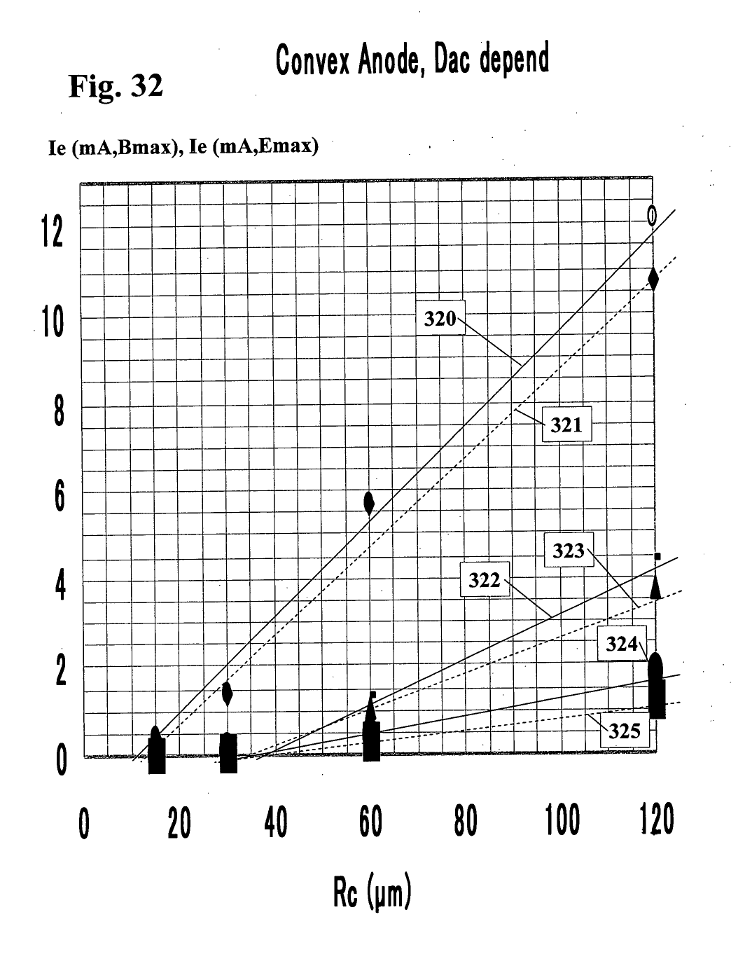

FIG. 32 is the emission currents which give the maximum brightness or the maximum Emittance as a function of Rc, where Rc is smaller than 120 μm, and this graph is made from the values in Table III. For this cathode radius range it is characterized that very high brightness and very high Emittance are obtained by relatively small emission current. Contrary to this, for the cathode radius range from 120 μm to 960 μm, it is characterized that the maximum brightness and the maximum Emittance values are especially larger than those for the cathode radius range smaller than 120 μm. For the Dac of 1 mm, the emission current, which the maximum brightness is obtained, as a function of the cathode radius is shown as the line 320. The equation of the line 320 is as follows,

Ie=0.111Rc−1.05,

### For the maximum Emittance condition is shown as the line 321, the equation for the line 321 is as follows,

Ie=0.103Re−1.1.

For the Dac of 3 mm the maximum brightness condition is shown as the line 322, and the equation for the line 322 is as follows,

Ie=0.0524Rc−1.6.

The maximum Emittance condition is shown as the line 323, and the equation for the line 323 is as follows,

Ie=0.0406Rc−1.1

For the Dac of 5.5 mm the maximum brightness condition is shown as the line 324, and the equation for the line 324 is as follows,

Ie=0.0196Rc−0.5.

The maximum Emittance condition is shown as the line 325, and the equation for the line 325 is as follows,

Ie=0.0196Rc−0.5

Therefore, from the same logic as in FIG. 31, for the Dac range from 1 mm to 5.5 mm, the emission current which gives the maximum brightness is,

0.0136Rc−0.3≦Ie≦0.111Rc−1.05, where Rc≦120 μm. (10)

When the emission current is required to be small value, it is better that Dac is the range from 3 to 5.5 mm, as shown in the description of FIG. 30, and then the right side in Inequality (10) is changed by the equations for the lines 322, and then, the emission current, which give the maximum brightness, is shown as follows;

0.0196Rc−0.5≦Ie≦0.0524Rc−1.6. (11)

When the Emittance is also required, Dac is the range from 1 to 3 mm, as shown in the description of FIG. 30, and then the left side in Inequality (10) is changed by the equations for the lines 323, and then the emission current, which give the maximum brightness, is shown as follows;

0.0524Rc−1.6≦Ie≦0.111Rc−1.05. (12)

The maximum Emittance condition is summarized as follows. When the anode to the cathode distance: Dac is in the range 1 mm and 5.5 mm, the emission current Ie which give the maximum Emittance is in the range from the equation for the line 321 and to the equation for the line 323, and then,

0.0136Rc−0.3≦Ie≦0.103Re−1.1. (13)

When the cathode current density is required to be small value, it is better that Dac is from 3 to 5.5 mm, as shown in the description of FIG. 30, and then the right side in Inequality (13) is changed by the equations for the lines 323, and then, the emission current, which give the maximum Emittance, is shown as follows;

0.0136Rc−0.3≦Ie≦0.0406Rc−1.1 (14)

When the brightness is also required, Dac is from 1 to 3 mm, as shown in the description of FIG. 30, and then the left side in Inequality (13) is changed by the equations for the lines 322, and then, the emission current, which give the maximum brightness, is shown as follows;

0.0406Rc−1.1≦Ie≦0.103Re−1.1 (15)

The followings are summary for the cathode radius range from 15 μm to 960 μm.

The maximum brightness condition is:

0.0196Rc−0.5≦Ie≦0.111Rc−1.05, where 15≦Rc≦120 μm, or (10)

0.0294Rc−1.3≦Ie≦0.0332Rc+8.1, where 120<Rc. (1)

### When the small cathode current density is required,

0.0196Rc−0.5≦Ie≦0.0524Rc−1.6, where 15≦Rc≦120 μm, or (11)

0.0294Rc−1.3≦Ie≦0.0353Rc+0.8, where 120<Rc. (2)

### When the Emittance is also required,

0.0524Rc−1.6≦Ie≦0.111Rc−1.05, where 15≦Rc≦120 μm, or (12)

0.0353Rc+0.8≦Ie≦0.0332Rc+8.1, where 120<Rc. (3)

The maximum Emittance condition is,

0.0136Rc−0.3≦Ie≦0.103Re−1.1, where 15≦Rc≦120 μm, (13)

0.0226Rc−1.7≦Ie≦0.0322Rc+6.8, where 120<Rc≦480, or (4)

0.007Rc+5.9≦Ie≦0.0191Rc+13.2, where 480<Rc. (5)

### When the small cathode current density is required,

0.0136Rc−0.3≦Ie≦0.0406Rc−1.1, where 15≦Rc≦120 μm, (14)

0.0226Rc−1.7≦Ie≦0.0255Rc−1.2, where 120<Rc≦480 (μm), or (6)

0.007Rc+5.9≦Ie≦0.0202Rc+1.6, where 480<Rc. (7)

### When the brightness is also required,

0.0406Rc−1.1≦Ie≦0.103Re−1.1, where 15≦Rc≦120 μm, (15)

0.0255Rc−1.2≦Ie≦0.0322Rc+6.8, where 120<Rc≦480 (μm), or (8)

0.0202Rc+1.6≦Ie≦0.019Rc+13.2, where 480<Rc. (9)

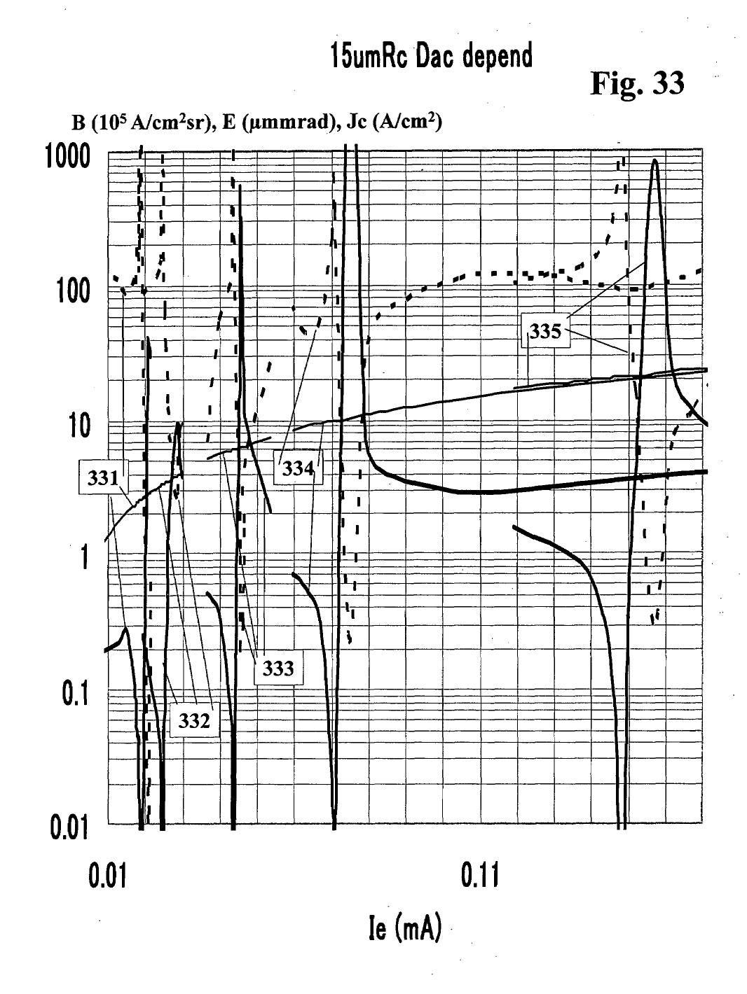

In the second preferred embodiment, the very high brightness and very high Emittance conditions are studied, where the angle difference between the beam edge and the wehnelt is fixed to 75.4 degree, and the cathode radius and the distance between the anode and the cathode are varied. FIG. 33 is the simulated result for the model in FIG. 1, wherein the cathode radius is 15 μm, and the distance between the anode and the cathode: Dac is varied as 2, 3, 4, 5, and 6 mm. The solid curve is the brightness as a function of the emission current: Ie, the dotted curve is the Emittance as a function of Ie, and the short solid curve is the cathode current density as a function of Ie. The curves 331, 332, 333, 334 and 335 are the Dac of 6, 5, 4, 3 and 2 mm, respectively. All the electron guns with these cathode radii, when the emission current increased from zero, the very high Emittance is obtained firstly and secondly the very high brightness is obtained. The electron guns with the larger Dac tend to have high brightness and high Emittance condition by the smaller cathode current density. The emission current values which give the maximum brightness and the maximum Emittance for each cathode radius are read from FIG. 33 and write in Table IV.

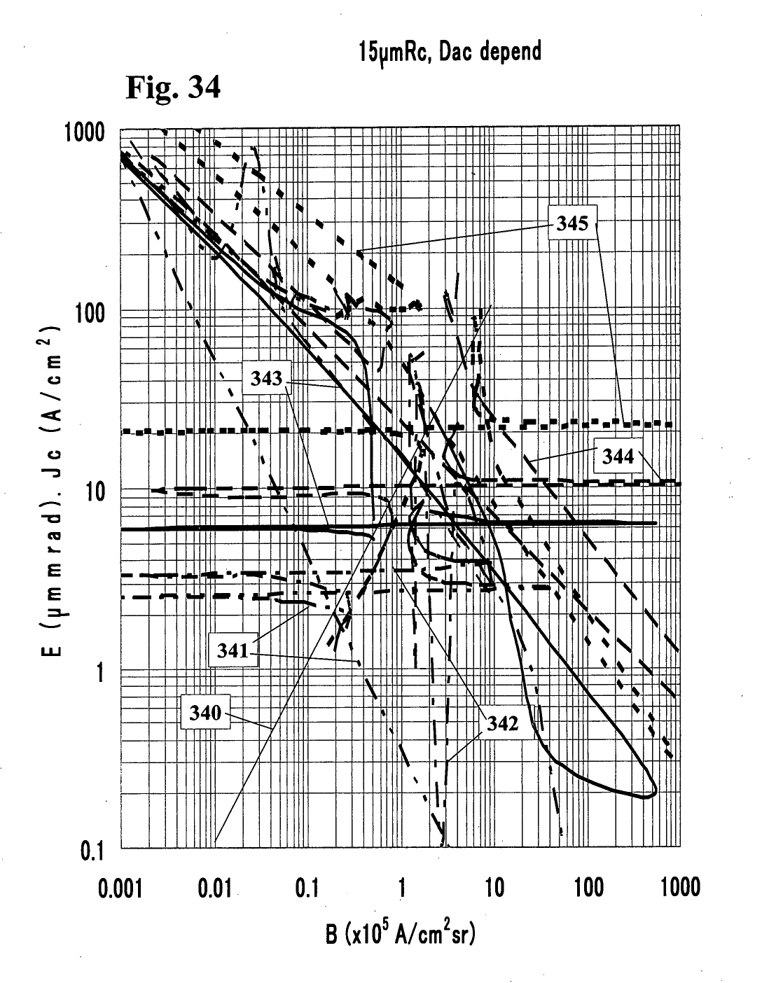

FIG. 34 is the brightness vs. Emittance curves (roughly decreasing function of the brightness) and the brightness vs. cathode current density curves for the simulated results of FIG. 33, where the abscissa is the brightness (10⁵ A/cm²sr) and the ordinate is the Emittance (μmmrad) or the cathode current density (A/cm²). The line 340 is Langmuir limit for the 4.5 keV beam energy and 1800 K cathode temperature. The curves 341, 342, 343, 344, and 345 are the distance between the cathode and the anode: Dac of 6, 5, 4, 3 and 2 mm, respectively. For the electron gun with the larger Dac tend to have very high brightness and very high brightness by the lower cathode current density, and the Emittance is the smaller for the same brightness condition. For the electron gun with this Rc the Emittance is smaller than 20 μmmrad at the brightness of 1×10⁶ A/cm²sr, and then when the high Emittance is required, this electron gun is not useful. Also, when the Emittance is 1000 μmmrad, the brightness is smaller than 1000 A/cm²sr, and then when high Emittance and high brightness are required, this electron gun is not useful.

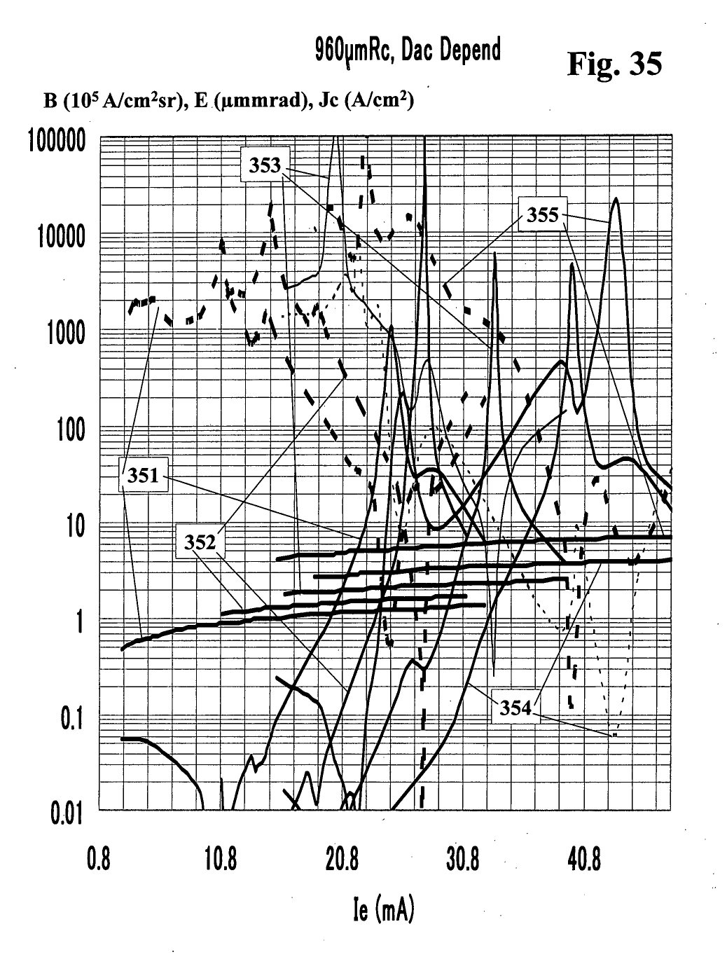

FIG. 35 is the simulated result for the model in FIG. 1, wherein the cathode radius is fixed to 960 μm, and the distance between the anode and the cathode: Dac is varied as 2, 3, 4, 5 and 6 mm. The solid curves are the brightness as a function of the emission current: Ie, the dotted or broken curves are the Emittance as a function Ie, and the short solid curve is the cathode current density as a function of Ie. The curves 351, 352, 353, 354 and 355 are the Dac of 6, 5, 4, 3 and 2 mm, respectively. Only an Emittance curve for Dac of 4 mm is shown by a fine solid curve. All the electron guns with these Dac, when the emission current increased from zero, the very high Emittance is obtained firstly and secondly the very high brightness is obtained. The electron gun with the larger Dac tends to have high brightness and high Emittance condition by the smaller cathode current density. The emission current values which give the maximum brightness and the maximum Emittance for each cathode radius are read from FIG. 33 and write in the Table IV.

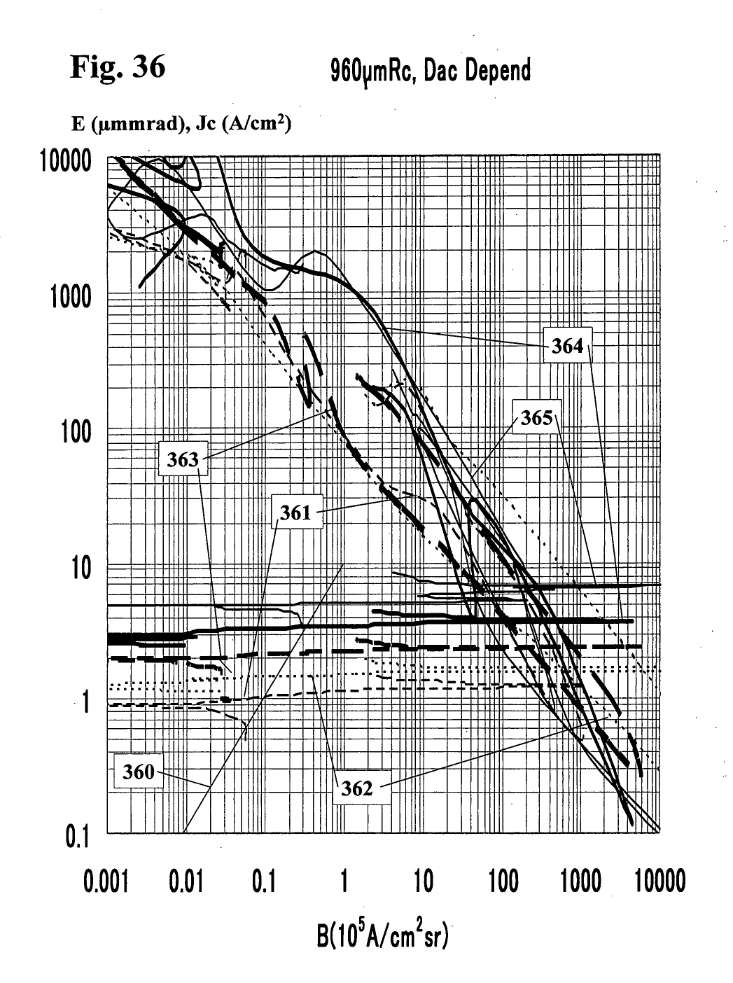

FIG. 36 is the brightness vs. Emittance curves (roughly decreasing function of the brightness) and the brightness vs. cathode current density curves for the simulated results of FIG. 35, where the abscissa is the brightness (10⁵ A/cm²sr) and the ordinate is the Emittance (μmmrad) or the cathode current density (A/cm²). The line 360 is Langmuir limit for the 4.5 keV beam energy and 1800 K cathode temperature. The curves 361, 362, 363, 364, and 365 are the distance between the cathode and the anode Dac of 6, 5, 4, 3 and 2 mm, respectively. For the electron gun with the larger Dac tend to have very high brightness and very high brightness by the lower cathode current density, and the Emittance is the smaller for the same brightness condition. For these electron gun with this Rc of 960 μm the Emittance is 200 μmmrad, at the condition of 1×10⁶ A/cm²sr, then there is no problem, even if the high brightness and high Emittance are both required, however, for the electron gun the emission current is large at the high brightness or the high Emittance condition, and then when the emission current is required to be small value, this electro gun is not useful.

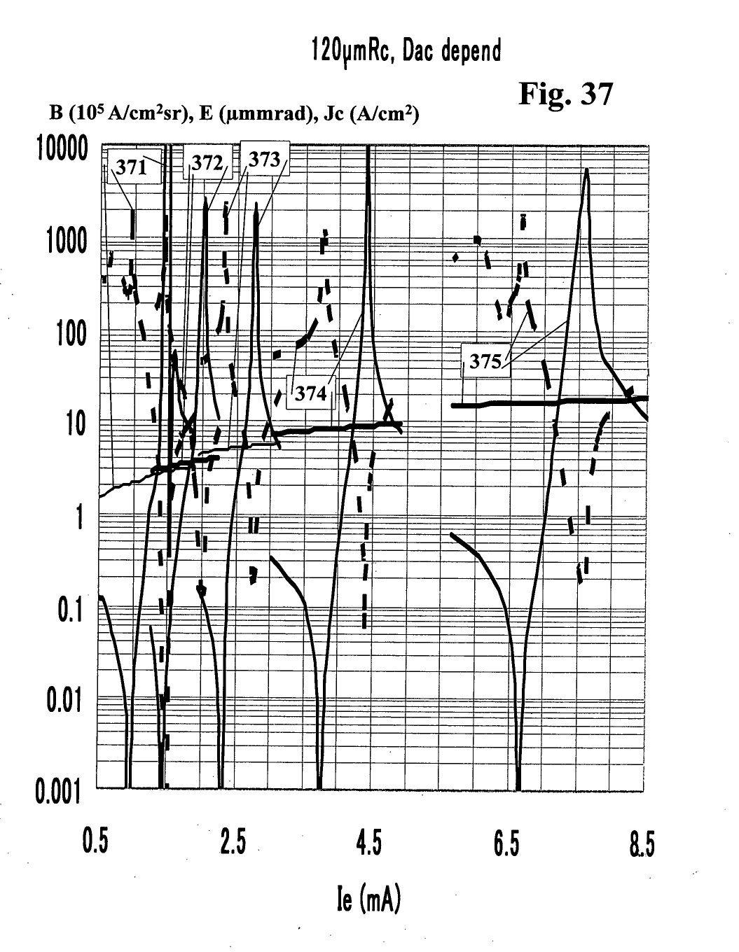

FIG. 37 is the simulated result for the model in FIG. 1, wherein the cathode radius is 120 μm, and the distance between the anode and the cathode: Dac is varied from 6 to 2 mm with an increment of 1 mm. The solid curves are the brightness as a function of the emission current: Ie, the broken curves are the Emittance as a function of Ie, and the short solid curves are the cathode current density as a function of Ie. The curves 371, 372, 373, 374 and 375 are the Dac of 6, 5, 4, 3 and 2 mm, respectively. All the electron guns with these Dac, when the emission current increased from zero, the very high Emittance is obtained firstly and secondly the very high brightness is obtained. The electron gun with the larger Dac tends to have high brightness and high Emittance condition by the smaller cathode current density. The emission current values which give the maximum brightness and the maximum Emittance for each cathode radius are read from FIG. 37 and write in Table IV.

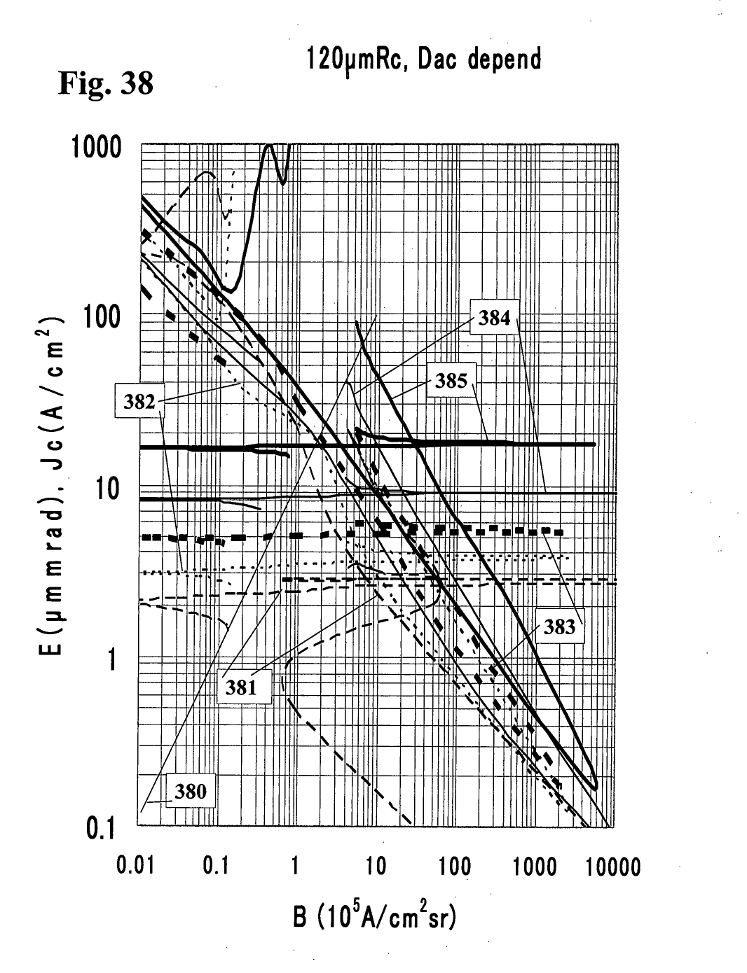

FIG. 38 is the brightness vs. Emittance curves (roughly decreasing function of the brightness) and the brightness vs. cathode current density curves for the simulated results of FIG. 37, where the abscissa is the brightness (10⁵ A/cm²sr) and the ordinate is the Emittance (μmmrad) or the cathode current density (A/cm²). The line 380 is Langmuir limit for the 4.5 keV beam energy and 1800 K cathode temperature. The curves 381, 382, 383, 384, and 385 are the distance between the cathode and the anode Dac of 6, 5, 4, 3 and 2 mm, respectively. For the electron gun with the larger Dac tends to have very high brightness and very high Emittance by the lower cathode current density, and the Emittance is the smaller for the same brightness condition. For these electron gun with this Rc of 120 μm, the emission current is smaller than 7.1 mA, and relatively small and the problem, when the Rc is 960 μm, is solved. The Emittance is 40 μmmrad, at the condition of 1×10⁶ A/cm²sr, and then there is no problem, even if the high brightness and high Emittance are both required and therefore the problem, when the cathode radius is 15 μm, is solved.

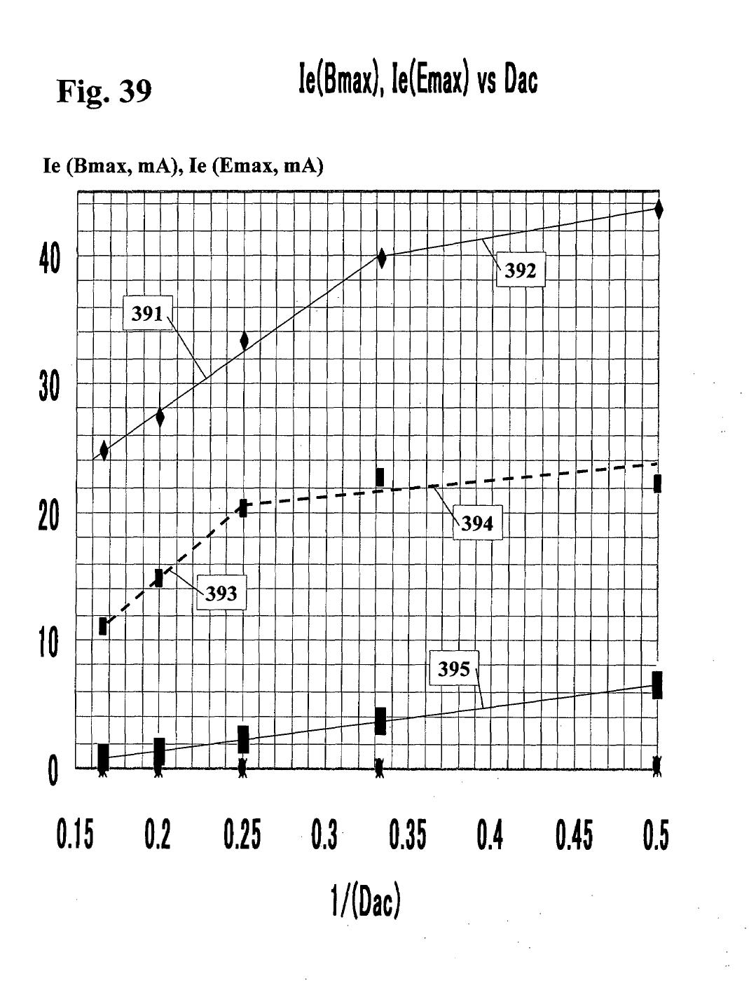

FIG. 39 is the emission currents which give the maximum brightness or the maximum Emittance as a function of Rc, and this graph is made from the values in Table IV. The abscissa is a reciprocal of Dac: (1/Dac), and the ordinate is the emission currents Ie(Bmax) which give the maximum brightness for each Dac, and Ie(Emax) which give the maximum Emittance for each Dac, and the former is shown in the solid line and the latter is shown in the broken line. The line 391 for Rc of 960 μm is made using distribution of Ie(Bmax) values in the Dac range from 6 mm to 3 mm and the method of least square. The line 392 is the same line in the range from 3 to 2 mm. The emission current Ie(Emax) which give the maximum Emittance distribute around one line 393 in the Dac range from 6 mm to 4 mm, and around line 394 in the range 4 mm to 2 mm. The emission current which gives the maximum Emittance for each Dac: Ie(Emax) is distributed around one line 394 in the Dac range from 6 mm to 2 mm, and these lines are represented as following equations.

The line 391: Ie(Bmax)=92.8/Dac+9.28, where Dac is mm, and Ie is mA,

The line 392: Ie(Bmax)=22/Dac+32.7. The line 393: Ie(Emax)=117/Dac−8.35.

The line 394: Ie(Emax)=12/Dac+17.8. The line 395: Ie(Bmax)=17.8/Dac−1.51.

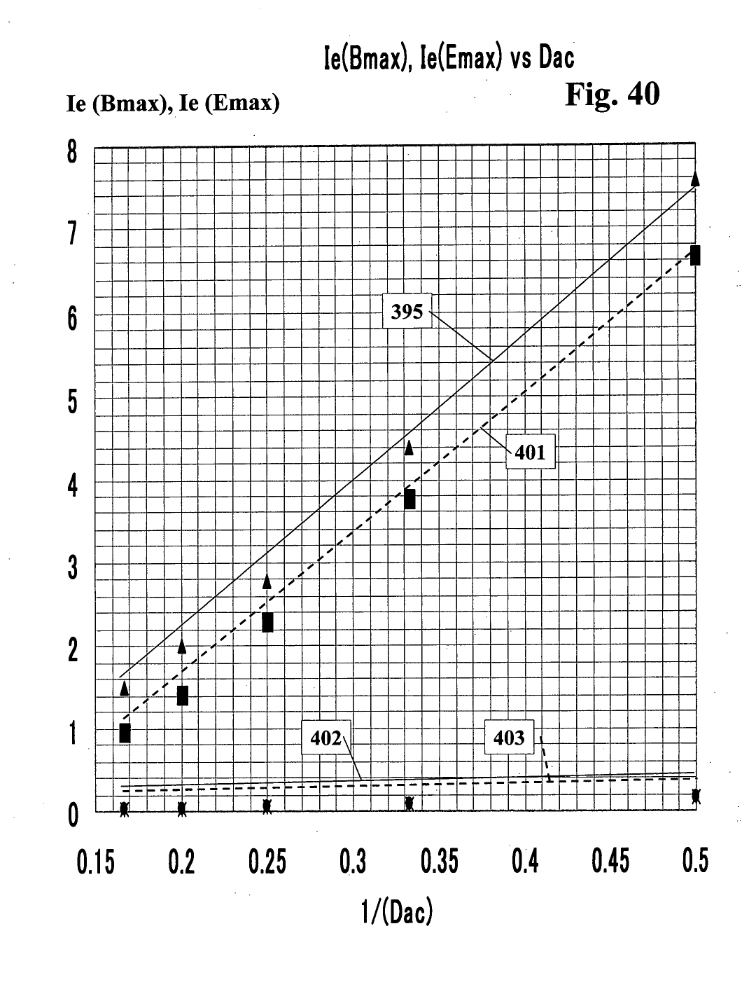

FIG. 40 is the emission currents which give the maximum brightness or the maximum Emittance as a function of Dac, wherein the emission current is smaller than 8 mA, and where the cathode radii are 15 and 120 μm, For these cathode radii it is characterized that the very high Emittance and the very high brightness are obtained by small emission current. Contrary to this, the cathode radius range from 120 to 960 μm the values of the maximum Emittance and the maximum brightness are especially larger than that for the cathode radius range smaller than 120 μm.

The line 401 is the emission current Ie(Emax), which give the maximum Emittance, as a function of Dac, in the case the cathode radius Rc is 120 μm. The equation for the line 401 is as follows,

Ie(Emax)=17.3/Dac−1.99.

The lines 402 and 403 are the emission currents Ie(Bmax) and Ie(Emax) which give the maximum brightness and the maximum Emittance, respectively as a function of (1/Dac). The equation for the maximum brightness: the line 402 is as follows, Ie(Bmax)=0.409/Dac−0.0475.

### The equation for the maximum Emittance: the line 403 is as follows,

Ie(Emax)=0.388/Dac−0.046.

As above, the equations for the emission currents which give the brightness higher than Langmuir limit and the very high Emittance are all presented. Using these equations the emission current ranges which give the brightness higher than Langmuir limit and the very high Emittance are summarized as follows.

The brightness higher than Langmuir limit:

When the cathode radius: Rc is 15 μm, the line 402: Ie(Bmax)=0.409/Dac−0.0475.
When the cathode radius: Rc is 960 μm, the line 391:

Ie(Bmax)=92.8/Dac+9.28, where Dac≧3 mm.

The line 392: Ie(Bmax)=22/Dac+32.7, where Dac<3 mm.

### Therefore, when the cathode radius is from 15 μm to 960 μm,

0.409/Dac−0.0475≦Ie(Bmax)≦92.8/Dac+9.28, where Dac≧3 mm, or (16)

0.409/Dac−0.0475≦Ie(Bmax)≦22/Dac+32.7, where Dac<3 mm. (17)

### When the emission current is required to be small value, from the description regarding FIG. 38, the cathode radius is from 15 μm to 120 μm, and then the right side in the Inequality (16) is changed to the equation for the line 395, then

0.409/Dac−0.0475≦Ie(Bmax)≦17.8/Dac−1.51. (18)

### When the high Emittance is also required, from the description regarding FIG. 38, the Rc is from 120 μm to 960 μm, the left side of the Inequality (16) and (17) are changed to the equation of the line 395, and then,

17.8/Dac−1.51−Ie(Bmax)≦92.8/Dac+9.28, where Dac≧3 mm, or (19)

17.8/Dac−1.51≦Ie(Bmax)≦22/Dac+32.7, where Dac<3 mm. (20)

The condition for the very high Emittance:

### When Rc is 15 μm, the line 403: Ie(Emax)=0.388/Dac−0.046, where Dac≧4 mm, or

### When Rc is 960 μm, the line 393: Ie(Emax)=117/Dac−8.35, where Dac<4 mm.

### When the cathode radius Rc is the range from 15 μm to 960 μm, then,

0.388/Dac−0.046≦Ie(Emax)≦117/Dac−8.35, where Dac≧4 mm, or (21)

0.388/Dac−0.046≦Ie(Emax)≦12/Dac+17.8, where Dac<4 mm. (22)

### When the emission current is required to be small, from the description regarding FIG. 38, Rc is the range from 15 μm to 120 μm, and then the right side in the Inequality (21) is changed to the equation for the line 401, and then,

0.388/Dac−0.046≦Ie(Emax)≦17.3/Dac−1.99. (23)

### When the high brightness is also required, from the description regarding FIG. 38, Rc is the range from 120 μm to 960 μm, and then the left side in the inequalities (21) and (22) are changed to the equation of the line 401, and then,

17.3/Dac−1.99≦Ie(Emax)≦−117/Dac−8.35, where Dac≧4 mm, or (24)

17.3/Dac−1.99≦Ie(Emax)≦12/Dac+17.8, where Dac<4 mm. (25)

In the third preferred embodiment, Table V is the second electron gun model which give the brightness larger than Langmuir limit. In the mode in Table I the anode or the beam drawing electrode have the spherical surface and the assembling accuracy tend to degrade. In the third gun model, all the electrode has no spherical surface except a small curvature for a countermeasure for the breakdown. The simulation is done for this model by using “SOURCE” soled by MEBS company. The conditions for executing “SOURCEA” are also shown after of Table I as 3f.con. Bold numerals are varied as parameters in table V. The simulations are done as follows.
(7) “SOURCEV” is executed for a fixed wehnelt voltage, then the cathode current or the emission current Ie is obtained.
(8) “SOURCEA” is executed, then the cathode current density: Jc, the crossover diameter: Dco, and the crossover position: Zco are obtained.
(9) “SOURCEB” is executed, the brightness as a function of beam emission angle. The beam emission angle θe for 90% or 110% of the axial brightness are obtained. The Emittance E is calculated as E=Dco×θe.

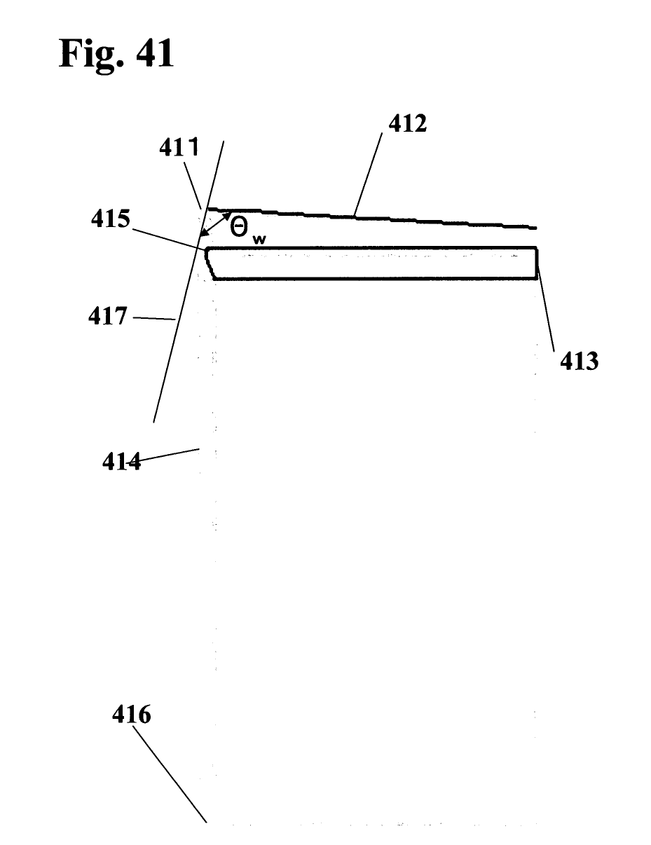

FIG. 41 is the schematic sectional gun model in this invention. Total shape is axially symmetrical around the optical axis 414. The cathode is flat disk and made of a low work function material such as LaB6, CeBix, W—ZrO or the photo cathode and the beam drawing electrode is flat shape. The wehnelt is the truncated cone shape as same as the conventional electron gun, however the position and size is characterized as follows. A cone 417 whose bottom is the cathode edge and its top is the anode position on the optical axis is supposed. And the real wehnelt 412 is designed outside of the assumed cone 417 with the angle difference of θw, and its cathode side radial coordinate is the cathode edge +200 μm, and its Z coordinate coincide with that of the cathode. The cone 417 is approximate to the beam edge. As the real beam edge varies through the emission current variation, the fixed beam edge is assumed as said above. Where, the wehnelt angle θw is designed as 90.5 degree. The cathode side edge 415 of the beam drawing electrode has the curved surface to avoid break down. The beam drawing electrode 413 have a 0.2 mm radius hole. The anode side surface of the beam drawing electrode and the anode surface are flat parallel surfaces to minimize the effect of the axial displacement between these two electrodes. The cathode 411 and wehnelt 412 are centering adjustable before evacuation. The beam drawing electrode 413 have the same centering adjustable mechanism to the wehnelt. Between these three electrodes and an anode are centering adjustable seeing the beam monitor by an adjustable mechanism arranged outside of the electron gun.

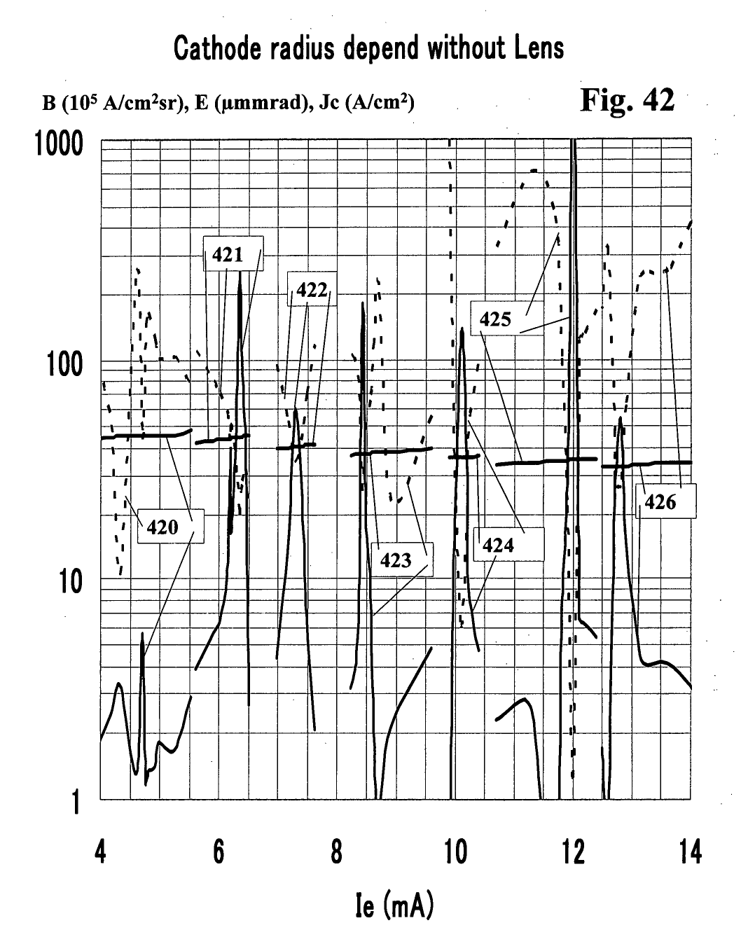

Typical simulated results for FIG. 41 model are shown in FIG. 42, wherein the cathode radius is varied as 80, 100, 120, 140, 160, 180 and 200 μm. The anode voltage is 4.5 kV, the cathode voltage is 0 V, and the emission current is varied by changing the wehnelt voltage. By changing the emission current the brightness is changed. In FIG. 42, the abscissa is the emission current: Ie (mA), the ordinate is the brightness (10⁵ A/cm²sr), the Emittance (μmmrad), the cathode current density (A/cm²), and the cathode to the anode distance: Dac is 1.2 mm.

The curves 420, 421, 422, 423, 424, 425 and 426 are for the electron gun with the cathode radius of 80, 100, 120, 140, 160, 180 and 200 μm, respectively. The dotted curves are the Emittance, the short solid curves are the cathode current density, and the solid curves are the brightness. At the specified emission current Ie, except for the cathode radius of 80 μm all the electron gun have high brightness larger than Langmuir limit. In the conventional electron gun, the emission current is roughly smaller than several hundred μA, contrary this, the electron gun in this invention have a characteristics of the 10 times larger emission current than that for the conventional electron gun. That is, by through the emission current large value, the beam trajectory deviate from the optical model, and then the very high brightness much larger than Langmuir limit is obtained.

For the electron gun with cathode radii of 100, 120 and 140 μm, the brightness increase to the very high value when the emission current increase, and when the emission current increase still more, the brightness decrease rapidly. Contrary this, for the electron gun with 180 and 200 μm cathode radius when the emission current increase, the brightness decrease to very small value, and when the emission current increase still more the very high brightness is obtained. Therefore, for the electron gun with cathode radii of 180 and 200 μm, when the high brightness condition is searched so that the condition which the Emittance is very high is found and the emission current a little larger than said high Emittance emission current condition is studied.

Also, when the ratio: (the emission current which the maximum brightness is obtained)/(the cathode radius) that is Ie(Bmax)/Rc are calculated, the results are 0.064, 0.0638, 0.06, 0.0631, 0.066 and 0.064 (mA/μm) for the cathode radius of 100, 120, 140, 160, 180 and 200 μm, respectively are obtained. Therefore, when the cathode radius is multiplied by 0.064, the emission current which gives the brightness larger than Langmuir limit is obtained.

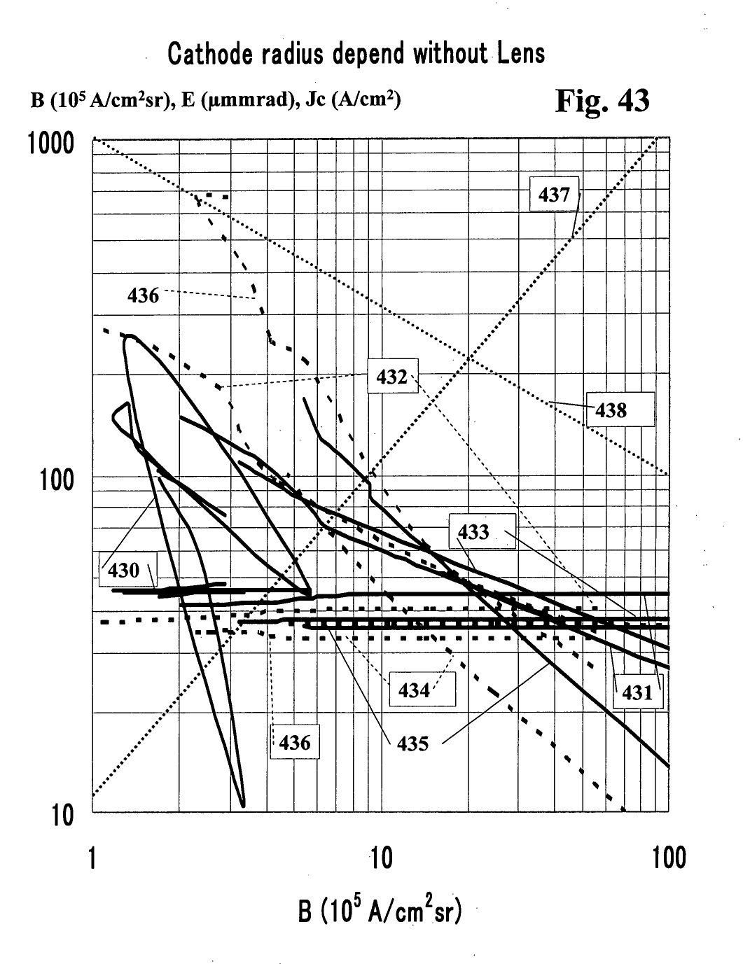

FIG. 43 is the brightness vs. Emittance curves (roughly decreasing function of the brightness) and the brightness vs. cathode current density curves for the simulated results of FIG. 42, where the abscissa is the brightness (10⁵ A/cm²sr) and the ordinate is the Emittance (μmmrad) or the cathode current density (A/cm²). In the former curves the righter side curves or the upper curves are the better performance. The curves nearly horizontal are the brightness vs. cathode current density curves. The curves 431, 432, 433 and 434 are slightly increasing function of the brightness; this is because for the emission current area smaller than the emission current which gives the very high brightness are used. The curves 435 and 436 are slightly decreasing function of the brightness, this is because for the emission area larger than the emission current which gives the very high brightness are used. The curves 430, 431, 432, 433, 434, 435, and 436 correspond to the cathode radius of 80, 100, 120, 140, 160, 180 and 200 μm, respectively. The line 437 is Langmuir limit, and for the conventional theory right side of the line 437 there is no B vs. Jc curve. The dotted line 438 is the line where B×E² is constant, and if some arbitrary lines which pass some points in the B vs. E curves and parallel to this dotted line, for the brightness and Emittance condition including the upper or righter line the larger beam current is obtained, when the aperture size is sufficiently large. The B vs. E curves 434, 435 and 436 have steeper slope than the line 438, and then for these electron gun the low brightness and high Emittance condition give large beam current. The B vs. E curves 431, 432 and 432 have gentler slope than the line 438, then for this electron gun the high brightness and low Emittance condition give large beam current. From this figure the following are cleared, that is,
(1) The electron gun with the cathode radius range from 100 to 200 μm gives high brightness much larger than Langmuir limit.
(2) The electron gun with the larger cathode radius gives high brightness much larger than Langmuir limit by the smaller cathode current density.
(3) The electron gun with a 80 μm cathode radius does not give the brightness larger than Langmuir limit.
(4) The very high brightness condition is obtained when the emission current is around Rc×0.0638 (mA), where Rc is the cathode radius (μm).

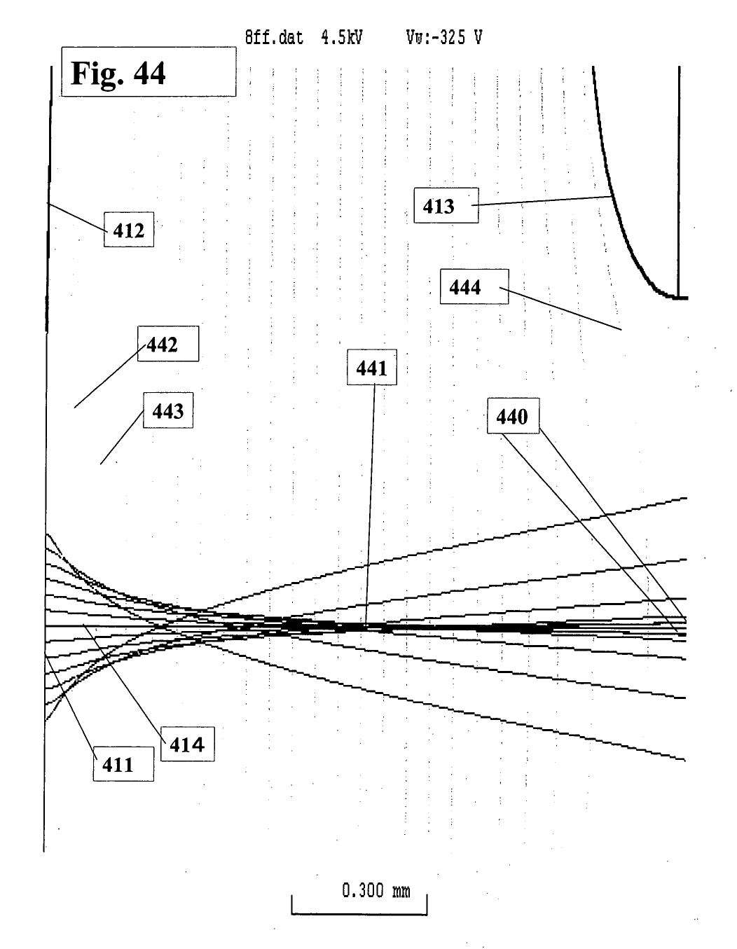

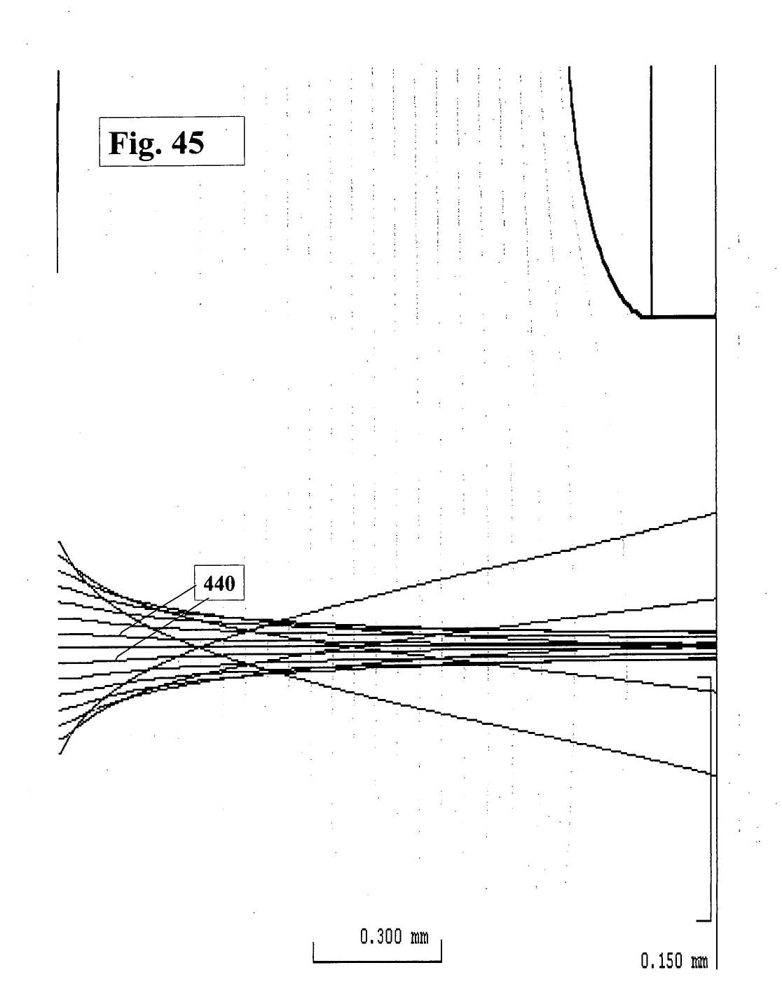

FIGS. 44 and 45 are the electron beam trajectories for the case when the brightness is smaller than Langmuir limit and for the case when the brightness is larger than Langmuir limit, where the cathode radius is 80 μm. The cathode 411, wehnelt 412, anode 413 and the optical axis 414 are same as in FIG. 41. In FIG. 44, a crossover 441 is formed between the cathode and the anode. In FIG. 45, the trajectories 440, which start around the optical axis, do not make crossover until the anode, and they approximate to the laminar flow. By the comparison between FIG. 44 and FIG. 45, it is said that the condition for the brightness higher than Langmuir limit is to control the electron trajectories not an optical model but a laminar flow model.

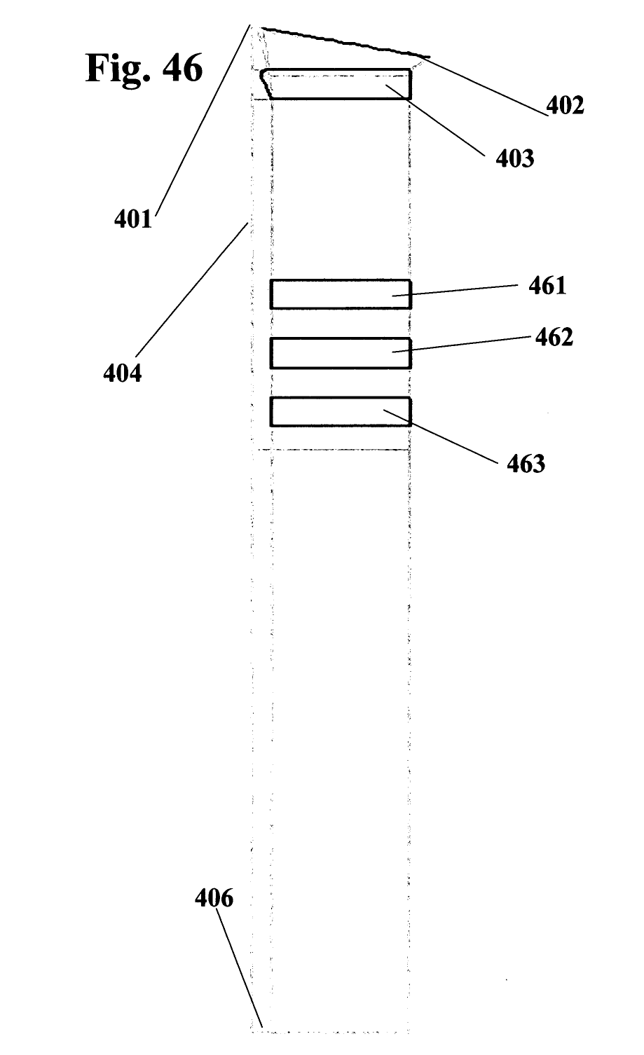

As said above, the brightness larger than Langmuir limit is obtained by the specified emission current which depend on the cathode radius. However, as said emission current is large, the condition that the high brightness is obtained by the smaller emission current is desirable. FIG. 46 is the electron gun model where an electrostatic lens is added after the gun model in FIG. 41. Three electrodes 461, 462 and 463 are deposited, where the electrode 461 and 463 have a same voltage as the anode, the voltage for the central electrode 462 is valid and the simulation is carried out. A model example in FIG. 46 is shown in Table VI. The date con for executing “SOURCEA” is the same as in Table I.

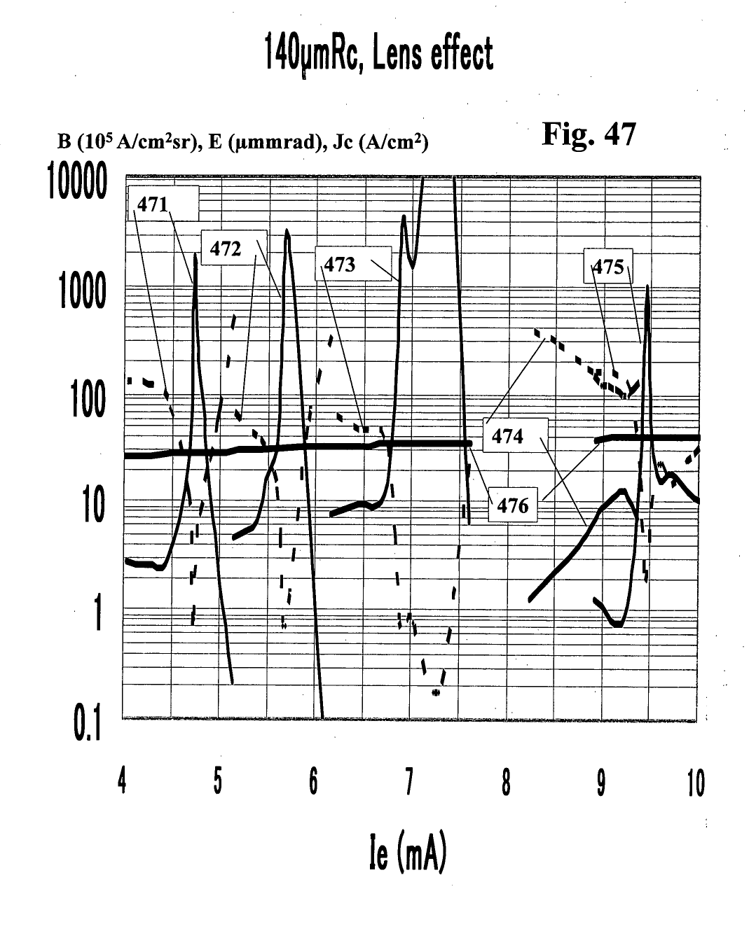

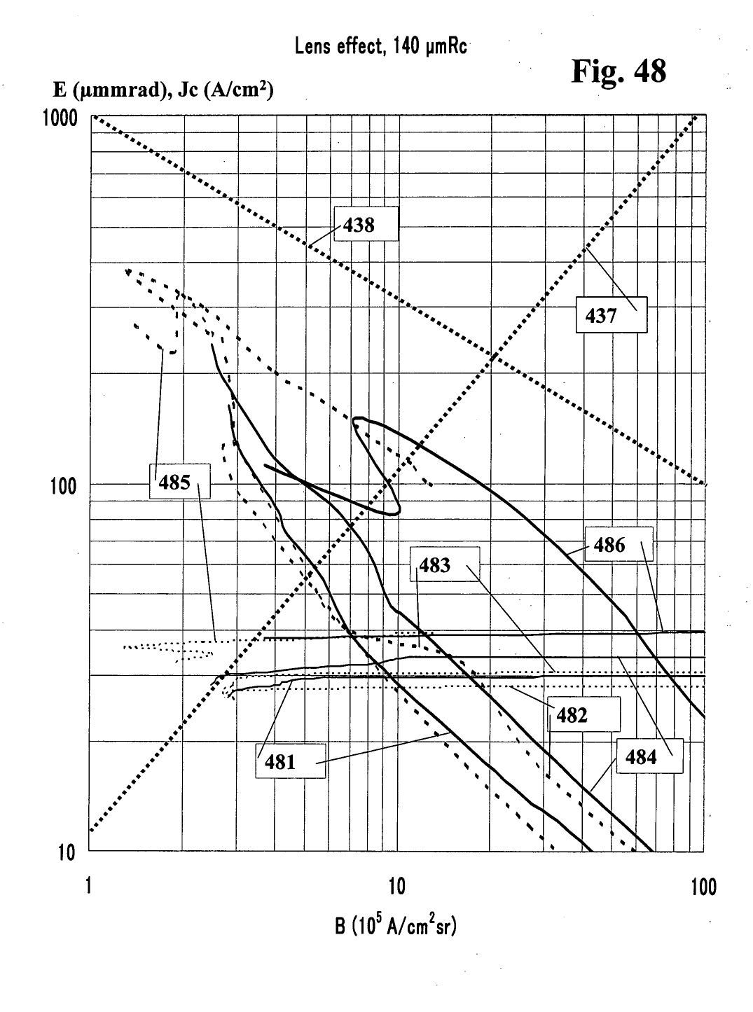

The simulated results are shown in FIGS. 47 and 48. FIG. 47 is the simulated result for the model in FIG. 46, where the brightness (solid curve), the Emittance (broken curve), the cathode current density (solid short curve) as a function of the emission current Ie. The potentials which applied in the electrodes 462 are 12.5, 14, 15, 12, and 4.5 kV, for the curves 471, 472, 473, 474, and 475, respectively. When the anode potential is 0 V, above potentials are subtracted by 4.5 kV. The cathode radius Rc is 140 μm. For the curve 475 with no lens excitation, the emission current which gives the high brightness is 9.4 mA, contrary the emission currents are 4.75, 5.7, 7.25 and 9.23 mA, for the lens excitation of 12.5 kV, 14, 15, and 12 kV, respectively. That is to say, by through the lens the maximum brightness is obtained at smaller emission current. Common to all the lens condition, when Ie is increased, the brightness increase monotonically, the maximum brightness is obtained, and the brightness decrease rapidly to the minimum brightness. The Emittance is the minimum when the brightness is the maximum and the Emittance becomes the maximum, when the brightness becomes the minimum. Therefore, the maximum brightness condition can be searched through the brightness measurement is done using a electron optics with two apertures which can be measure the brightness, or the condition for the maximum Emittance is searched and search around the emission current a little smaller emission current than the high Emittance condition.

FIG. 48 is the brightness vs. Emittance curves (roughly decreasing function of B) and the brightness vs. cathode current density curves for the simulated results of FIG. 47, wherein the brightness is 10⁵ A/cm²sr and the Emittance is μmmrad, and the cathode current density is A/cm². The curves 481, 482, 483, 484, 485 and 486 are the case where the central electrode 462 is applied 12.5, 13, 14, 12 and 4.5 kV, respectively. When the anode potential is 0 V, above potentials are subtracted by 4.5 kV. The line 437 is Langmuir limit, and then for the conventional theory there is no B-Jc curve right side of the line 437. The line 438 is as same in FIG. 43, and in FIG. 48 the slope of the B vs. E curves is larger than the line 438, and then the obtainable maximum beam current is larger at the condition of low brightness and high Emittance condition. The B-E curve 486 for no lens condition is upper side than for the B-E curves 481, 482, 483, 484, and 485, which are the case for the lens excitation, and then unfortunately the maximum obtainable beam current for the same brightness become smaller than the no lens excitation case.

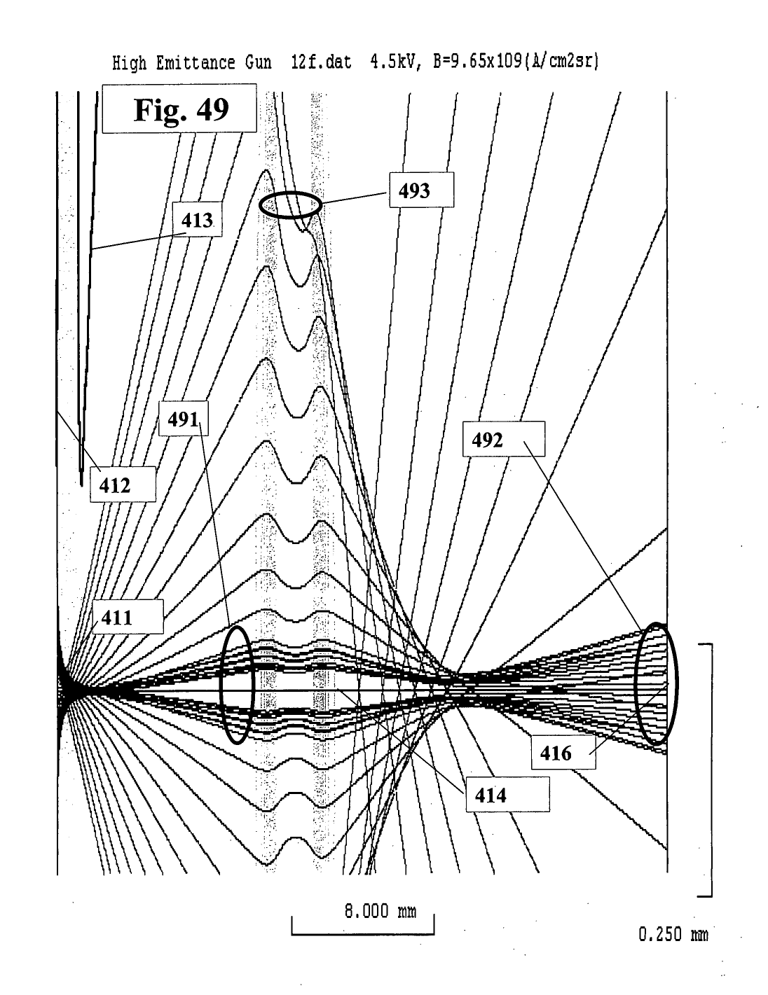

FIG. 49 is the electron beam trajectories started from the cathode surface normal for the case when the brightness is larger than Langmuir limit, and a positive voltage is applied in the electrostatic lens. As shown in 491, the trajectories started with equal separation become small density at the central part by the space charge effect; however, after the lens as shown in 492, at the evaluation plane 416 the trajectory density is improved largely, and the brightness degrade due to the space charge effect is compensated. The lines 493 are equi-potential line for the lens excited by the positive voltage.

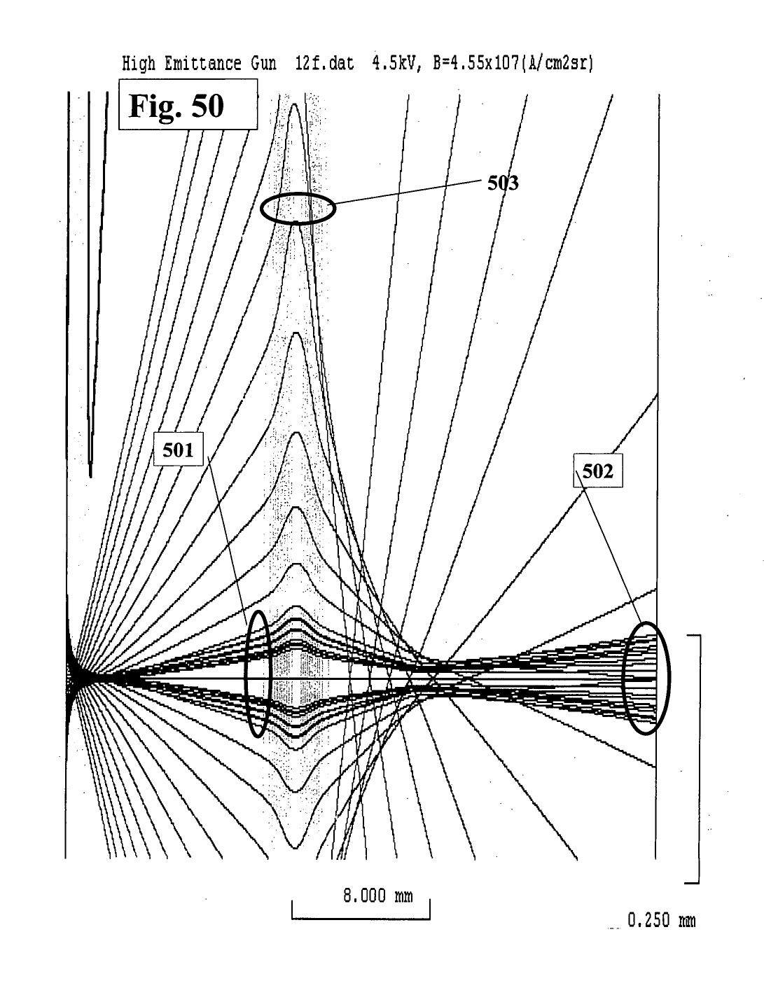

FIG. 50 is the electron beam trajectories for the case when the brightness is larger than Langmuir limit, and a negative voltage is applied in the electrostatic lens. As same as in FIG. 49, the trajectories started with equal separation become small density at the central part: 501 by the space charge effect; however, after the lens as shown in 502, at the evaluation plane the trajectory density is improved largely, and the brightness degrade due to the space charge effect is compensated. Therefore, the high brightness is confirmed. Lines 503 are equi-potential line for the lens excited by the negative voltage.

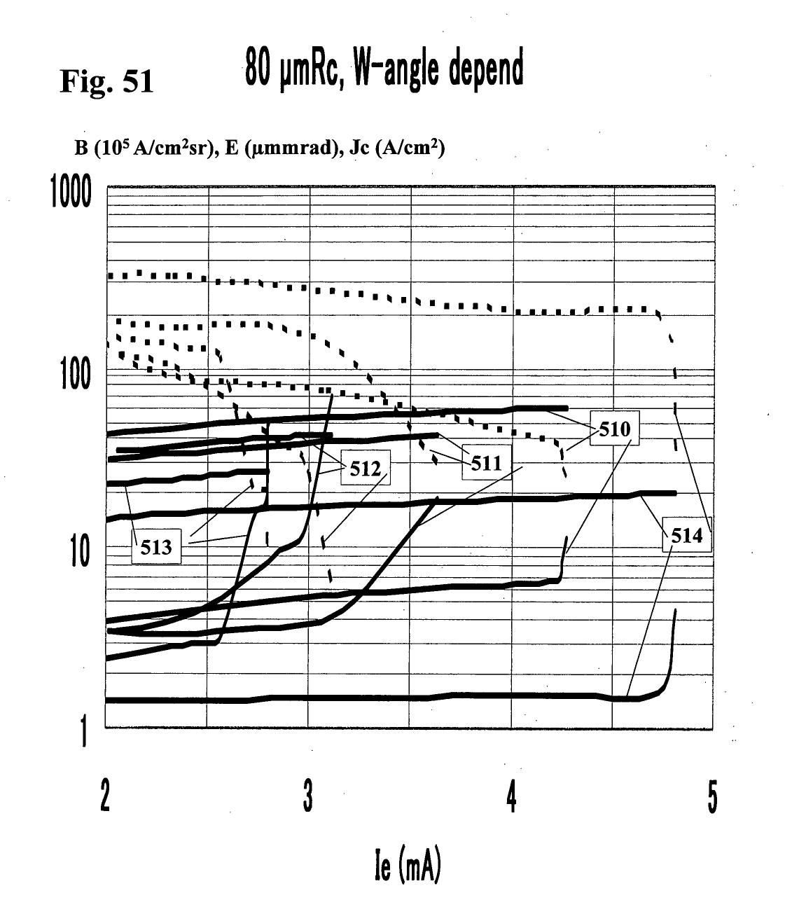

FIG. 51 is the simulated result for the model in FIG. 46, wherein the wehnelt angle is varied, where the cathode radius Rc is 80 μm. For the angle difference between the beam edge and the wehnelt are 93.2, 90.5, 83.6, 69.4 and 57.6 degrees are shown as curves 510, 511, 512, 513, and 514, respectively. The dotted curves are the Emittance, the solid short curves are the cathode current density, and the curves which curve upright at the right shoulder are the brightness. For the cases where the angle difference between the beam edge and the wehnelt angle from 93.2 to 69.4 degrees the brightness larger than 1×10⁶ A/cm²sr are obtained, however for the case of 57.6 degree of the same angle, the maximum brightness is 4.6×10⁵ A/cm²sr. From these fact it is required that the difference between the wehnelt angle and the proximity beam edge is larger than 69.4 degree. When we compare the curve 511 for the wehnelt angle is 90.5 degree and the curve 513 for 69.4 degree, the emission current ratio for obtaining the brightness larger than Langmuir limit is 2.8 mA/3.6 mA=0.777.

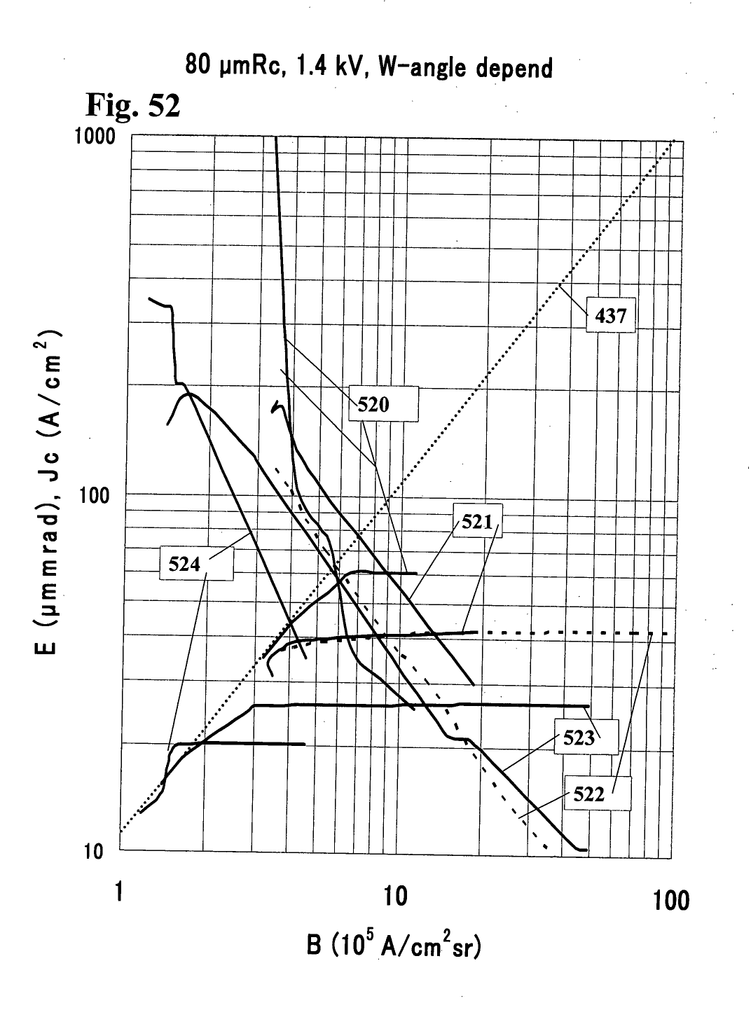

FIG. 52 is the brightness vs. Emittance curves (decreasing function of the brightness) and the brightness vs. cathode current density curves for the simulated results of FIG. 51. The curves 520, 521, 522, 523 and 524 are for the angle difference between the wehnelt and the beam edge: θw is 93.2, 90.5, 83.6, 69.4 and 57.7 degrees, respectively. The line 437 is Langmuir limit for the 1800 K cathode temperature and 4.5 keV of the beam energy, and for the conventional theory, there is no B-Jc curve right side of the line 437. The curve 521: 90.5 degree is right side of the line 437, and the larger brightness than Langmuir limit is obtained and has good characteristics. For the curve 520: 93.5 degree the cathode current density is too large. After all, the angle difference between the wehnelt angle and the proximity beam edge is the optimum from 69.4 to 90.5 degree, and the brightness larger than Langmuir limit is obtained, when the angle difference is larger than 69.4 degree. For the curve 524: 57.6 degree the brightness a little larger than Langmuir limit is obtained.

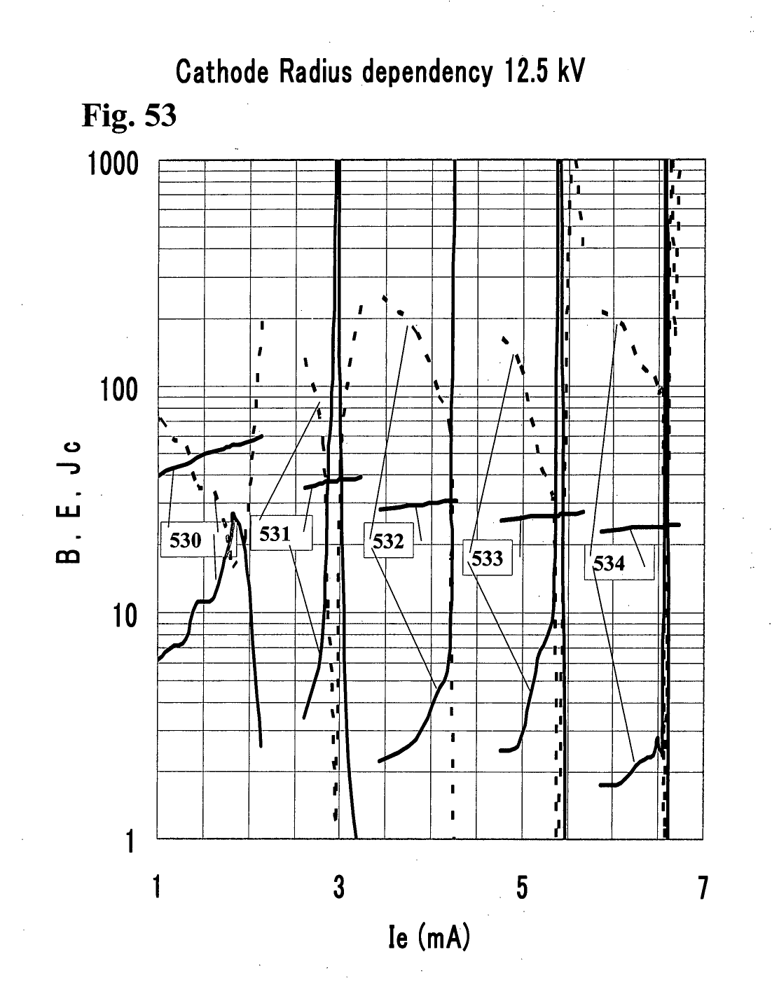

FIG. 53 is a simulated result as a function of the emission current for the model in FIG. 46, wherein the cathode radius: Rc is varied as 40, 80, 120, 160 and 200 μm, and the lens voltage is 12.5 kV, and for this condition the emission current, which give the brightness larger than Langmuir limit, is the smallest, as explain in FIG. 47. The ordinate is the brightness: B (10⁵ A/cm²sr), the Emittance: E (μmmrad), and the cathode current density: Jc (A/cm²). Also, the wehnelt angle is 90.5 degree, and the distance from the anode to the cathode is 1.2 mm. The results for said cathode radius are shown in the curves 530, 531, 532, 533 and 534, respectively. The short solid curves are the cathode current density (10⁵ A/cm²), the solid curves are the brightness (A/cm²sr), the dotted curves are the Emittance (μmmrad) and the abscissa is the emission current (mA). The emission current which give the maximum brightness are 1.82, 2.93, 4.24 5.4 and 6.58 mA, for the Rc from 40 to 200 μm, respectively. These current values are on the line as follows;

Ie=0.5+0.0304Rc.

Therefore, the condition for obtaining the brightness larger than Langmuir limit satisfies said equation. When for the case of no lens, said emission current condition is as follows;

Ie=0.0658Rc.

### And then when the lens condition is not optimum, Ie is in the range between said two equations, that is;

0.5+0.0304Rc≦Ie≦0.0658Rc. (103)

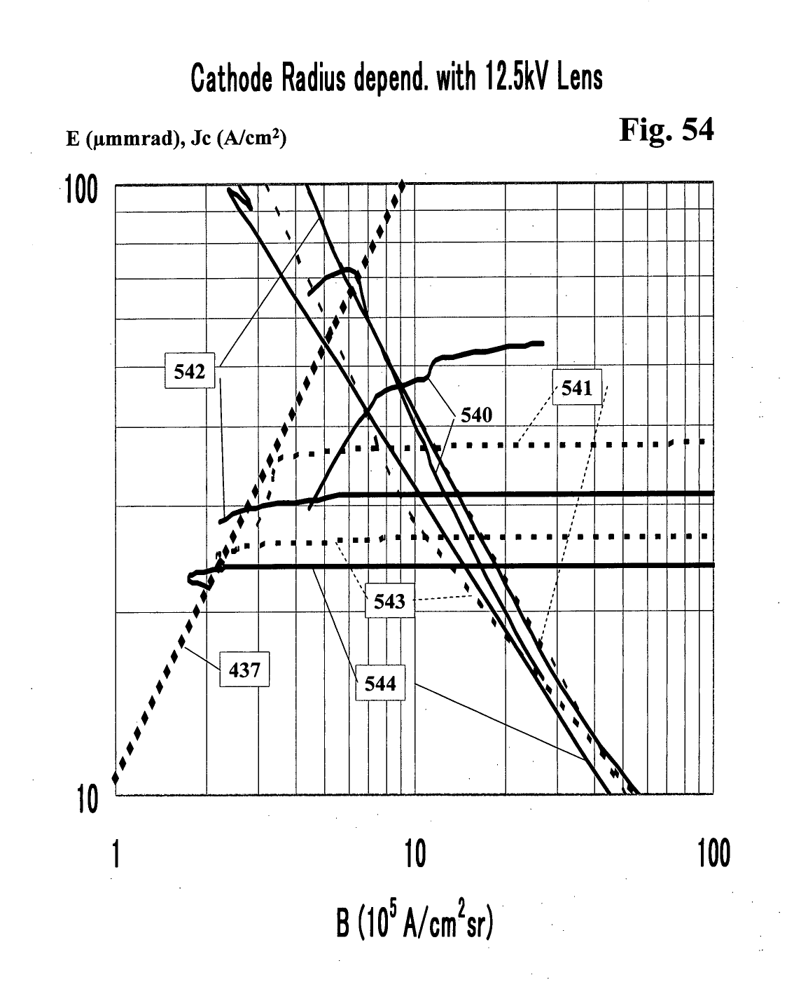

FIG. 54 is the brightness vs. Emittance curve and the brightness vs. cathode current density curve for the simulated results of FIG. 53, wherein the brightness is 10⁵ A/cm²sr and the Emittance is μmmrad, and the cathode current density is A/cm². The curves 540, 541, 542, 543 and 544 are the case where the cathode radius: Rc is 40, 80, 120, 140, 160 and 200 μm, respectively. The area, where the brightness vs. the cathode current density curve is nearly horizontal line, is right side of the line 437; correspond to the fact that the brightness increases rapidly in FIG. 53, and then the condition that the emission current Ie which give the brightness larger than Langmuir limit is as follows;

Ie≧0.5+0.0304Rc.

In the brightness vs. cathode current density curve for the larger cathode radius by the smaller cathode current density the brightness larger than Langmuir limit is obtained. Also, not so remarkable, in the B vs. E curves the smaller cathode radius tends to obtain the larger Emittance by the same brightness.

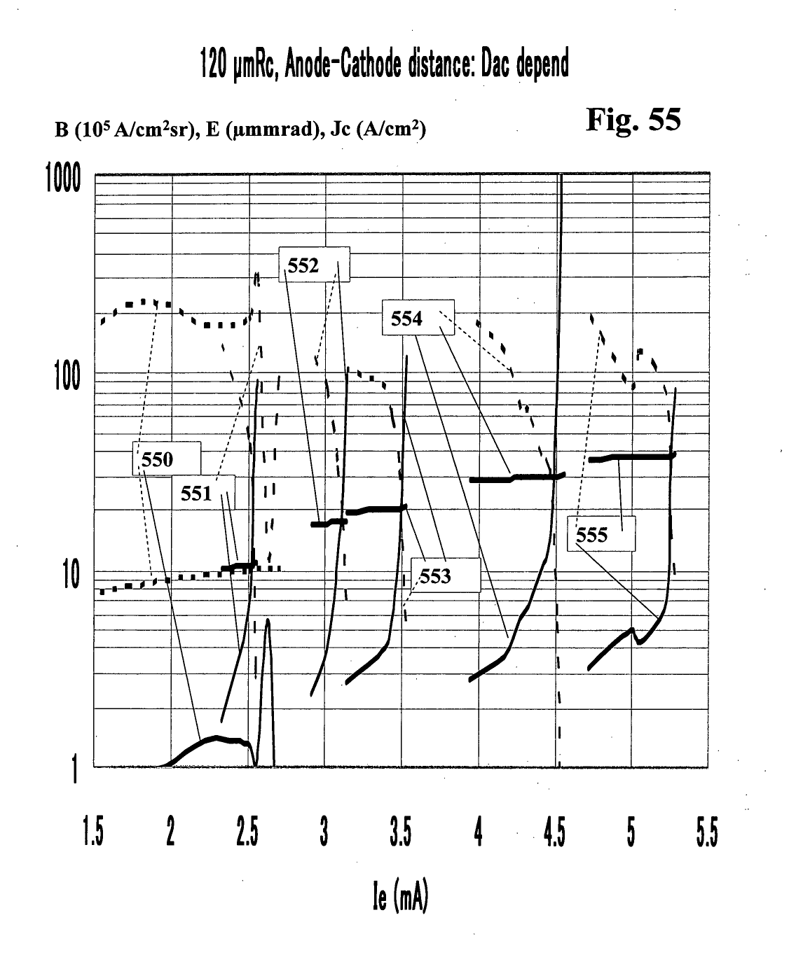

FIG. 55 is the simulated result for the model in FIG. 46, wherein the distance from the cathode to the anode: Dac is the parameter and the emission current is varied. The cathode radius is 120 μm, the lens voltage is 14 kV, and the wehnelt angle: θw is 90.5 degree. For the Dac of 3, 2.8, 1.6, 1.2 and 1 mm the results are shown as the curves 550, 551, 552, 553, 554 and 555, respectively. The dotted line curves are the Emittance (μmmrad), the solid curves are the brightness, and the solid short curves are the cathode current density. Through this invention the cathode current density is the value around the optical axis. For the electron gun with the anode to the cathode distance: Dac is 3 mm, the maximum brightness is 5.6×10⁵ A/cm²sr. For the electron gun where the Dac is smaller than 2.8 mm, the brightness is larger than 1×10⁷ A/cm²sr. As 4.5 kV is applied between the anode and the cathode, from these results it is said that when an electric field is from 1.6 to 4.5 kV/mm, the brightness larger than Langmuir limit is obtained.

Regarding the curves 551 and 554 the Ie value which the brightness is larger than Langmuir limit are compared. The result is as follows; for the Dac of 1.2 mm the Ie which give the brightness larger than Langmuir limit is 2.5 mA, the Dac of 2.8 mm Ie which give the brightness larger than Langmuir limit is 4.5 mA. The emission current ratio between the Dac of 2.8 mm and the Dac of 1.2 mm is 2.5/4.5=0.555, and then the result: eq. (103) from FIG. 53 for Dac of 2.8 mm is changed to Eq. (104); (0.5+0.0304Rc)×0.555≦Ie≦0.0658Rc, then

0.278+0.0169Rc≦Ie≦0.0658Rc, (104)

and when the optimum wehnelt angle, that is obtained from the discussion for FIG. 51, is used, the Ie is multiplied by 0.777, and then Eq. (104) become to Inequality: (105),

0.168+0.0131Rc≦Ie≦0.0658Rc. (105)

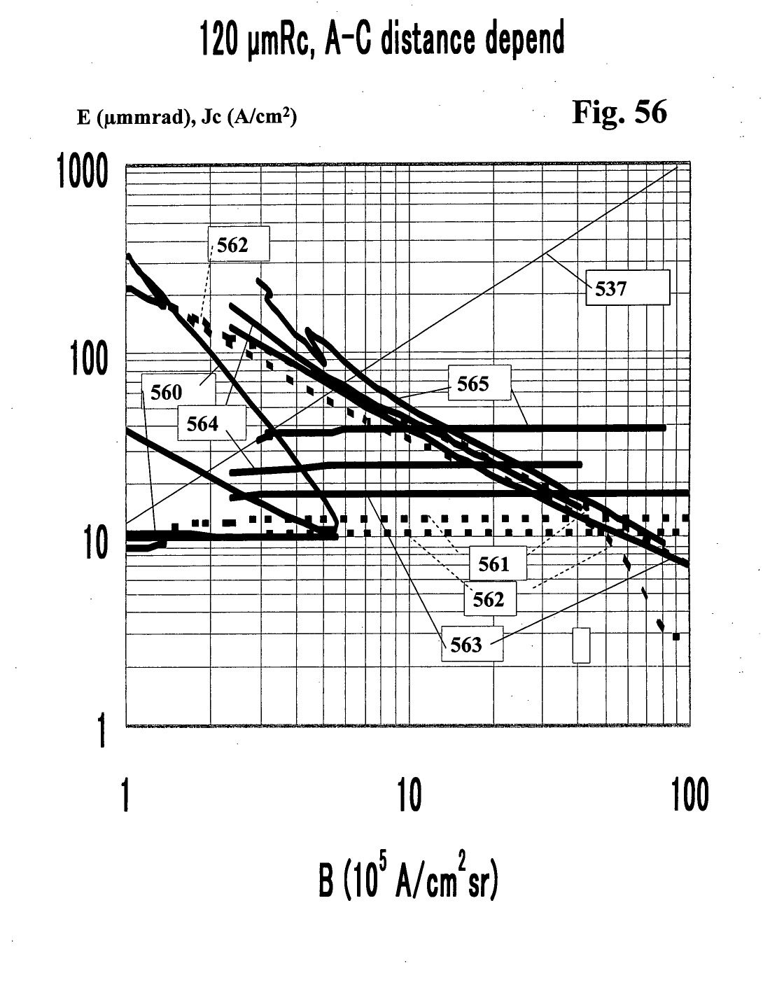

FIG. 56 is the brightness vs. Emittance curves and the brightness vs. cathode current density curves for the simulated results of FIG. 55, wherein the brightness is 10⁵ A/cm²sr and the Emittance is μmmrad, and the cathode current density is A/cm². The characteristics for the Dac of 3, 2.8, 2.2, 1.8, 1.4 and 1 mm are shown as the curves 560, 561, 562, 563 564 and 565, respectively. From the brightness vs. Emittance curves: 560, the case where Dac is 3 mm is no good, and for this condition the maximum brightness is 5.6×10⁵ A/cm²sr, however, as the some part of the B-Jc curve is right side of the line 537, and then the brightness larger than Langmuir limit is obtained.

The larger cathode to the anode distance tend to obtain the larger Emittance for the same brightness, by way of compensation the condition have a problem that the cathode current density at the high brightness is large. Therefore, from this figure the optimum electric field between the anode and the cathode is the range from 1.6 to 4.5 kV/mm.

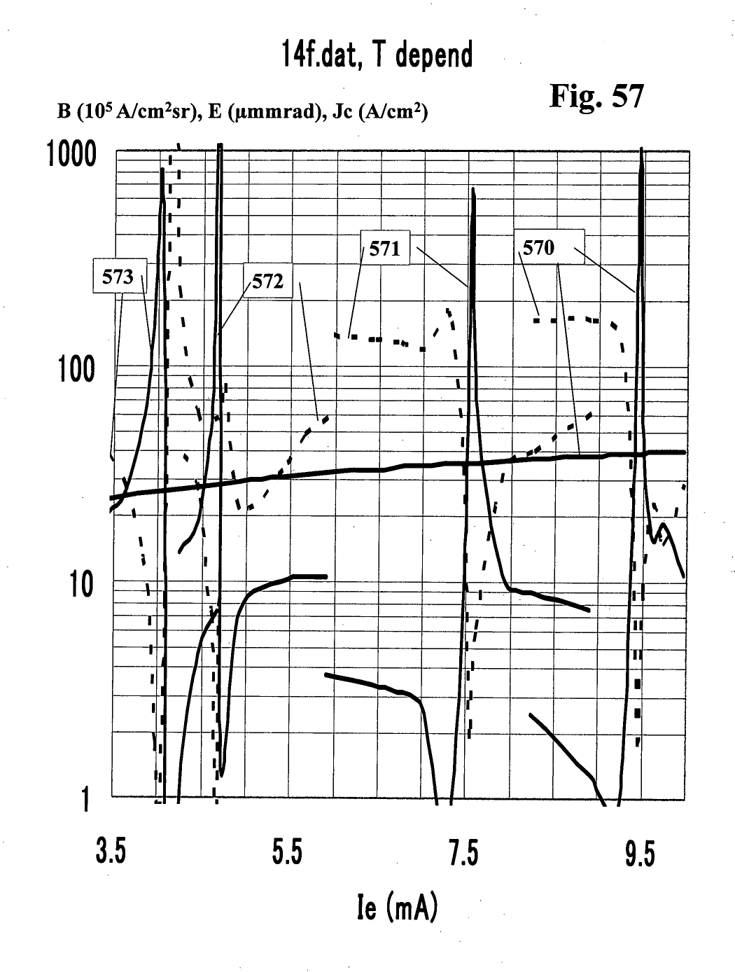

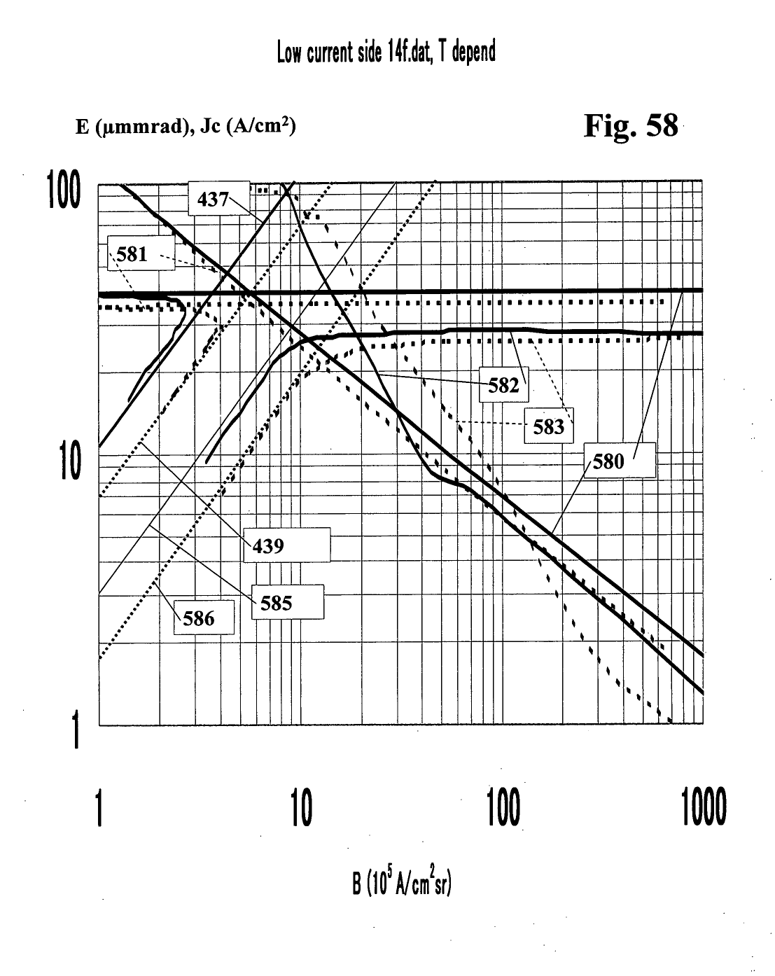

In the next stage for the case where the cathode temperature is varied is explained in FIGS. 57 and 58. For the model in FIG. 41 with no lens and the cathode radius: Rc is 140 μm, Dac is 1.2 mm, and the wehnelt angle is 90.5 degree. For the cathode temperature of 1800, 1100, 450 and 292 K, the simulations are done and the results are shown as curves 570, 571, 572 and 573. The cathode temperature of 1800 K correspond to CeBix cathode of which work function is 2.35 eV, the cathode temperature of 1100 K correspond to the oxide cathode for example Ba or Sr of which work function is 1.15 eV, the cathode temperature of 450 K correspond to the assumed combination the photo cathode and the excitation laser for which the difference between the work function and the laser photon energy is less than 0.2 eV, and the cathode temperature of 292 K correspond to the photo cathode with a negative electron affinity and its work function is assumed to −0.01 eV.

In FIG. 57 the solid curves are the brightness (10⁵ A/cm²sr), the dotted curves are the Emittance, and the short curves are the cathode current density. For each cathode temperature, the cathode current density is the same value for the same emission current. For the curve 570 where the cathode temperature is 1800 K, when Ie is increased, the brightness start to decrease and have a minimum at 9.2 mA, and after that has the maximum value and then decrease rapidly. The Emittance decrease from a constant value and decrease rapidly when the brightness start to increase, and it increase when the brightness decrease, and reach to a constant smaller value. For the curve 571 where the cathode temperature is 1100 K, when Ie is increased, the brightness start to decrease and have a minimum at 7.25 mA, and after that has the maximum value at 7.55 mA and then decrease rapidly. The Emittance decrease from a constant value and decrease rapidly when the brightness start to increase, and increase when the brightness decrease. For the curve 572 where the cathode temperature is 450 K, different from the former two cases, when Ie is increased, the brightness increase monotonically and have a maximum at 4.2 mA, and after that decrease rapidly. The Emittance decrease rapidly when the brightness start to increase, and increase rapidly when the brightness decrease, and have a maximum value. For the curve 573 where the cathode temperature is 292 K, the brightness and the Emittance show same Ie dependence as the case of 450 K, and the maximum brightness is obtained at the Ie of 4.02 mA, this value is much smaller than 9.45 mA which is for the case of 1800 K. Therefore it is clear that the electron gun, whose cathode is the photocathode with the negative electron affinity, obtain the brightness larger than Langmuir limit more easily than the thermal cathode as LaB6 or CeBix.

When two Ie values, for obtaining the brightness larger than Langmuir limit for the cathode temperatures of 292 and 1800 K, are compared, the ratio 4.02/9.45=0.425 is reduced. Therefore, for the electron gun whose cathode is photo cathode with a negative electron affinity, the emission current Ie condition which the brightness become larger value than Langmuir limit is as follows,

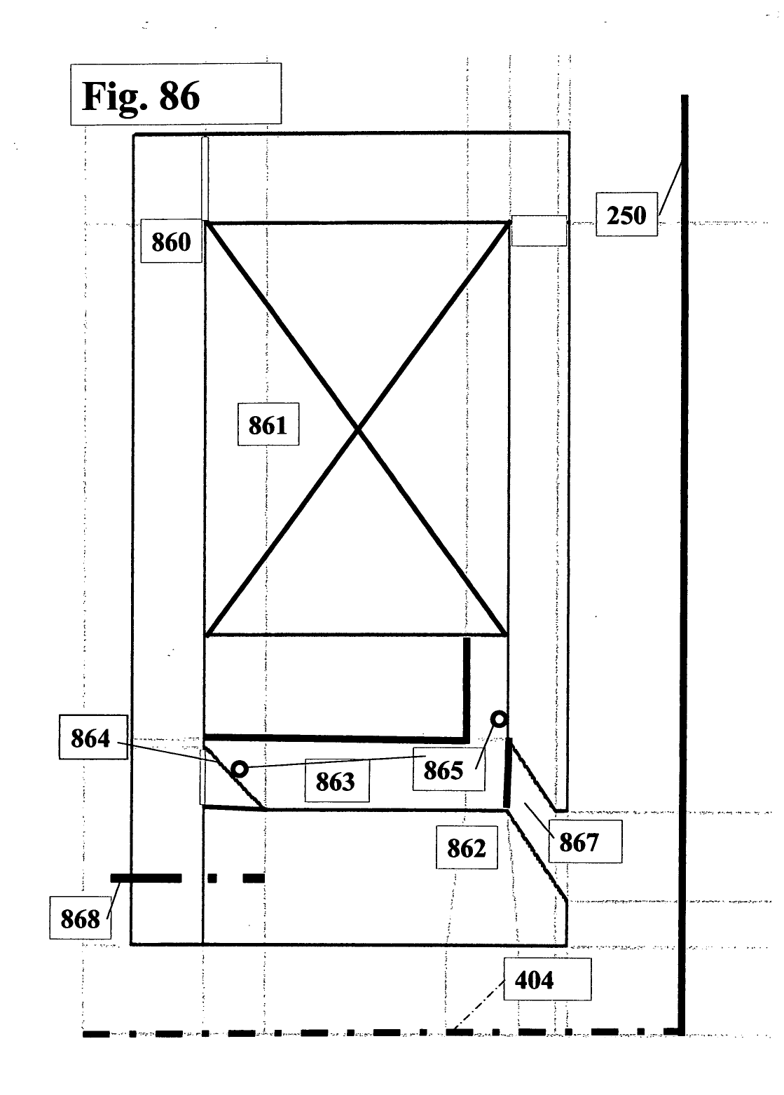

0.0714+0.00557Rc≦Ie≦0.0658Rc, (106)

where the left side is multiplied by 0.425. Regarding this a detailed will be shown later in FIG. 86.

FIG. 58 is the brightness vs. Emittance curves (decreasing function of B) and the brightness vs. cathode current density curves for the simulated results of FIG. 57, wherein the brightness is 10⁵ A/cm²sr and the Emittance is μmmrad, the cathode current density is A/cm², and the B vs. Jc curve are made using only the data where Ie is larger than a value with the maximum brightness. The results for the cathode temperature of 1800, 1100, 450 and 292 K are shown as the curves 580, 581, 582 and 583, respectively. Langmuir limits for the cathode temperatures of 1100, 450 and 292 K are calculated from Eq. (-1), and shown as 439, 585 and 586, respectively.

From the B vs. E curves, the electron gun with the photocathode has larger Emittance than the electron gun with LaB6, CeBix, or Oxide cathode, when the brightness is around 1×10⁶ A/cm²sr.

In the B vs. Jc curves, some parts of the curves 580, 581, 582 and 583 are the right side of the lines 437, 439, 583 and 586, respectively, and then the electron gun with lower temperature cathode have the brightness larger than Langmuir limit for the lower temperature.

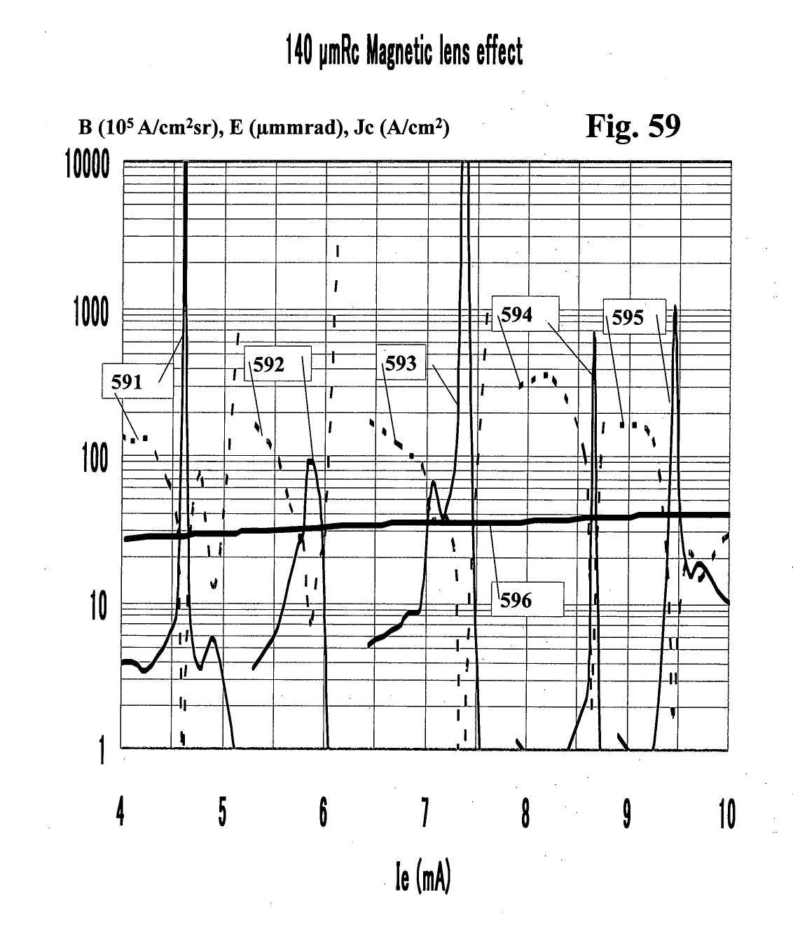

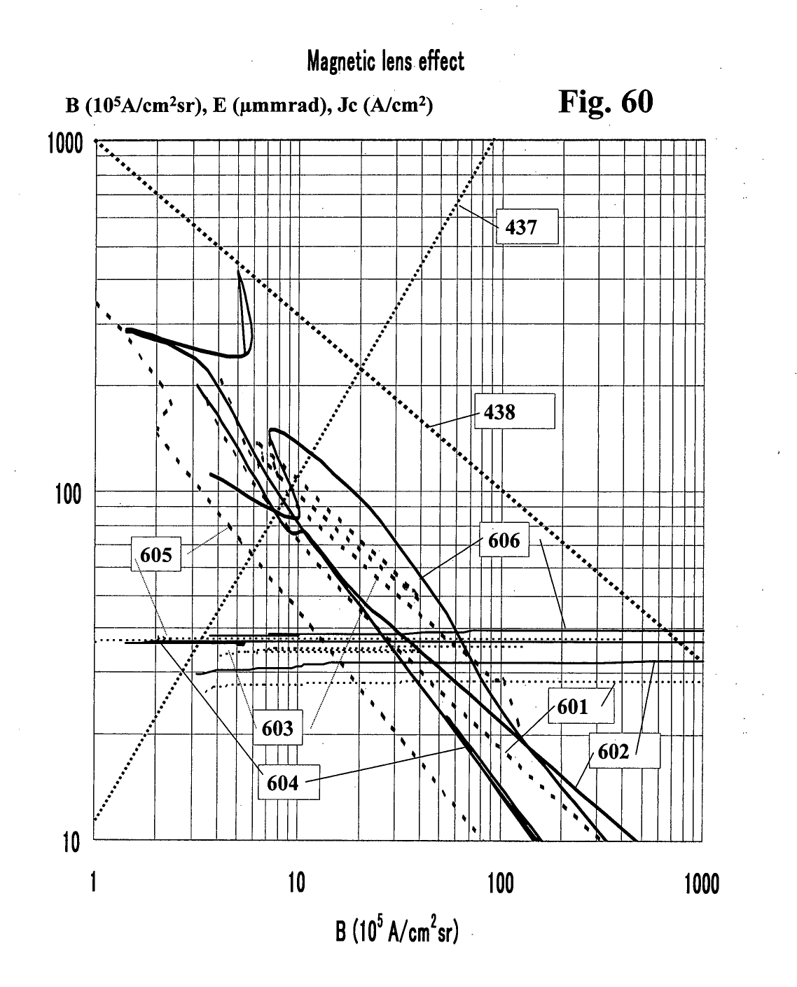

In FIG. 47, it is shown that when the electro static lens is designed, the brightness larger than Langmuir limit is obtained by smaller emission current than the case of no lens. It is studied that if the electro static lens is changed by the electro magnetic lens, the brightness larger than Langmuir limit is obtained or not. For the electromagnetic lens with the bore radius is 1 mm and the lens gap is 1 mm, the excitation AT is varied and the simulation is done. The results are shown in FIGS. 59 and 60. FIG. 59 is a simulated result of the model in FIG. 46, where the brightness (solid curves), the Emittance (dotted curves), and the cathode current density (nearly horizontal curve) as a function of the emission current. The excitation AT is 500, 550, 600, 400, and 0 AT for the curves 591, 592, 593, 594 and 595, respectively.

The curve 595 with no excitation has the high brightness at the emission current of 9.4 mA; on the other hand, for the excitation of 500, 550, 600 and 400 AT, the maximum brightness condition are the emission current of 4.6, 5.85, 7.4, and 8.6 mA, respectively. That is to say, by through the magnetic lens, smaller emission current gives the maximum brightness than the no lens case. Common to all lens condition, when the emission current increased, the brightness increase monotonically until the maximum brightness is obtained, after the maximum brightness the brightness decrease rapidly and become the minimum value. When the emission current increase the Emittance decrease monotonically until it become the minimum value, after the minimum the Emittance increase rapidly, and this change is contrary to the change for the brightness.

FIG. 60 is the brightness vs. Emittance curves and the brightness vs. cathode current density curves for the simulated results of FIG. 59, wherein the abscissa is 10⁵ A/cm²sr and the ordinate is E (μmmrad), or Jc (A/cm²). The curves 601, 602, 603, 604, 605 and 606 are the cases where the lens excitations are 500, 550, 450, 600, 400 and 0 AT, respectively. The line 437 is Langmuir limit and for the conventional theory right side of this line there is no B vs. Jc curve. The line 438 is explained in FIG. 43. In this figure the slopes of the B vs. E curves are larger than that of the line 438, and then the obtainable maximum beam current is at the condition of the low brightness and high Emittance. The B vs. E curve 606 is the most upper side than all the curves 601, 602, 603, 604 and 605, for the brightness range from 7×10⁵ A/cm²sr to 7×10⁶ A/cm²sr, unfortunately, the obtainable maximum beam current is small when the lens effect is used.

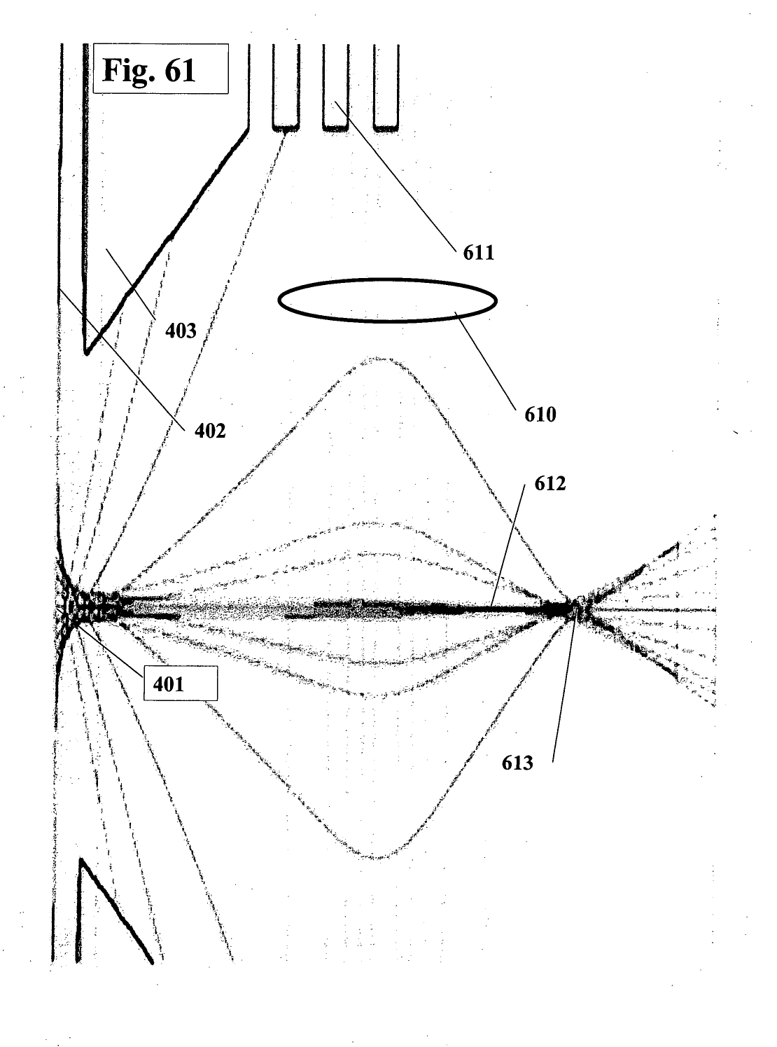

FIG. 61 is the electron beam trajectories for studying why the brightness becomes high value when the magnetic lens is operated. For this case the applied voltage on the central electrode is 4.5 kV and the same value on the other two electrodes. Vertical lines 610 are the magnetic equi-potential surface, and show the magnetic lens position. As same as in FIGS. 44 and 45, the trajectory density at the target is much improved than that before the lens. Also, the crossover 612 for the trajectory around the optical axis is near to the cathode than that 613 for the far trajectory from the optical axis. This means that a negative spherical aberration is generated. The negative spherical aberration is generated by the space charge effect and the anode hole lens. The latter does not depend on the beam current, and then similar to the conventional electron gun. The different point from the conventional electron gun is as follows: The large space charge effect due to the large emission current forms large space charge effect and the large negative spherical aberration compensate a positive spherical aberration due to the electron gun and the magnetic lens. This compensation condition generates the high brightness. It is not clear that this explanation is right or not, however a commonsense; that is, the lens can not increase the brightness, is denied by this simulation.

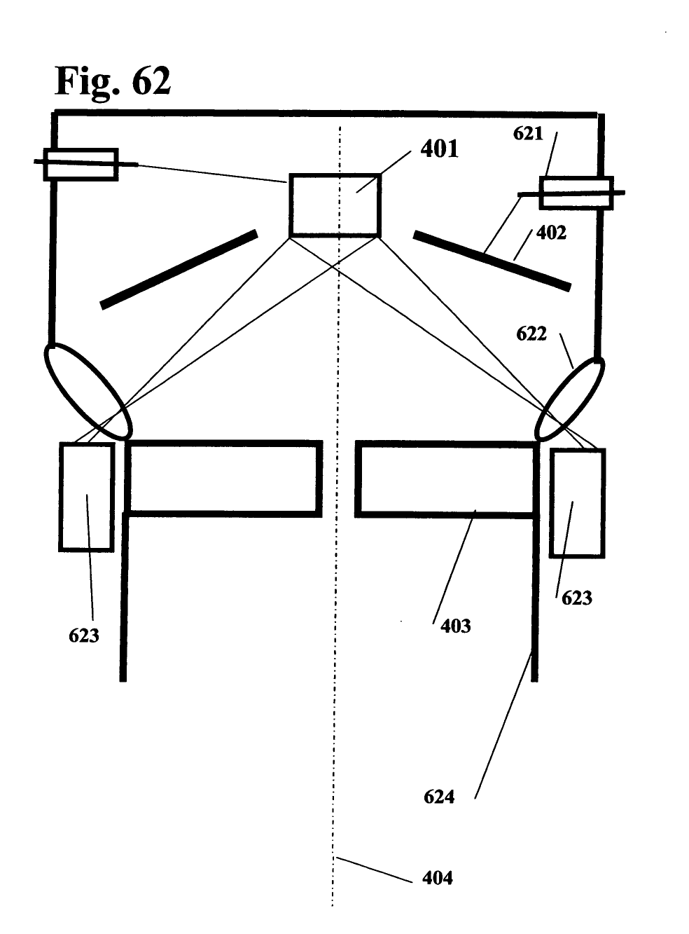

FIG. 62 is the electron gun design example with the photocathode in this invention. The cathode 401, wehnelt 402 and the anode 403 are axial symmetry around the optical axis 404. The angle difference between the wehnelt and the beam edge is larger than 69.4 degree, and this angle is relatively large so that laser light passes through between the wehnelt and the anode. The laser light generated by the laser source 623 pass through an optical lens 622 and irradiates the electron emission area. The applied voltage is introduced through the hermetic seal 621. The electron optics 624 is connected to the electron gun.

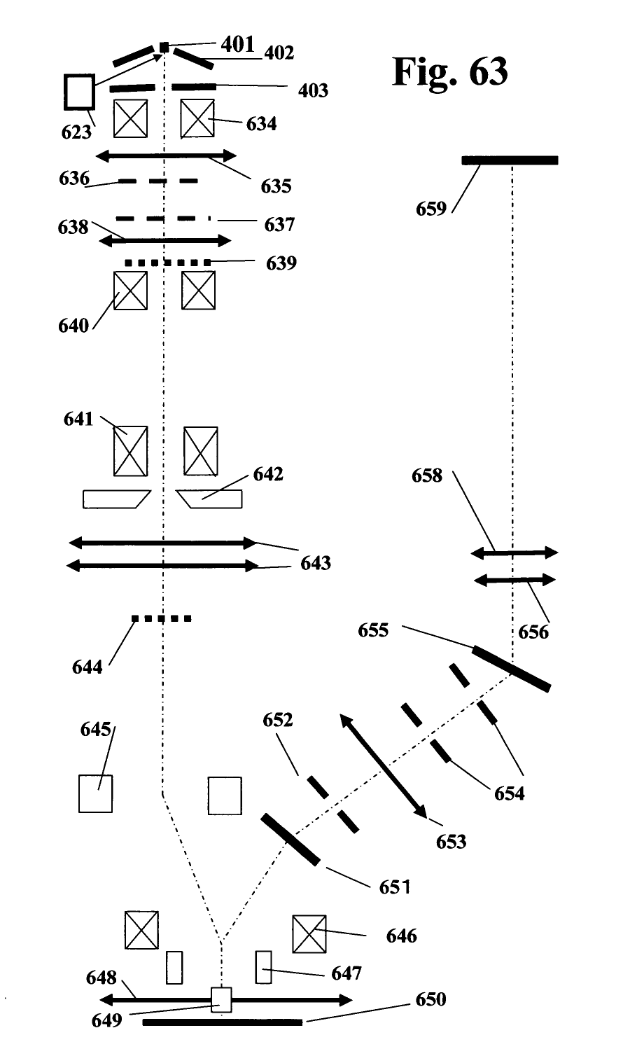

FIG. 63 is the electron optics with the high brightness electron gun in this invention. By utilizing said high brightness effectively, multiple beam with large beam current can be formed around the optical axis. As a matter of course some beams are formed at distant position from the optical axis, then the finer cares are required than the single beam case. The electron optics has two axial offsets in the primary and the secondary optics as shown in FIG. 63. The electron gun consists of the cathode 401, the wehnelt 402 and the anode 403. The electron beam emitted from the electron gun is aligned to the condenser lens 635 by the alignment deflector 634. The condensed beam by the condenser lens 635 is aligned to the 2^{nd} condenser lens 638 and the multiple apertures 639 by 2 stage alignment deflectors 636 and 637. The multiple beams formed by the multiple apertures are aligned to the NA aperture 642 and the rotation and reduced lenses 643 by the 2 stage deflectors 640 and 641 and reduced by the rotation and reduced lenses 643; and form the multiple beam images at position 644. Said optical axis offset is corrected by the electrostatic deflector 645 and the electromagnetic deflector 646, and the multiple beams enter to the objective lens 648 normally, and irradiate and scan to the specimen surface 650. The scanning to the specimen is done by a scanning signal added to the electrostatic deflectors 645 and 647. A cylindrical electrode 649 is designed for reducing the axial chromatic aberration of the multiple beams and the positive high voltage is applied. The SEs emitted from the scanned specimen is separated from the primary optics by the electromagnetic deflectors 646 and 651 and corrected normal by the electromagnetic deflector 655. The SE images from each multiple beams are magnified by the objective lens 648, electrostatic lens 653, and two stage lenses 656 and 658; and detected by the detectors 659 independently.

The objective lens 648 is the electromagnetic lens with the lens gap at the specimen side and then has the small axial chromatic aberration. By applying the positive high voltage to the cylindrical electrode the axial chromatic aberration is still more reduced.

The sectional figure for the objective lens is shown in FIG. 86. An excitation coil 861 is surrounded by a permenjur core which form an inner magnetic pole 862 and by a permalloy core which form an outer magnetic pole 860. A vacuum seal is done by two O-ring 865 and a nonmagnetic metal ring 863, whose section is L-character shape. An acceptance surface 864 for the O-ring 865 have a triangle sectional shape for reducing magnetic resistance from pole 860 to the pole 862, and a curved surface concave to the O-ring side is better for this surface. As screws 868 can be used for fixing two magnetic poles on the optical axis direction, high accuracy assembling is possible. As a summary, the magnetic lens whose lens gap is the specimen side, said lens gap is formed by the inner pole and the outer pole, the inner pole is made of high saturation magnetic flux density material, said the outer pole is made of high permeability magnetic material, and at connection part for these two magnetic pole the outer pole have ring shape projection, and the one surface of said projection contacts with the inner magnetic pole and the other surface is the acceptance for the O-ring, and the O-ring acceptance surface is better when said surface is concave to the O-ring side. As a results, the magnetic resistance at the connection part for two magnetic poles become small and an axial magnetic field distribution have a single peak, and then no parasitic aberration generate.

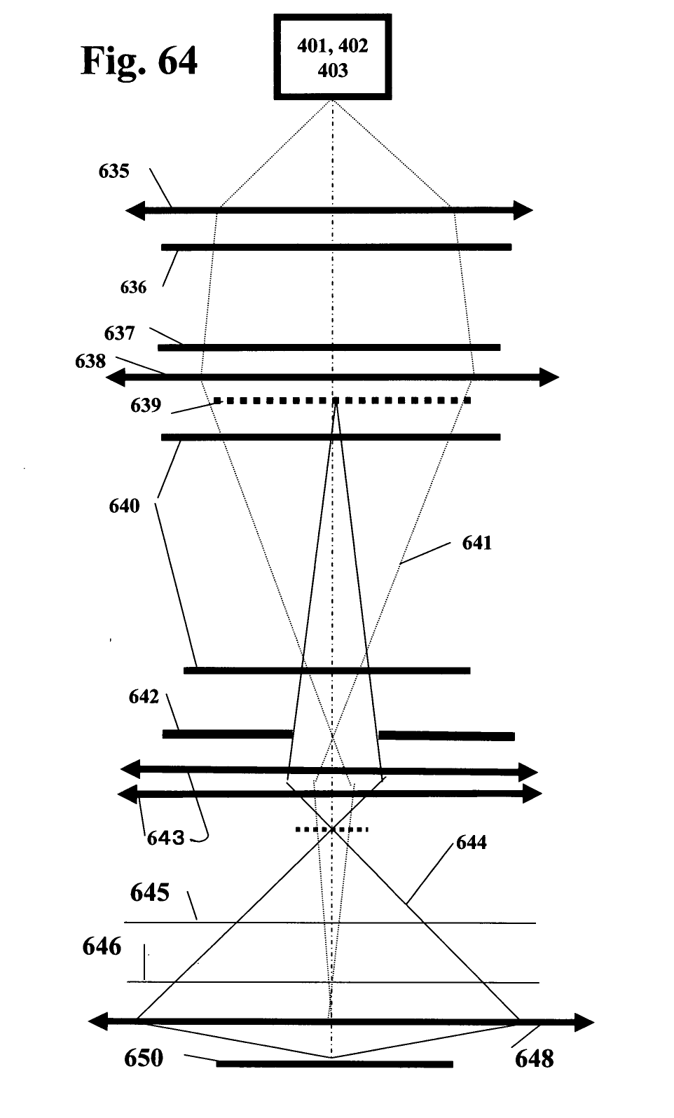

FIG. 64 is a detailed figure of only the primary optics of the FIG. 63, wherein the optical axis offset and two deflections for the optical offset compensation are neglected. In FIG. 64, the lines 644 are the image lines for the multiple apertures, and the lines 641 are the image lines for the crossover image. The electron beam emitted from the electron gun pass through two stage lenses 635 and 638 and makes a magnified crossover after the multiple apertures, and the magnification is adjustable. As a results, the current density at the multiple aperture is large and the uniform irradiation intensity area can be adjustable just cover the multiple aperture area. In this crossover imaging, the crossover is not formed between two condenser lenses, and then the energy width increase is small and the effect for using photo cathode with the negative electron affinity material is large.

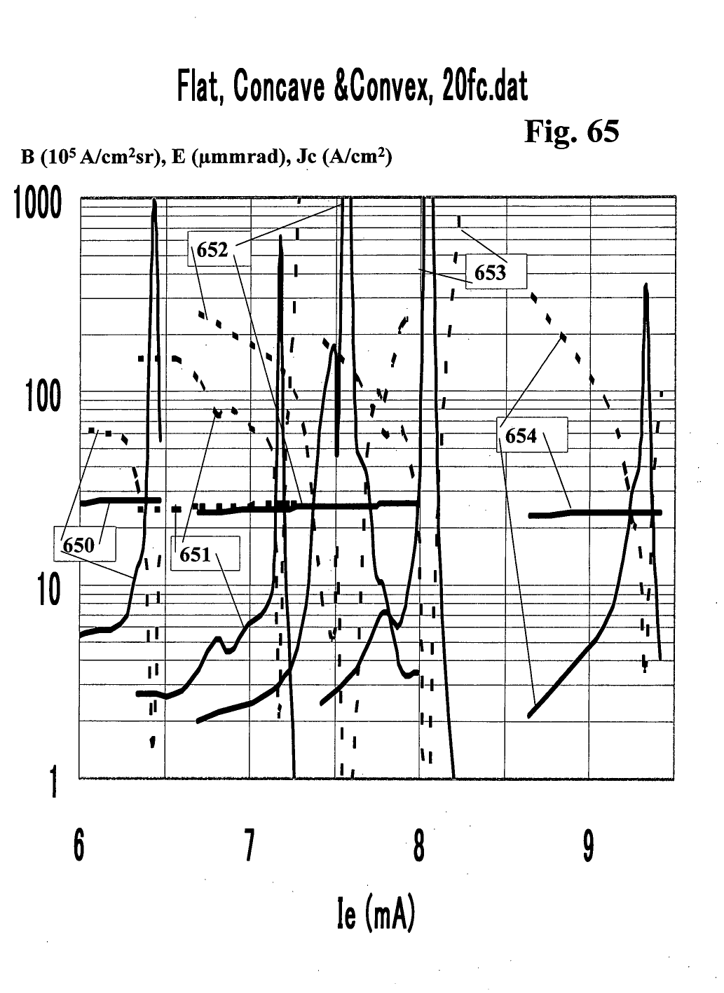

FIG. 65 is the simulated result of the model in FIG. 46, wherein the cathode surface is not a flat but a curvature, the radius of curvature is varied as 5 mm, 1.5 mm, ∞, −1.5 mm, −5 mm, and the results are shown as 650, 651, 652, 653 and 654, respectively, where the positive curvature means convex to the anode and the negative curvature means concave to the anode. The cathode radius is fixed to 200 μm, the lens excitation is 12.5 kV, the wehnelt angle: θw is 90.5 degree, and the Dac is 1.2 mm. For the flat cathode case: the curve 652, the maximum brightness is obtained at 7.6 mA of the emission current, and for the convex cathode with 1.5 mm radius of curvature case: the curve 650, the emission current of the same condition is 6.4 mA. The emission current for obtaining the brightness larger than Langmuir limit is reduced 6.4/7.6=0.842 times, and then the left side of the Inequality (105) is multiplied by 0.842, and then,

0.141+0.0142Rc≦Ie≦0.0658Rc. (107)

For the concave cathode with 1.5 mm radius of curvature case: the curve 654, the emission current of the same condition is 9.38 mA. The emission current for obtaining the brightness larger than Langmuir limit is increased 6.4/7.6=1.234 times, and then the left side of the Inequality (105) is multiplied by 1.234, and then,

0.207+0.0162Rc≦Ie≦0.06Rc. (108)

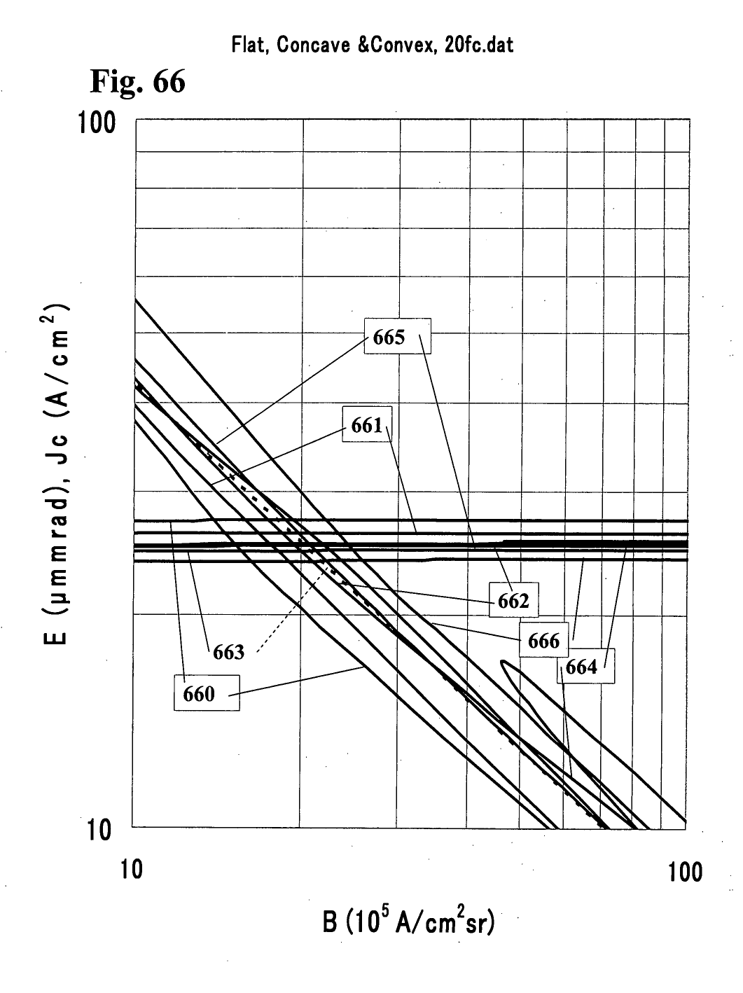

FIG. 66 is the brightness vs. Emittance curves (decreasing function curves) and the brightness vs. cathode current density curves (nearly horizontal lines) for the simulated results of FIG. 65, wherein the abscissa is the brightness (10⁵ A/cm²sr) and the ordinate is the Emittance (μmmrad), or the cathode current density (A/cm²). The curves 660, 661, 663, 664, 665 and 666 correspond to the case where the cathode radius of curvature are 1.5, 3, 5, ∞, −5, −3, −1.5 mm, respectively. For the curve 660: 1.5 mm convex, the B vs. E position is the most left side, and then the Emittance is the smallest, and the B vs. Jc curve is the most upper side, therefore this cathode curvature is the worst. Contrary, for the curve 666: −1.5 mm concave, the B vs. E position is the most right sides, and then the Emittance is the largest for the same brightness, and the B vs. Jc curve is the most bottom side, and then this cathode curvature is the best.

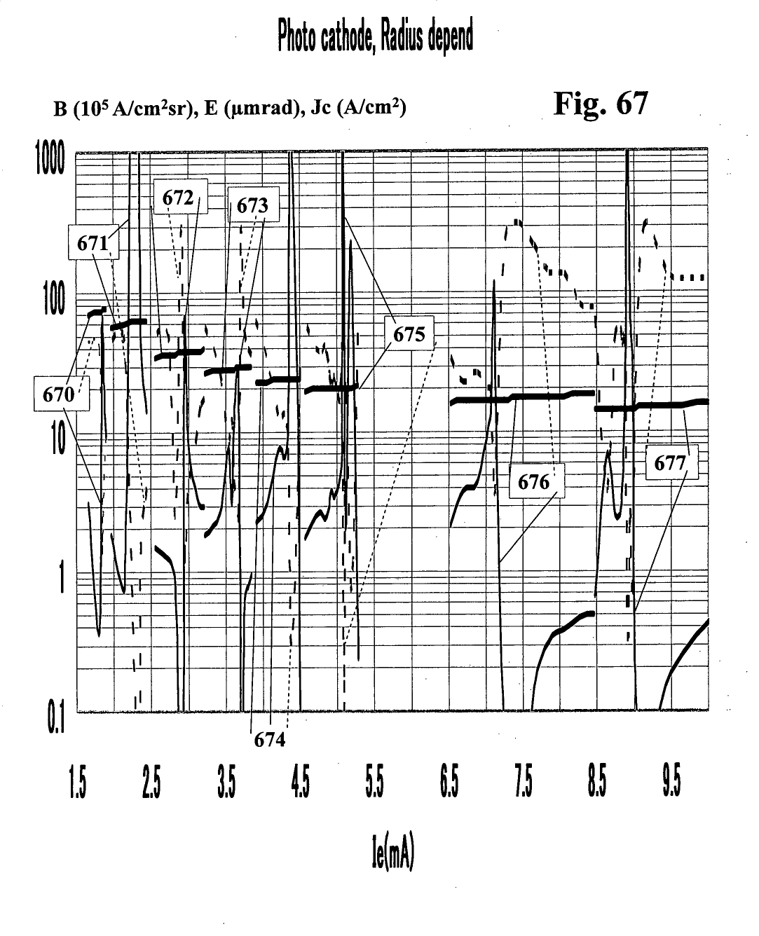

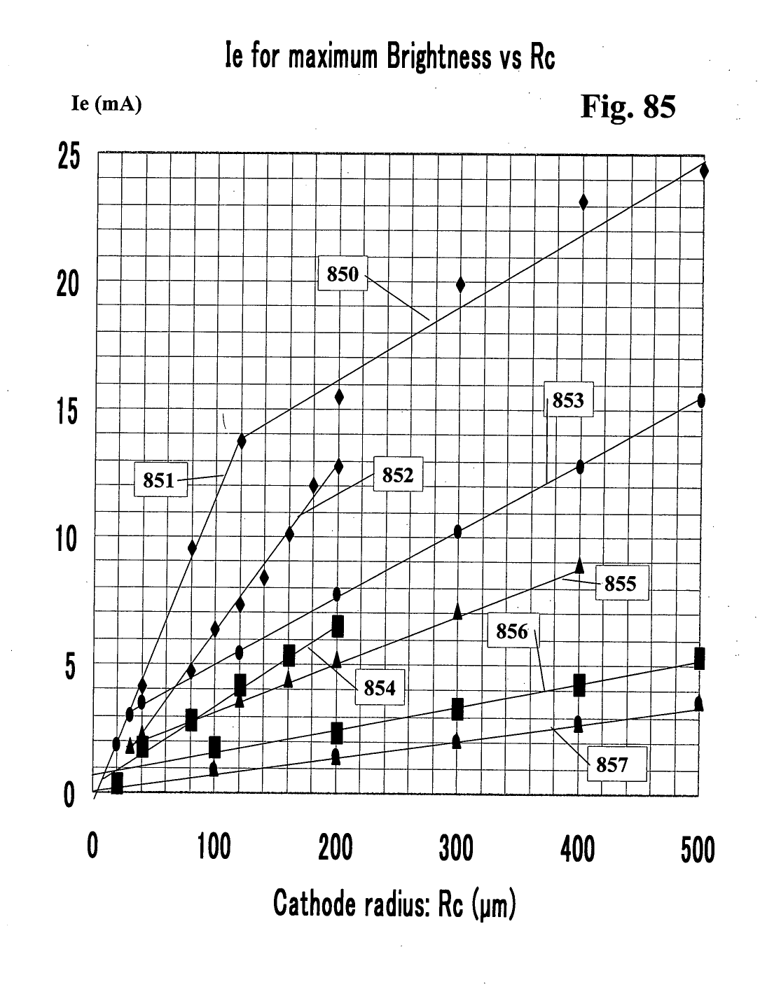

FIG. 67 is the simulated result of the gun with the photo cathode with the negative electron affinity, the flat beam drawing electrode, and the truncated cone shape wehnelt, wherein the Dac is 1.2 mm, the θw is 90.2 degree, the lens excitation is 6.5 kV, the cathode temperature is 293 K, the cathode work function is −0.01 eV, and the cathode radius is varied as 20, 30, 40, 60, 80, 120, 160, and 200 μm. The results are shown as the curves 670, 671, 672, 673, 674, 675, 676 and 677, respectively. The dotted line curve is the Emittance (μmmrad), the solid curve is the brightness (10⁵ A/cm²sr) and the short curves are the cathode current density (A/cm²). For each cathode radius the emission current which gives the maximum brightness is read from the figure as 1.85, 2.2, 2.95, 3.55, 4.4, 6.2, 7.05, and 8.9 mA. These results are used later (FIG. 85).

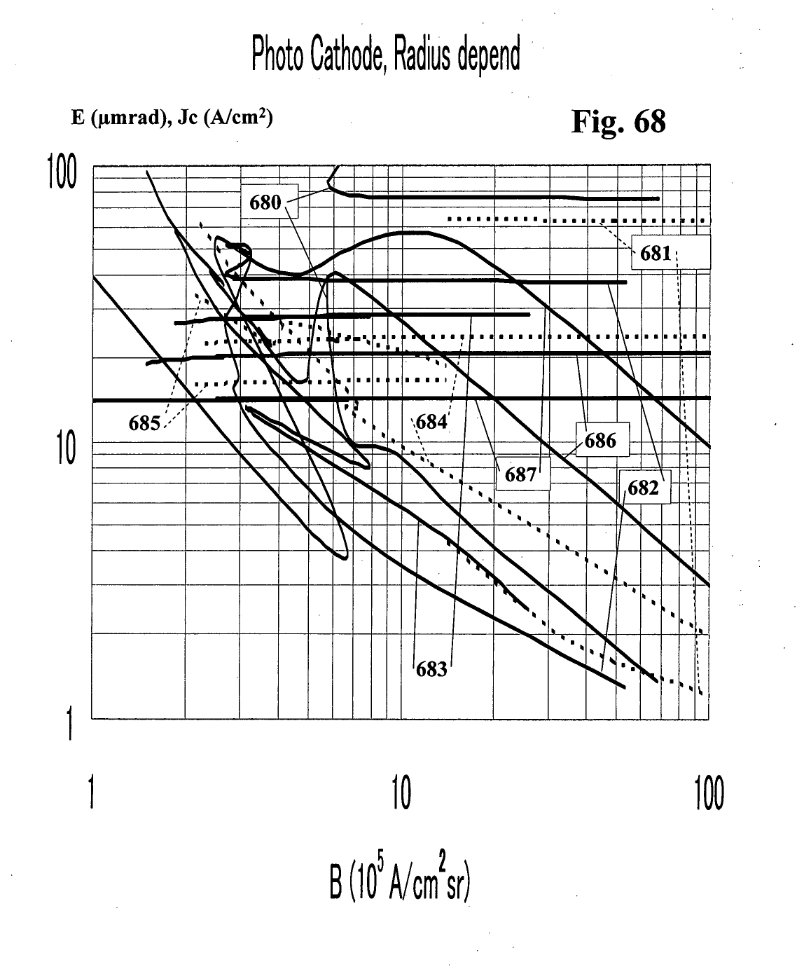

FIG. 68 is the brightness vs. Emittance curves (roughly decreasing function) and the brightness vs. cathode current density curves (nearly horizontal line) for the simulated results of FIG. 67, wherein the abscissa is the brightness (10⁵ A/cm²sr) and the ordinate is the Emittance (μmmrad), or the cathode current density (A/cm²). For the cathode radii of 30, 40, 80, 120, 160 and 200 μm, the results are shown as the curves 680, 681, 682, 683, 684, 685, 686 and 687, respectively.

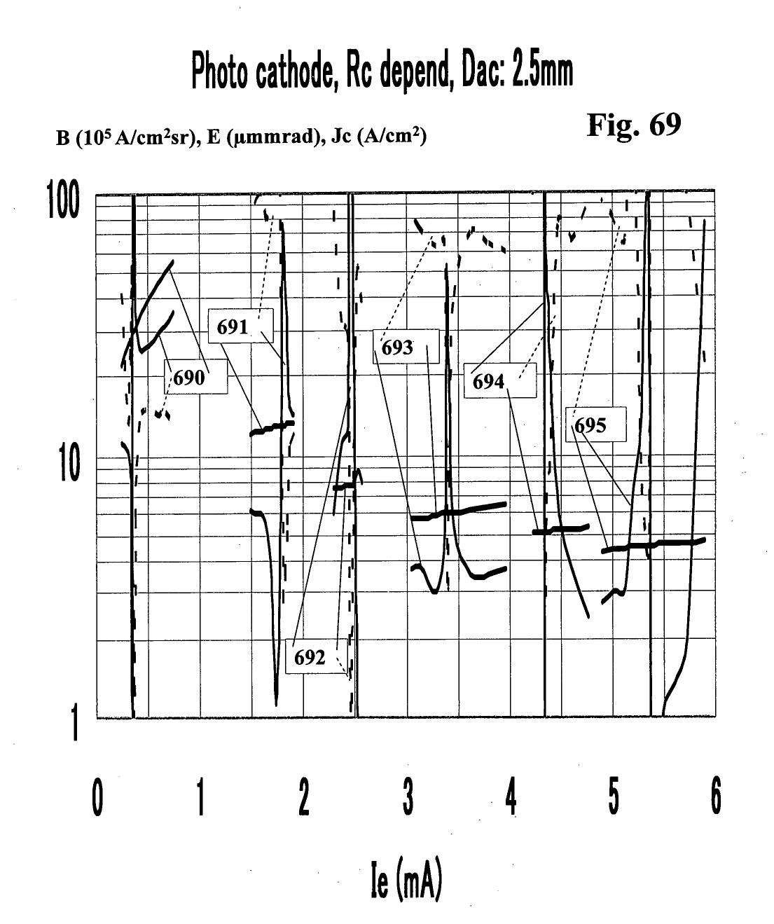

FIG. 69 is the simulated result of the gun with the photo cathode, wherein the cathode work function is −0.01 eV, the cathode temperature is 293 K, the θw is 90.5 degree, the Dac is 2.5 mm, and the cathode radius is varied as 20, 100, 200, 300, 400, and 500 μm. The results are shown as curves 690, 691, 692, 693, 694 and 695, respectively. For each cathode radius the emission current which gives the maximum brightness is 0.361, 1.8, 2.45, 3.39, 4.34 and 5.36 mA. These results are used latter (FIG. 85).

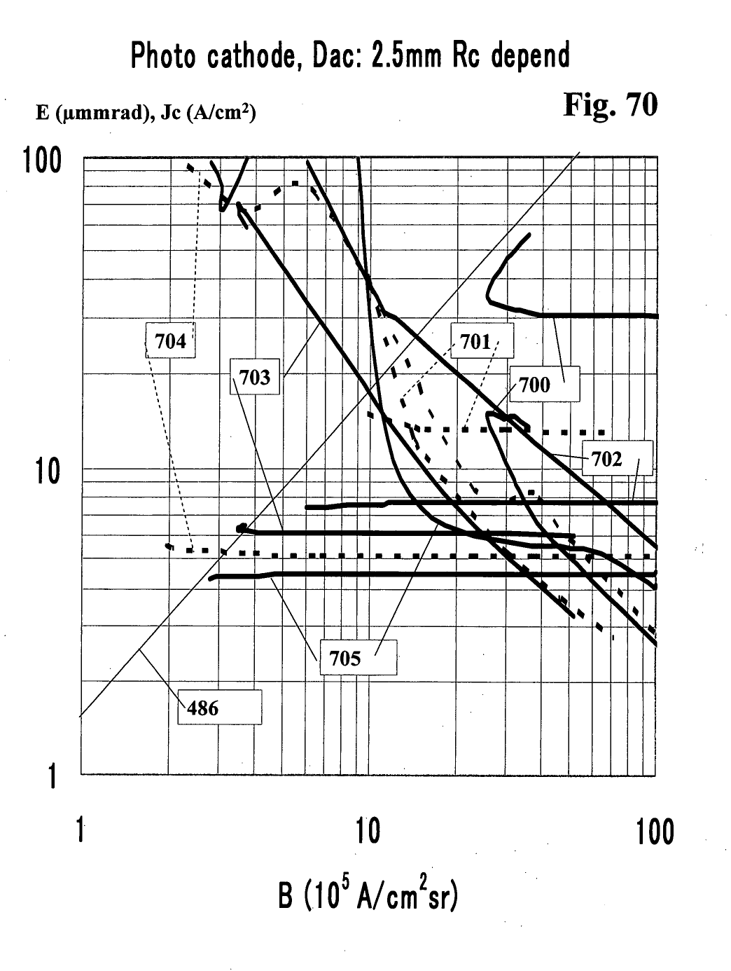

FIG. 70 is the brightness vs. Emittance curves (roughly decreasing function) and the brightness vs. cathode current density curves (nearly horizontal lines) for the simulated results of FIG. 69, wherein the abscissa is the brightness (10⁵ A/cm²sr) and the ordinate is the Emittance (μmmrad), or the cathode current density (A/cm²). For the cathode radius of 20, 100, 200, 300, 400 and 500 μm, the results are shown as the curves 700, 701, 702, 703, 704 and 705, respectively. Right side of Langmuir limit: the line 486 there is the B vs. Jc curves with small cathode current density. That is, when the cathode radius is varied 20, 100, 200, 300, 400 and 500 μm, the brightness is larger than Langmuir limit at the cathode current density of 30, 13, 7.7, 6, 5.1 and 4.6 A/cm². It is very useful that by this small current density the brightness larger than Langmuir limit is obtained.

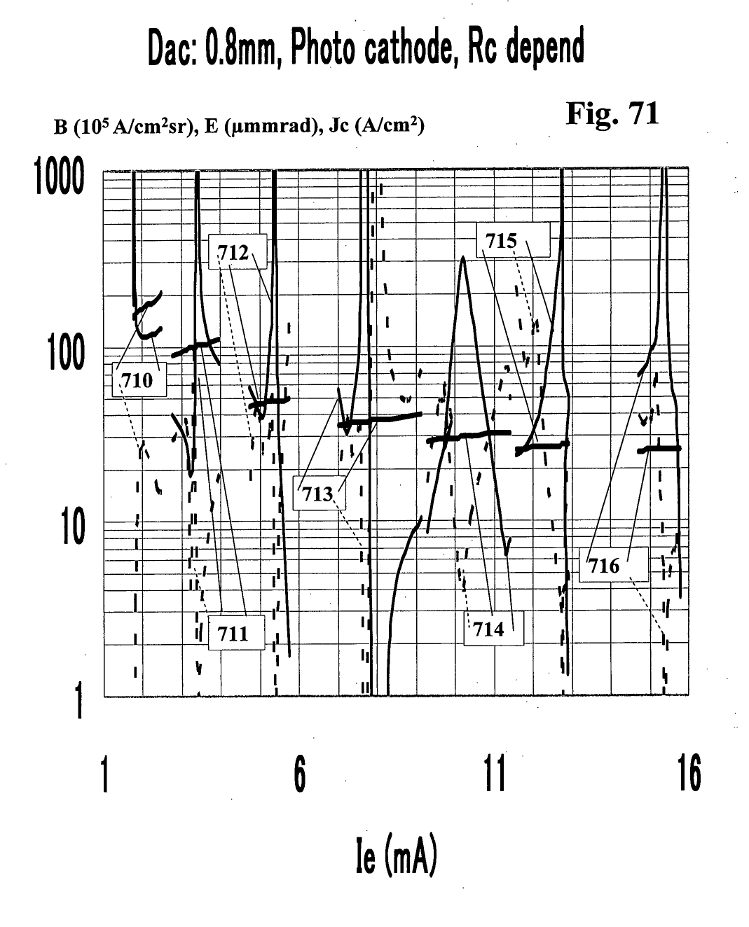

FIG. 71 is the simulated result of the electron gun with the photo cathode, wherein the cathode work function is −0.01 eV, the cathode temperature is 293 K, the Dac is 0.8 mm, the θw is 90.5 degree, the cathode radius is varied as 20, 40, 120, 200, 300, 400 and 500 μm. The results are shown as the curves 710, 711, 712, 713, 714, 715, and 716, respectively. For each cathode radius the emission current which gives the maximum brightness is 1.78, 3.42, 5.38, 7.69, 10.2, 12.6 and 15.4 mA. These values are used later (FIG. 85).

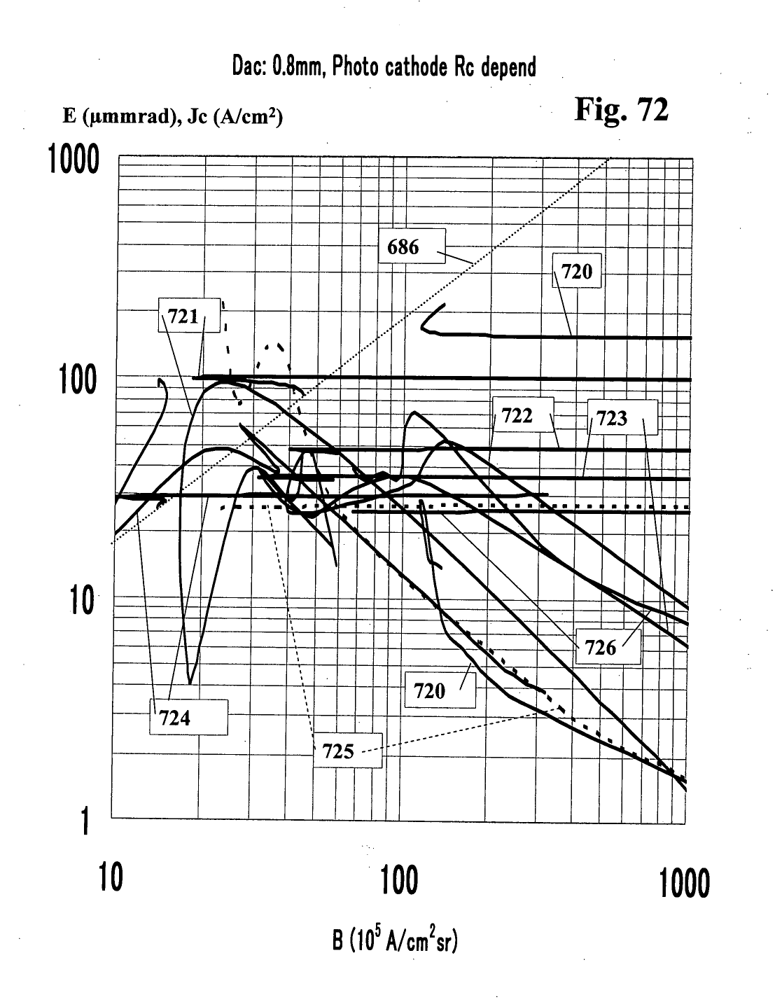

FIG. 72 is the brightness vs. Emittance curves (roughly decreasing function) and the brightness vs. cathode current density curves (nearly horizontal lines) for the simulated results of FIG. 71, wherein the abscissa is the brightness (10⁵ A/cm²sr) and the ordinate is the Emittance (μmmrad), or the cathode current density (A/cm²). The results for the cathode radii of 20, 40, 120, 200, 300, 400 and 500 μm are shown as the curves 720, 721, 722, 723, 724, 725 and 726, respectively. On the right side of the line 686: Langmuir limit there are the B vs. Jc curves. That is, when the Rc is varied as 20, 40, 120, 200, 300, 400 and 500 μm, the brightness exceed Langmuir limit at the cathode current density of 160, 100, 49, 38, 30, 27 and 26 A/cm², respectively. The characteristics for the cathode to the anode distance: Dac of 0.8 mm is that at the brightness condition which exceeds Langmuir limit the Emittance is very high. For example, when the brightness is 1×10⁷ A/cm²sr FIGS. 70 and 72 are compared, in the former case: Dac is 2.5 mm; the Emittance is the range from 1.4 to 9 μmmrad; In the latter case: Dac is 0.8 mm; the Emittance is from 12 to 65 μmmrad. It is very useful that the high Emittance at the high brightness is obtained.

Here, we study regarding photo cathode. Notations are defined as follows, the cathode work function is eφ, excitation laser wavelength is λ, its photon energy is hν (eV), and the cathode temperature is T(K). The energy width δE is defined that,

δE²=(kT)²+(hν−eφ)², (109)

where the electron-electron interaction effect is neglected. Therefore, we want to obtain small energy width δE, it is better that the laser photon energy is a little larger than the cathode work function, and the cathode is operated at the low temperature.

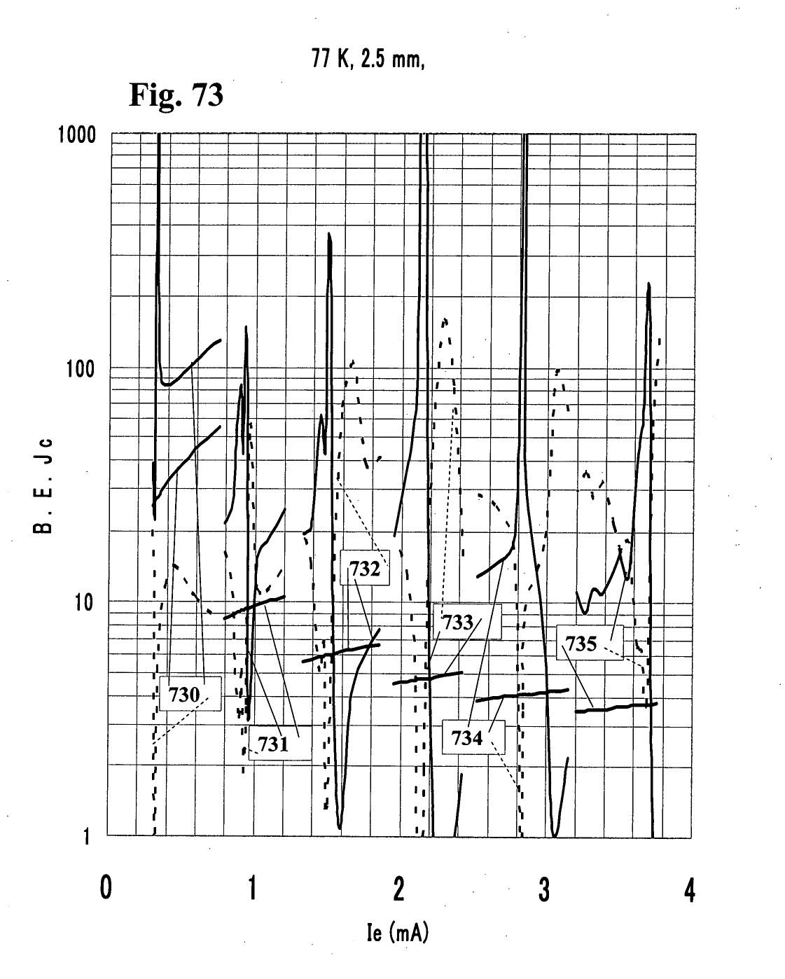

The low cathode temperature case is shown as follows. FIG. 73 is the simulated result of the electron gun, wherein the cathode radius Rc is parameter, the distance between the cathode and the anode: Dac is 2.5 mm, the cathode work function is −0.01 eV, the cathode temperature is 77 K, the θw is 90.5 degree. The ordinate is the brightness: B (10⁵ A/cm²sr), the Emittance: E (μmmrad), and the cathode current density: Jc (A/cm²). The results for the Rc of 20, 100, 200, 300, 400 and 500 μm are shown as the curves 730, 731, 732, 733, 734 and 735, respectively, wherein the abscissa is the brightness (10⁵ A/cm²sr) and the ordinate is the Emittance (μmmrad), or the cathode current density (A/cm²). For each cathode radius, the emission current which gives the maximum brightness is 0.321, 0.923, 1.485, 2.13, 2.83 and 3.69 mA, respectively. These values are used later (FIG. 85).

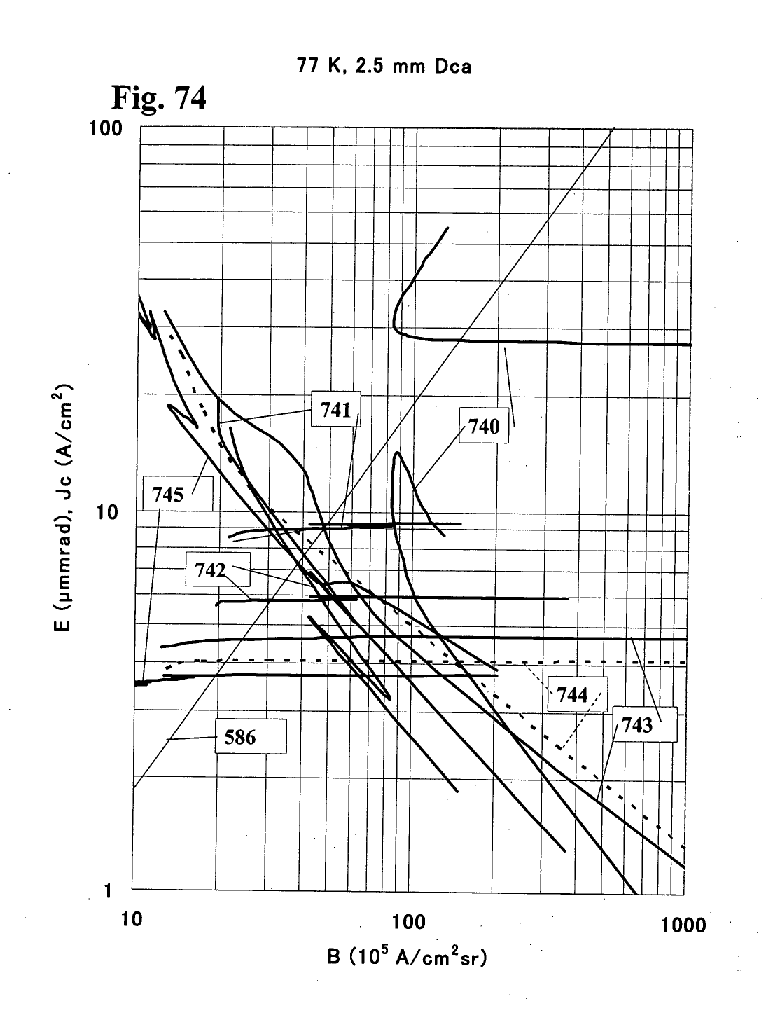

FIG. 74 is the brightness vs. Emittance curves (decreasing function of B) and the brightness vs. cathode current density curves (nearly horizontal line) for the simulated results of FIG. 73. For the cathode radius of 20, 100, 200, 300, 400 and 500 μm the results are shown as the curves 740, 741, 742, 743, 744 and 745, respectively. Right side of Langmuir limit: line 586 there are the B vs. Jc curves. That is, when the Rc are varied as 20, 100, 200, 300, 400 and 500 μm, the brightness exceed Langmuir limit at the cathode current density of 28, 9.1, 5.9, 4.6, 4.1 and 3.7 A/cm², respectively. This cathode to anode distance: Dac of 2.5 mm have a character that the emission current and the cathode current density which give the high brightness larger than Langmuir limit are very small. It is very useful that the very high brightness is obtained by such a small emission current and such a small cathode current density.

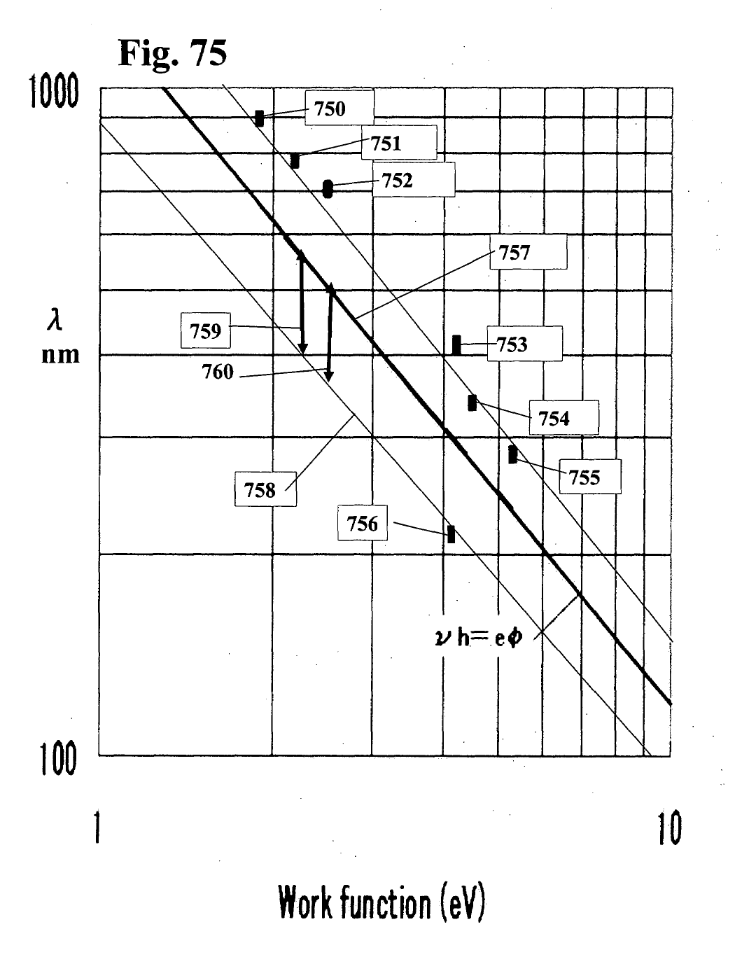

FIG. 75 shows the relationship between the cathode work function and the photo electron limiting wavelength. Points 750, 751, 752, 753, 754, 755 and 756 correspond to Cs on the Pt, K on the Pt, Ba, Al, Ag, Pt and W, respectively (Denshi-Tuushin Kougaku Handbook, Maruzen, 1957 p 470 in Japanese). The solid line 757 is a critical wavelength defined by hν=eφ. As the metal material except the W the critical wavelength shifts to the longer wavelength side than the line 757. For the W the critical wavelength shifts to the shorter wavelength side. It is supposed that the work function of the surface is changed by contamination, or the thermal velocity depend on the cathode temperature enable to emit the photoelectron by a little smaller photon energy than the critical wavelength. As those the work function change and the cathode temperature effect is take account, it is desirable to excite the cathode by the laser with wavelength range between line 757 and 758. For example, for the CeBix cathode: 759, the wavelength range between 470 and 700 nm, in this range there are Ar laser with a wavelength of 532 nm. For the LaB6 cathode: the wavelength range between 410 and 610 nm, in this range there are Ar laser with a wavelength of 527 nm. Both lasers are the Ar green laser excited by a semiconductor laser. As a summary, the cathode exciting laser wavelength range is λ±20%, where λ satisfy hλ/C=eφ, h is the plank constant, C is the velocity of light, and eφ is the cathode work function. When the cathode is cooled, the cathode exciting laser wavelength range is from 0.8λ to λ, where λ satisfy hλ/C=eφ.

As a next stage, to study why the high brightness is obtained, the electron trajectories for three conditions are shown, they are; normal brightness, high brightness, and very high brightness, and where the cathode work function is −0.01 eV, cathode temperature is 293 K, Dac is 0.8 mm, θw is 90.5 degree, and the cathode radius is 0.5 mm. The simulation is done for the electron gun model with a small aperture on the back surface of the anode, this is because the trajectories only around the optical axis are required. The small aperture is formed by changing the bold number 22 to 55 in the table V, and the lens is not excited. Regarding this, to reduce the space charge effect, it is useful that useless peripheral beam is removed as soon as possible by designing a small aperture at the back surface of the anode.

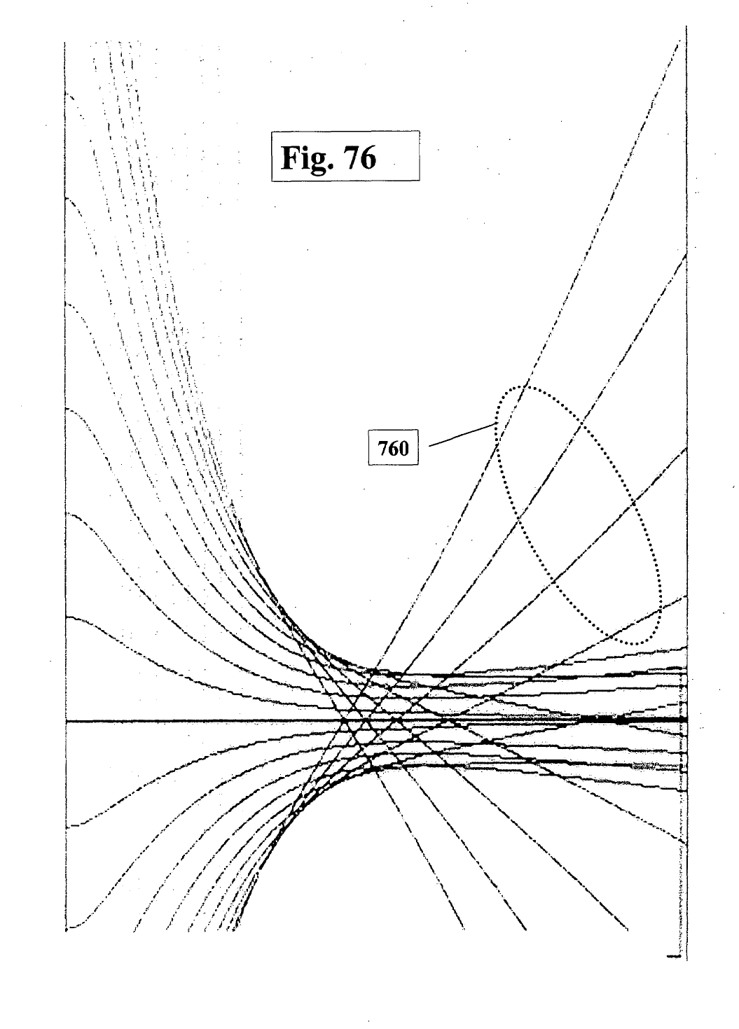

FIG. 76 is the simulated result of the beam trajectories for the normal brightness. Some trajectories go out of control at 760.

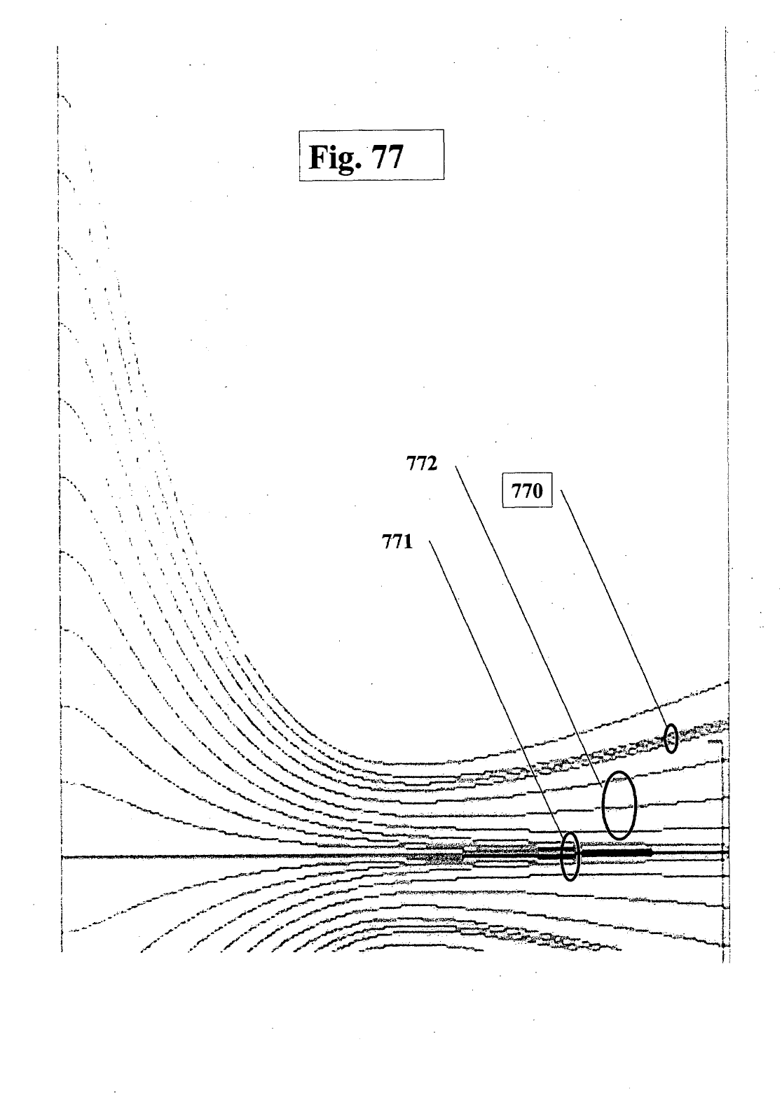

FIG. 77 is the simulated result of the beam trajectories for the high brightness. It is seen that trajectory density is too dense at 770 and 771, and that is too sparse at 772.

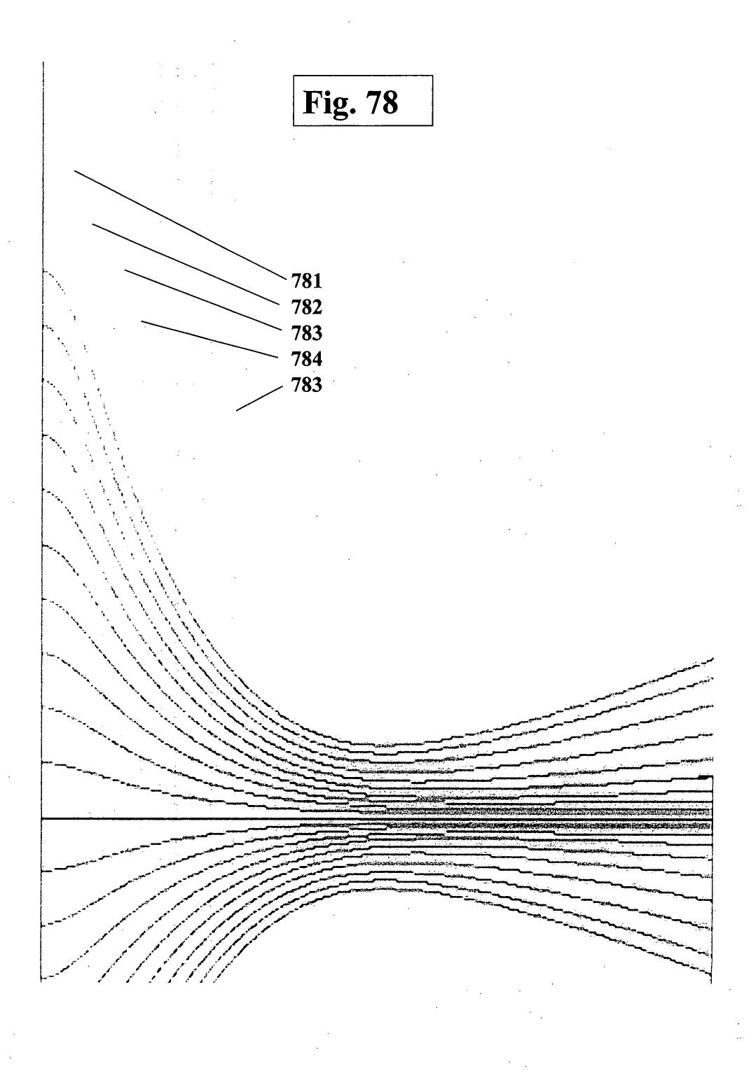

FIG. 78 is the simulated result of the beam trajectories for the very high brightness. There is no irregularity and the trajectory is very approximate to the laminar flow. For the approximate laminar flow, each trajectory does not cross each other, few electron-electron interaction occurs, and then the energy width increase is small. Moreover, the minimum beam diameter is formed at the position of 1.5 mm from the cathode and the Z coordinate is larger than 0.8 mm which is the anode position, where the beam is accelerated sufficiently, and then the interaction is still small. Naturally, as this type of the approximate laminar flow deviate from the optical model, there is no inconsistency even if the brightness larger than Langmuir limit is obtained. After all, when the wehnelt voltage is controlled so that the cathode current density is small at the cathode and the beam diameter decrease monotonically until pass through the anode, the high brightness and the beam with a small energy width is obtained, and then the axial chromatic aberration is small and then large beam current is focused to a fine beam.

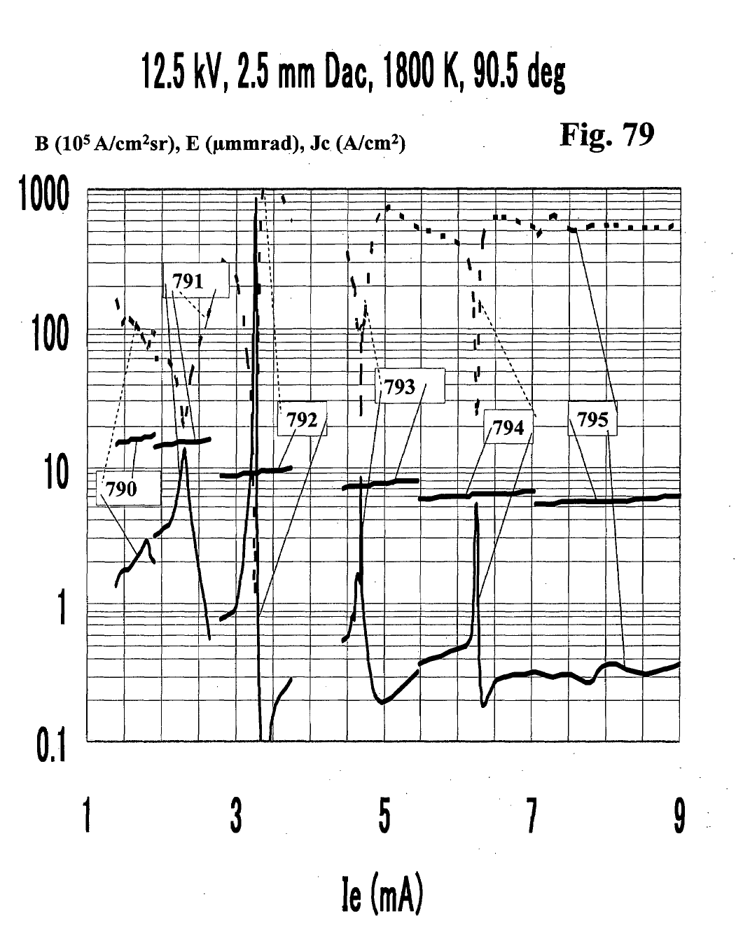

FIG. 79 is the simulated result of the electron gun, wherein the cathode temperature is 1800 K, the lens excitation is 12.5 kV, the Dac is 2.5 mm, the cathode work function is 2.35 eV, the wehnelt angle: θw is 90.5 degree, and the cathode radius is varied as 80, 100, 200, 300, 400 and 500 μm. The results are shown as the curves 790, 791, 792, 793, 794, and 795, respectively. The short solid curves are the cathode current density (A/cm²), the solid curves are the brightness (10⁵ A/cm²sr), and the dotted curves are the Emittance. The abscissa is the emission current (mA). The emission current, which the high brightness is obtained, are 1.81, 2.31, 3.26, 4.69, 6.25 mA, respectively. For the electron gun with the cathode radius of 500 μm the high brightness is not obtained. These emission current values are used later (FIG. 85).

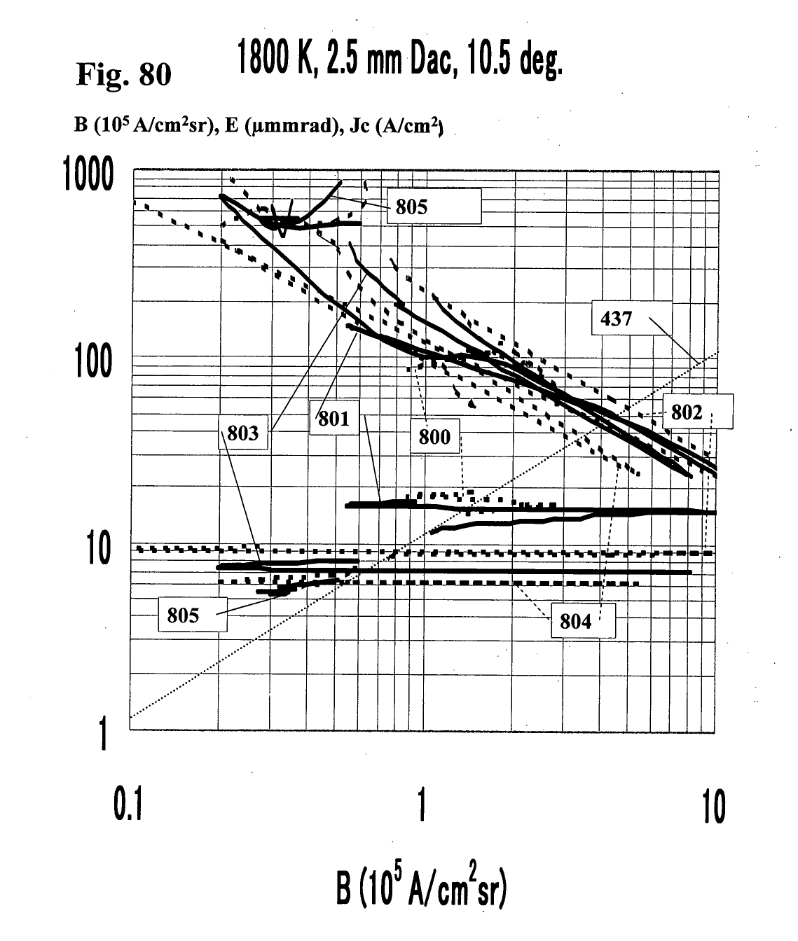

FIG. 80 is the brightness vs. Emittance curves (Decreasing function of B) and the brightness vs. cathode current density curves for the simulated results of FIG. 79, wherein the abscissa is the brightness (10⁵ A/cm²sr) and the ordinate is the Emittance (μmmrad), or the cathode current density (A/cm²). The curves 800, 801, 802, 803 804 and 805 correspond to the electron gun with the cathode radius of 80, 100, 200, 300, 400 and 500 μm, respectively. The brightness vs. cathode current density curves, which are nearly horizontal, are right side of the line 437, and then the brightness larger than Langmuir limit are obtained. The curve 805 which correspond to the cathode radius of 500 μm is not right side of the line 437, and then the brightness is smaller than the limit.

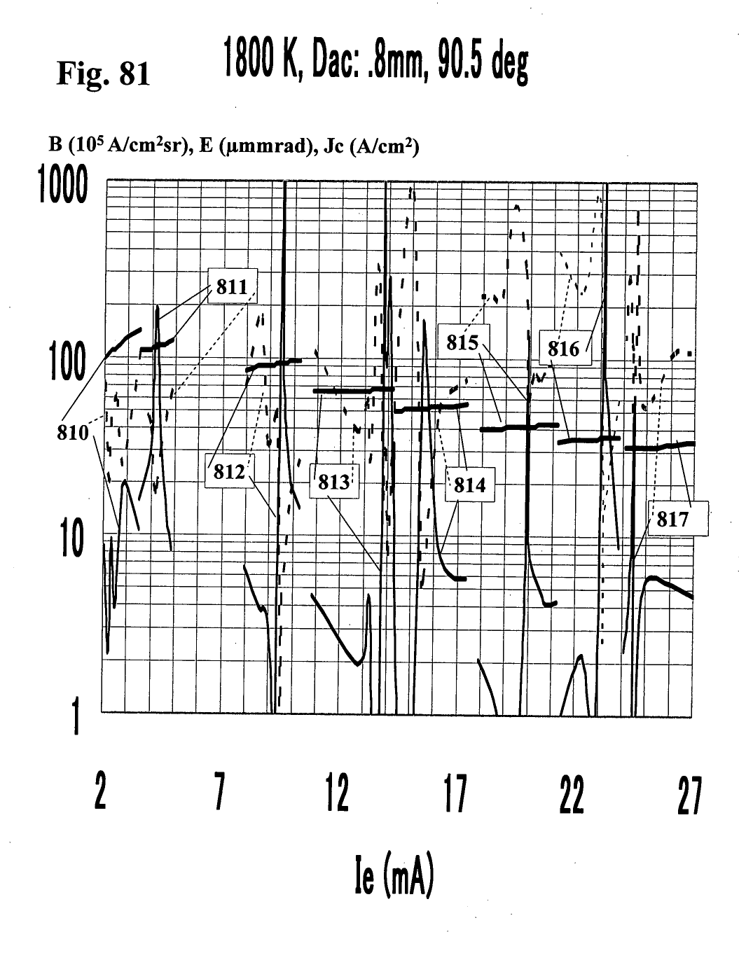

FIG. 81 is the simulated result of the gun characteristics as a function of the emission current, wherein the cathode is the thermal cathode, the distance between the cathode and the anode: Dac is 0.8 mm, the cathode work function is 2.35 eV, the wehnelt angle θw is 90.5 degree, and the cathode radius Rc is varied as 20, 40, 80, 100, 200, 300, 400 and 500 μm. The results are shown as the curves 810, 811, 812, 813, 814, 815 816 and 817, respectively. The short curves are the cathode current densities (A/cm²), the solid curves are the brightness (10⁵ A/cm²sr), the dotted curves are the Emittance (μmmrad) and the abscissa is the emission current (mA). The emission currents which the brightness is the maximum are used later (FIG. 85).

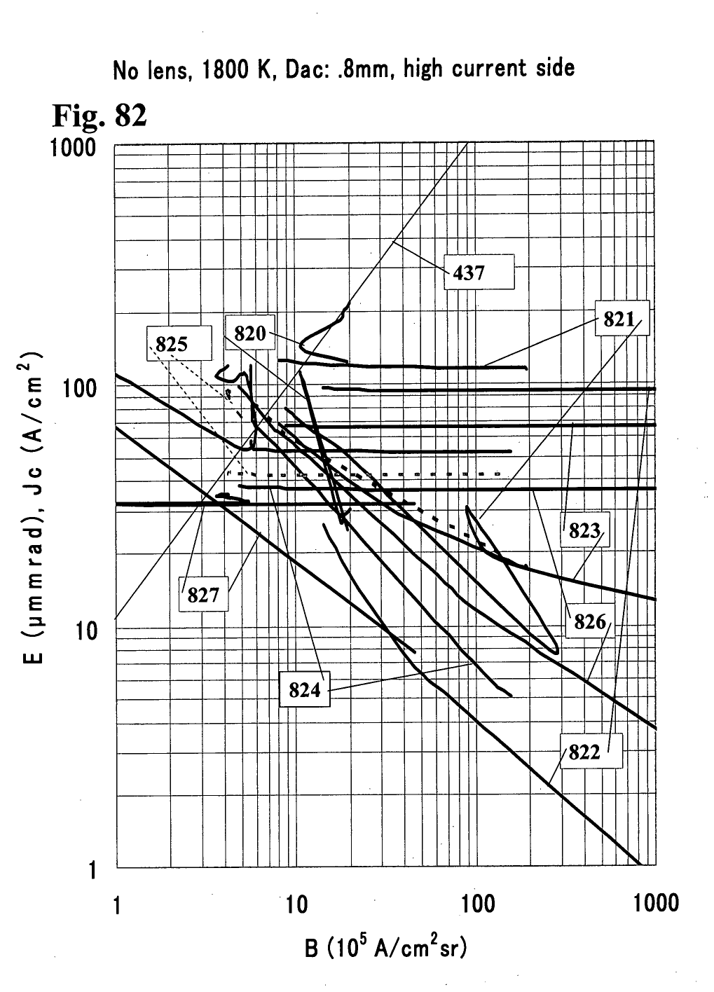

FIG. 82 is the brightness vs. Emittance curves (decreasing function of B) and the brightness vs. cathode current density curves for the simulated results of FIG. 81, wherein the abscissa is the brightness (10⁵ A/cm²sr) and the ordinate is the Emittance (μmmrad), or the cathode current density (A/cm²). The curves 820, 821, 822, 823, 824, 825, 826 and 827 correspond to the electron gun with the cathode radius of 20, 40, 80, 100, 200, 300, 400 and 500 μm, respectively. The brightness vs. cathode current density curves, which are nearly horizontal, are right side of the line 437, the brightness larger than Langmuir limit is obtained.

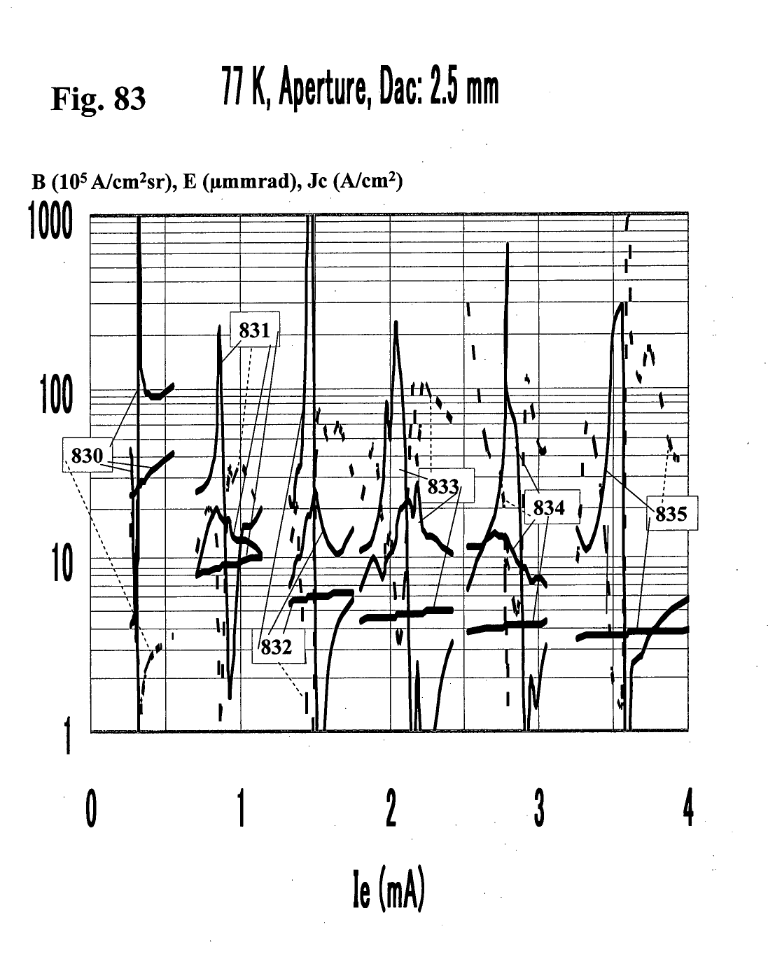

FIG. 83 is the simulated result for the electron gun, wherein the cathode radius Rc is the parameter, the distance between the cathode and the anode: Dac is 2.5 mm, the cathode work function is −0.01 eV, the cathode temperature is 77 K, the θw is 90.5 degree. These conditions are the same as in FIG. 73, however, to reduce the space charge effect the small aperture (43.1 μm radius) is deposited at the back surface of the anode. The results for the Rc of 20, 100, 200, 300, 400 and 500 μm are shown as the curves 830, 831, 832, 833, 834 and 835, respectively. For each cathode radius, the emission current which give the maximum brightness is 0.323, 0.868, 1.47, 2.038, 2.791 and 3.561 mA, respectively. These values are nearly equal to that in FIG. 73. In this figure the cross over Z positions: Zco are shown as nearly hill shape solid curves. Though for the case of 20 μm cathode radius case the Zco show a negative value and for the 500 μm Rc case Zco is not shown, for the Rc from 100 to 400 μm case the Zco are around 10 mm. The aperture position: Zap is back surface of the anode and 3.6 mm, and then the beam current is reduced less than 1/10 before the minimum beam radius position. For this case the brightness larger than Langmuir limit is obtained.

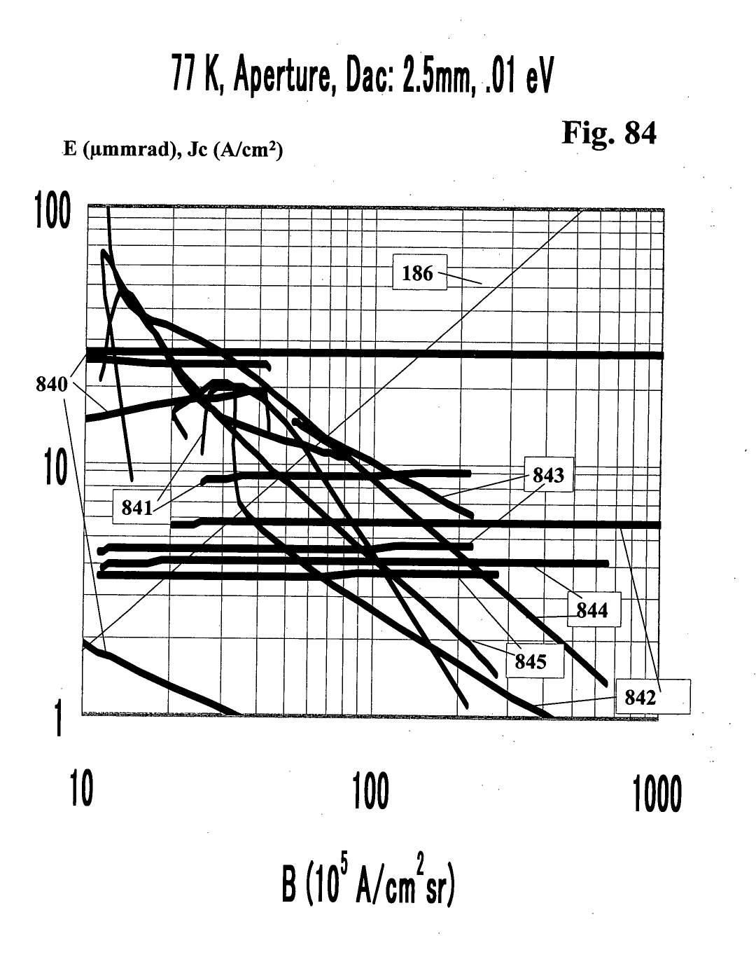

FIG. 84 is the brightness vs. Emittance curves (decreasing function of B) and the brightness vs. cathode current density curves for the simulated results of FIG. 83, wherein the abscissa is the brightness (10⁵ A/cm²sr) and the ordinate is the Emittance (μmmrad), or the cathode current density (A/cm²). The curves 840, 841, 842, 843 844 and 845 correspond to the electron gun with the cathode radii of 20, 100, 200, 300, 400 and 500 μm, respectively. The brightness vs. cathode current density curves are right side of the line 186, the brightness larger than Langmuir limit are obtained, and the cathode current density, where the brightness is larger than Langmuir limit are 28, 9.1, 5.9, 4.6, 4.1 and 37 A/cm², respectively. In FIGS. 74 and 84 the Emittance are compared, the later case in spite that the beam current is 1/10 of the former case, the Emittance do not decrease but increase a little from the former case. When the beam current is decreased to 1/10, the space charge effect is decreased to 1/10, and then it is very useful that the aperture is deposited before the minimum beam radius position and most of the beam current is trapped. When the hole radius of the anode is smaller than the beam size at that position, the same effect is obtained.

The emission currents which the brightness is larger than Langmuir limit as a function of the cathode radius as explained are summarized in FIG. 85, as follows.

The line 850: Results in FIG. 81, equation of the line:

Ie=10.5+0.0296Rc, where 120<Rc≦500

The line 851: Results in FIG. 41, equation of the line: Ie=0.116 Rc, where Rc≦120 μm.
The line 852: Results in FIG. 42, equation of the line: Ie=0.0645Rc.
The line 853: Results in FIG. 71, equation of the line: Ie=2.6+0.0254Rc.
The line 854: Results in FIG. 53, equation of the line: Ie=0.9+0.027Rc.
The line 855: Results in FIG. 67, equation of the line: Ie=1.5+0.0183Rc.
The line 856: Results in FIG. 60, equation of the line: Ie=1+0.0086Rc.
The line 857: Results in FIGS. 73 & 87, equation of the line: Ie=0.4+0.0064Rc.

From FIG. 85 and above equations when Rc is equal to or smaller than 120 μm, the emission current Ie condition for obtaining the brightness larger than Langmuir limit is in the range as,

0.4+0.0064Rc≦Ie≦0.116Rc.

And, when the Rc is larger than 120 μm, said condition is as follows,

0.4+0.0064Rc≦Ie≦10.5+0.0296Rc.

And, when the high Emittance is also required, the emission current is between the lines 851 and 853, where the Rc is equal to or smaller than 120 μm, and then as follows,

2.6+0.0254Rc≦Ie≦0.116Rc.

When the Rc is larger than 129 μm, said emission current range is the line 850 and 853, and as follows,

2.6+0.0254Rc≦Ie≦10.5+0.0296Rc.

When small emission current or small cathode current density is required, said emission current is between the lines 857 and 853, and then

0.4+0.0064Rc≦Ie≦2.6+0.0254Rc

And, the cathode radius condition, which the brightness larger than Langmuir limit is obtained by relatively small emission current, is as follows: 20≦Rc(μm)≦200.

And, the cathode radius condition, which the brightness larger than Langmuir limit is obtained by relatively small cathode current density, is as follows: 200<Rc(μm)≦500.

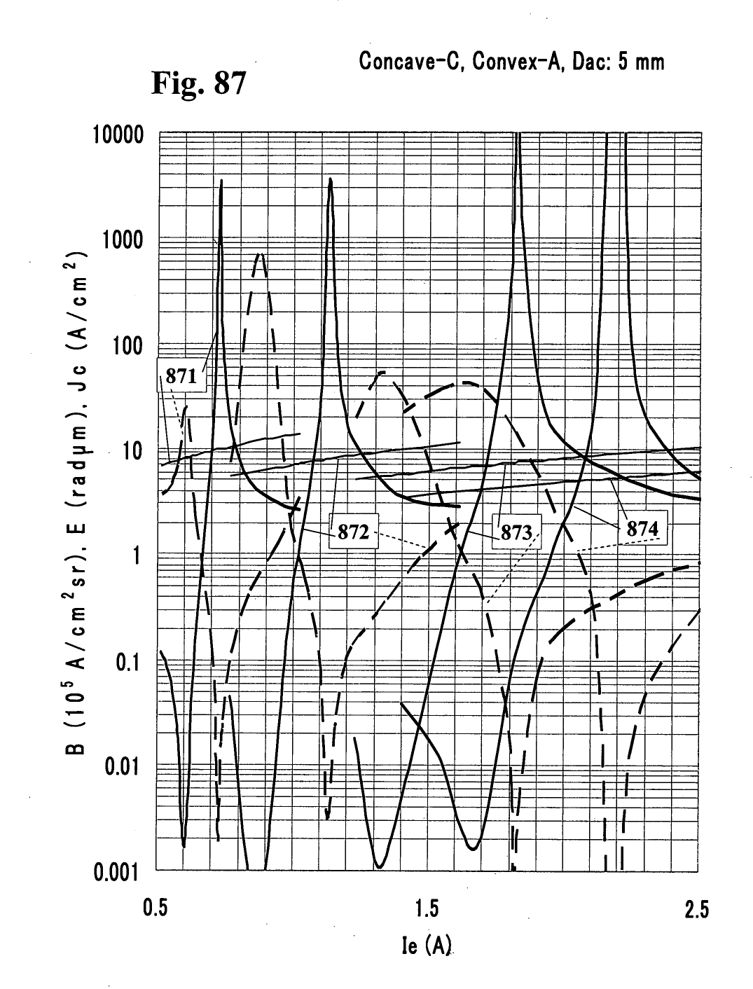

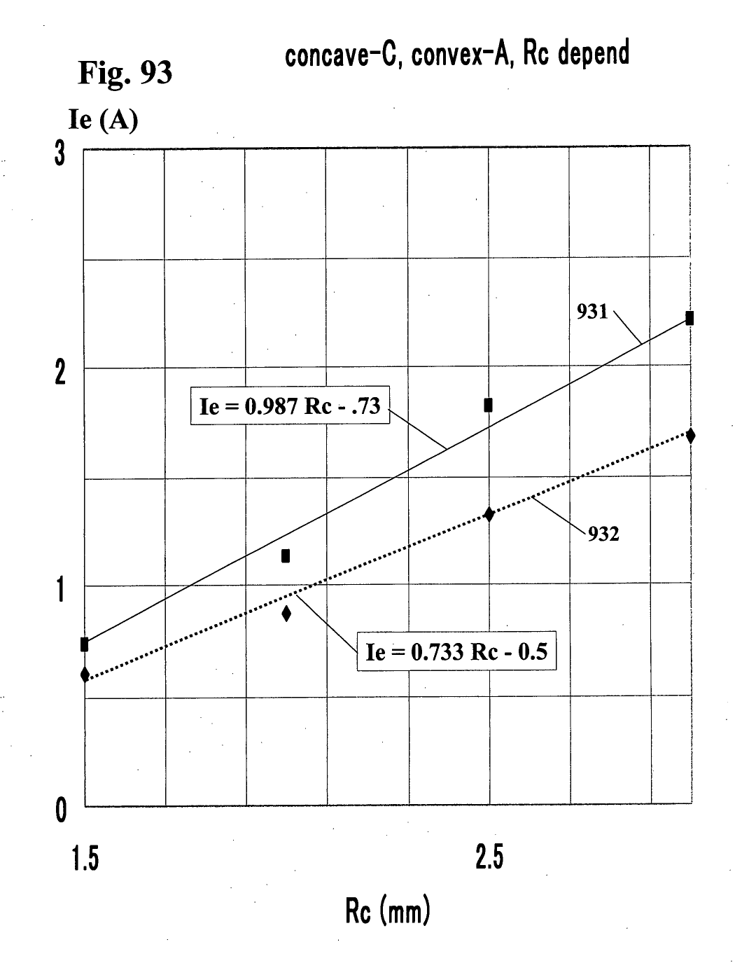

FIG. 87 is the simulated result for the model in FIG. 11, wherein the distance between the cathode and the anode is fixed to 5 mm, and wherein the cathode radius is varied from 1.5 mm to 3 mm with an increment of 0.5 mm. The curves 871, 872, 873 and 874 correspond to the cathode radii of 1.5, 2, 2.5 and 3 mm, respectively. All the electron guns with these cathode radii, when the emission current increased from zero, the very high Emittance is obtained firstly and secondly very high brightness condition is obtained. The electron gun with the larger cathode radius tends to have high brightness and high Emittance condition with the smaller cathode current density. The emission current values which give the maximum brightness and the maximum Emittance for each cathode radius are read from FIG. 87 and are used in FIG. 93.

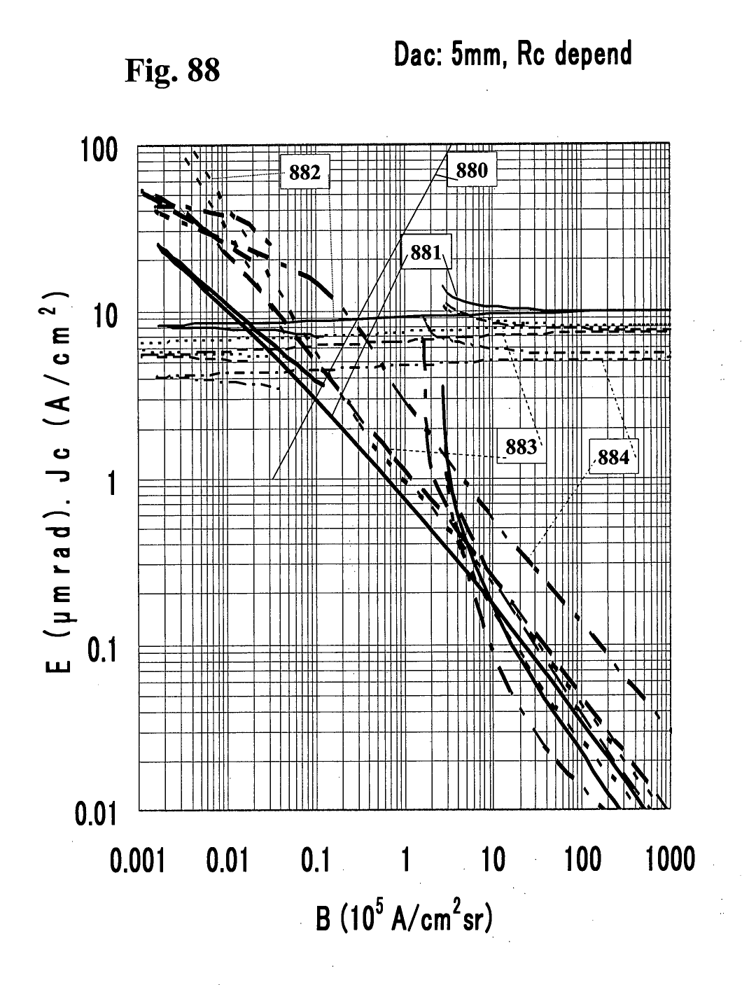

FIG. 88 is the brightness vs. Emittance curves (decreasing function) and the brightness vs. cathode current density curves for the simulated results of FIG. 87, wherein the brightness is 10⁵ A/cm²sr and the Emittance is μmrad, and the cathode current density is A/cm². The results for the cathode radii of 1.5, 2, 2.5 and 3 mm are shown as the curves 881, 882, 883 and 884, respectively. Langmuir limit for the cathode temperatures of 1800 K are calculated from Eq. (-1), and shown as the line 880.

In the B vs. Jc curves, some parts of the curves 881, 882, 883 and 884 are the right side of the lines 880, and then the electron gun with these cathode radii have the brightness larger than Langmuir limit. For this Dac condition the Emittance is too small, for example when the brightness is 10⁶ A/cm²sr, the Emittance is smaller than 0.59 μmrad

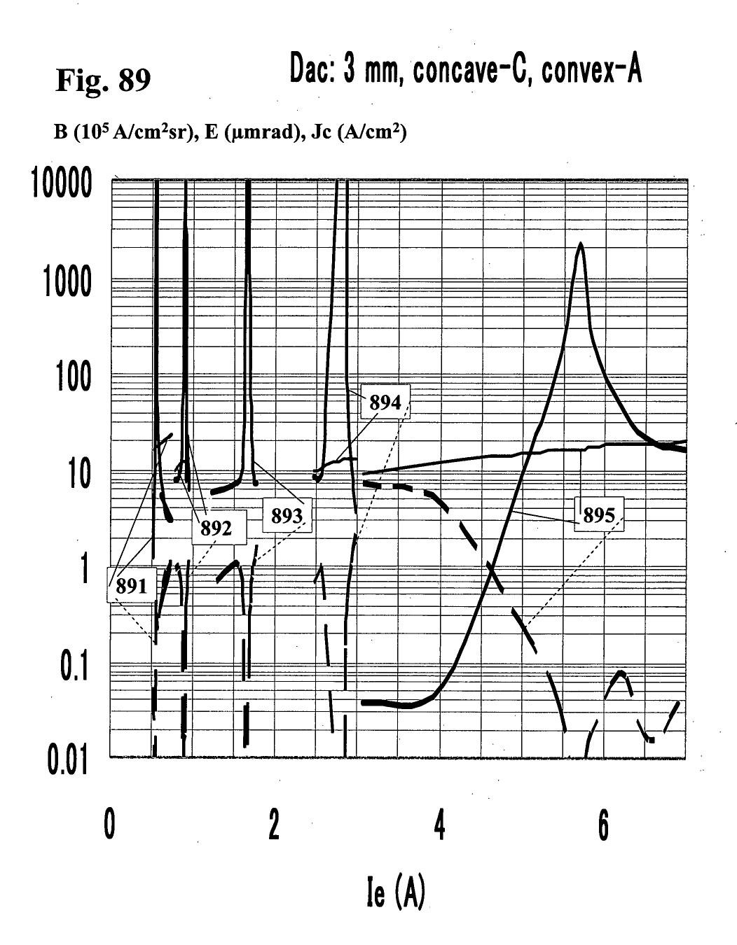

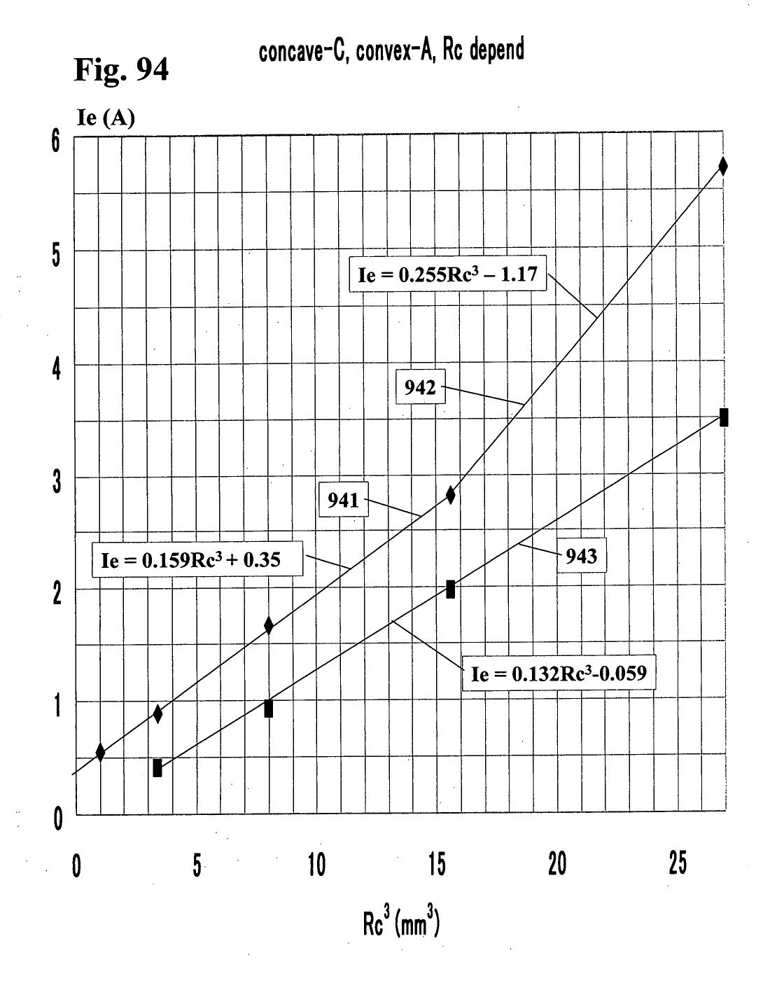

FIG. 89 is the simulated result for the model in FIG. 11, wherein the distance between the cathode and the anode is fixed to 3 mm, and wherein the cathode radius is varied from 1 mm to 3 mm with the increment of 5 mm. The curves 891, 892, 893, 894 and 895 correspond to the cathode radii of 1, 1.5, 2, 2.5 and 3 mm, respectively. All the electron guns with these cathode radii, high brightness conditions are obtained. The emission current values which give the maximum brightness for each cathode radius are read from FIG. 89 and are used in FIG. 94. For this Dac condition, the emission current which gives the maximum brightness is too large.

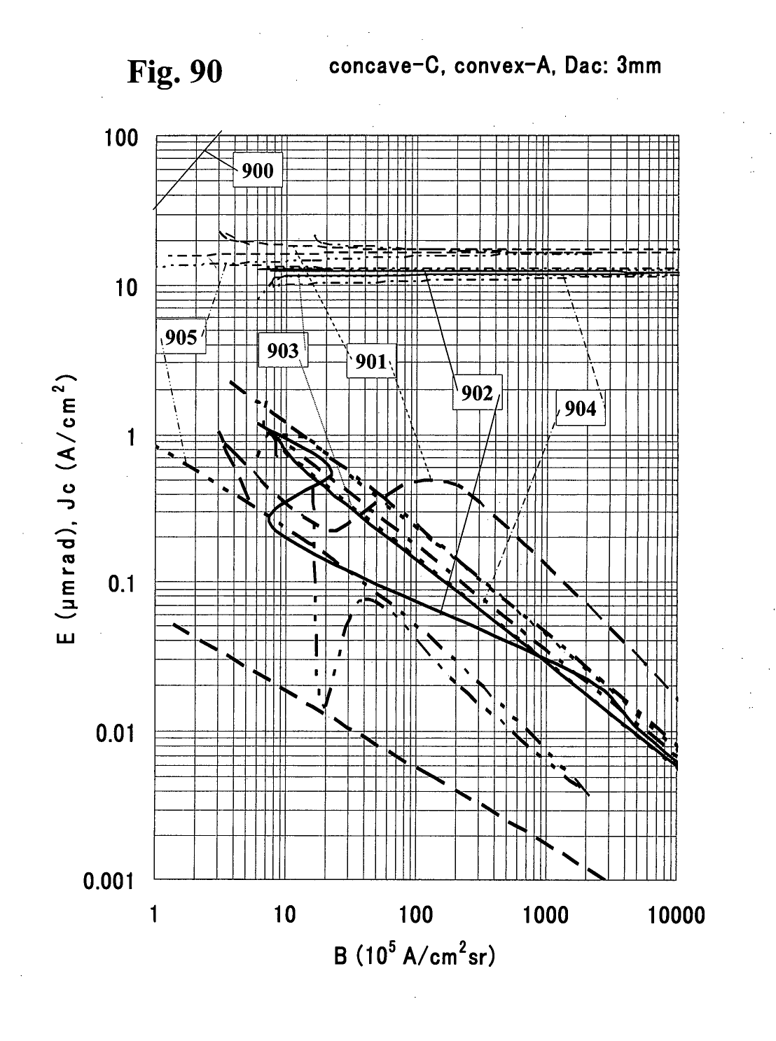

FIG. 90 is the brightness vs. Emittance curves (decreasing function) and the brightness vs. cathode current density curves for the simulated results of FIG. 89, wherein the brightness is 10⁵ A/cm²sr and the Emittance is μmrad, the cathode current density is A/cm². The results for the cathode radii of 1, 1.5, 2, 2.5 and 3 mm are shown as the curves 901, 902, 903, 904 and 905, respectively. Langmuir limit for the cathode temperatures of 1800 K are calculated from Eq. (-1), and shown as the line 900.

In the B vs. Jc curves, the curves 901, 902, 903, 904 and 905 are the right side of the lines 900, and then the electron gun with these cathode radii have the brightness larger than Langmuir limit.

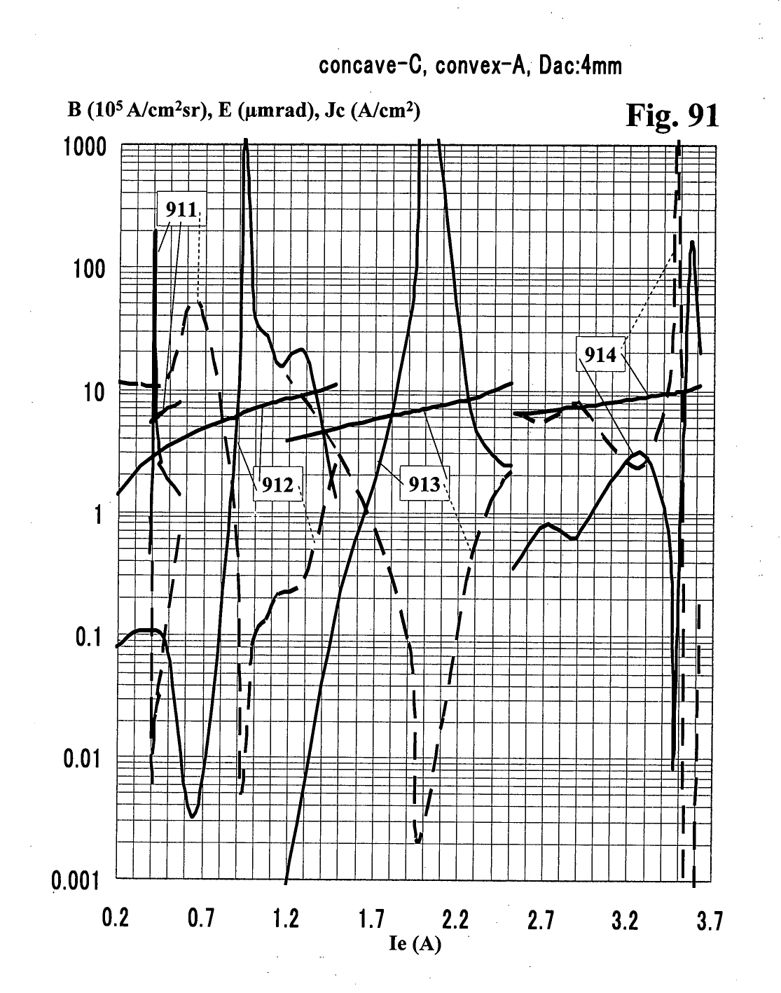

FIG. 91 is the simulated result for the model in FIG. 11, wherein the distance between the cathode and the anode is fixed to 4 mm, and wherein the cathode radius is varied from 1.5 mm to 3 mm with an increment of 0.5 mm. The curves 911, 912, 913, and 914 correspond to the cathode radii of 1.5, 2, 2.5 and 3 mm, respectively. All the electron guns with these cathode radii, the high brightness conditions are obtained. The emission current values which give the maximum brightness for each cathode radius are read from FIG. 91 and are used in FIG. 94. For this Dac condition the problem in the Dac of 3 mm, that the emission current which give the maximum brightness is too large, is solved.

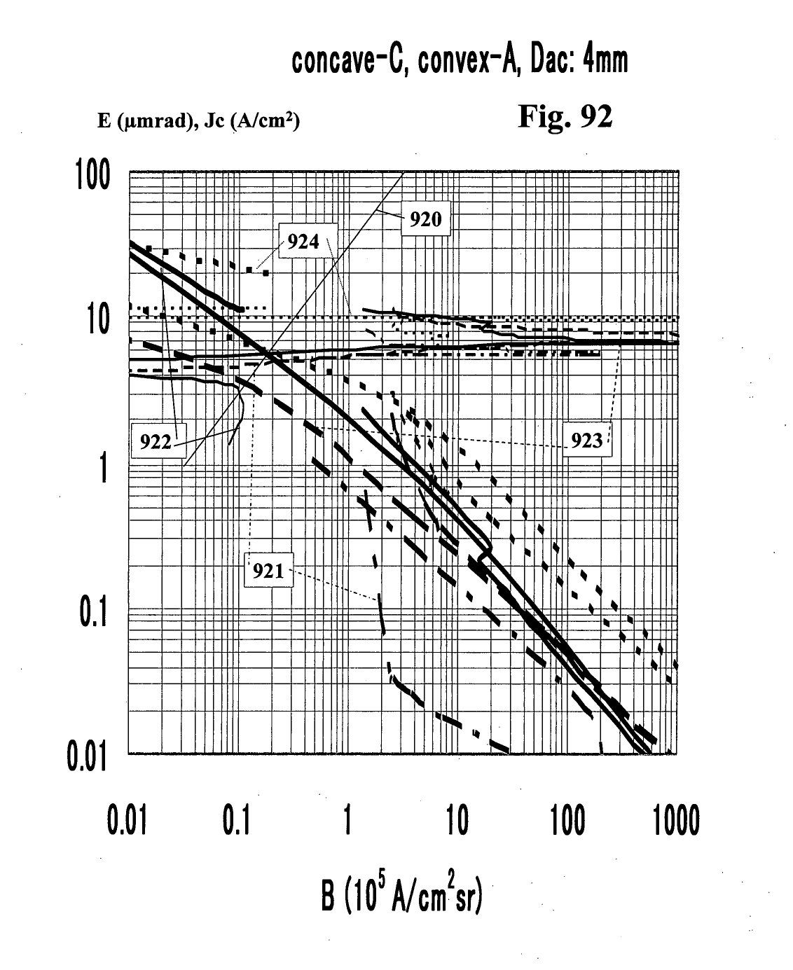

FIG. 92 is the brightness vs. Emittance curves (decreasing function) and the brightness vs. cathode current density curves for the simulated results of FIG. 91, wherein the brightness is 10⁵ A/cm²sr and the Emittance is μmrad, the cathode current density is A/cm². The results for the cathode radii of 1.5, 2, 2.5 and 3 mm are shown as the curves 921, 922, 923 and 924, respectively. Langmuir limit for the cathode temperatures of 1800 K and 3 keV of beam energy are calculated from Eq. (-1), and shown as the line 920.

In the B vs. Jc curves, some parts of the curves 921, 922, 923 and 924 are the right side of the line 920, and then the electron gun with these cathode radii have the brightness larger than Langmuir limit. When the brightness is 10⁶ A/cm²sr, the Emittance is 1.4 μmrad, and then the problem, that the Emittance is too small when the brightness is large, is solved.

The emission currents, which the brightness is larger than Langmuir limit and the Emittance is very large, as a function of the cathode radius as explained are summarized in FIG. 93, for the Dac of 5 mm as follows.

The line 931: Results in FIG. 87, the equation of the line:

Ie=0.987Rc−0.73, where 1.5≦Rc≦3 (mm). (109)

The line 932: Results in FIG. 47, the equation of the line: Ie=0.733Rc−0.5, high Emittance condition.

The emission currents, which the brightness is larger than Langmuir limit, as a function of the cathode radius as explained are summarized in FIG. 94, for the Dac of 3 and 4 mm as follows.

The line 941: Results in FIG. 90, equation of the line: Ie=0.159Rc³+0.35.

The line 943: Results in FIG. 92, equation of the line: Ie=0.132Rc³−0.059.

From FIGS. 93 and 94 and above equations when Rc is equal or smaller than 2.5 mm, the condition for obtaining the brightness larger than Langmuir limit and for obtaining very high Emittance is in the range as,

0.733Rc−0.5≦Ie≦0.159Rc³+0.35. (110)

And, when the Rc is larger than 2.5 mm, said condition is as follows,

0.733Rc−0.5≦Ie≦0.255Rc³−1.17. (111)

When the high Emittance is also required, the left side of above inequalities are changed to the equation of the line 943, and then

0.132R³−0.059Ie≦0.159Rc³+0.35, where Rc≦2.5 mm, or

0.132R³−0.059Ie≦0.255Rc³−1.17, where Rc>2.5 mm.

When the emission current is required to be small value, the right side of the Inequality (110) is changed to the equation line of 943, and then

0.733Rc−0.5≦Ie≦0.132R³−0.059.

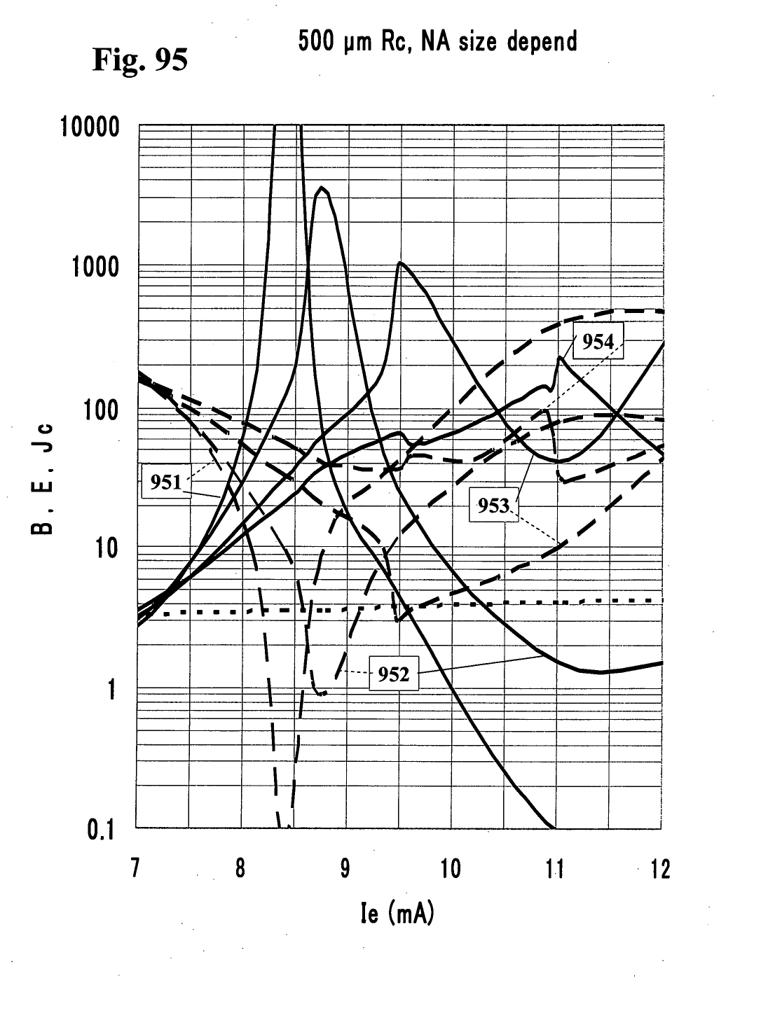

The electron gun in this invention tend to large emission current, and when this large emission current is flowed to the crossover, the energy width become large due to the space charge effect. For this countermeasure a small aperture is designed at the back surface of the anode or the beam drawing electrode, and tries to trap useless large beam current before the crossover. FIG. 95 is the simulated result for the electron gun with the small aperture at the back surface of the anode. The solid curves are the brightness (10⁵ A/cm²sr), the broken curves are the Emittance (μmmrad), and the dotted curve is the cathode current density (A/cm²). The curves 951, 952, 953 and 954 correspond to the aperture size of 73.8, 61.5, 49.5, and 37 μm, respectively. The beam radius at the aperture position is roughly 200 μm, and then transmission efficiencies are 13.6, 9.47, 6.13, and 3.42%, respectively. In spite of most of the emission current is trapped by the aperture before the crossover, the brightness larger than 2×10⁷ A/cm²sr is obtained as seen in FIG. 95. When the transmission efficiency smaller than ⅓ is realized, the space charge effect reduced to ⅓, and then the small aperture is very useful.

When the anode hole size is smaller than the beam size at the anode hole position, the same effect is expected. In this case the alignment between the wehnelt and the anode can be estimated by the transmission efficiency of the anode.

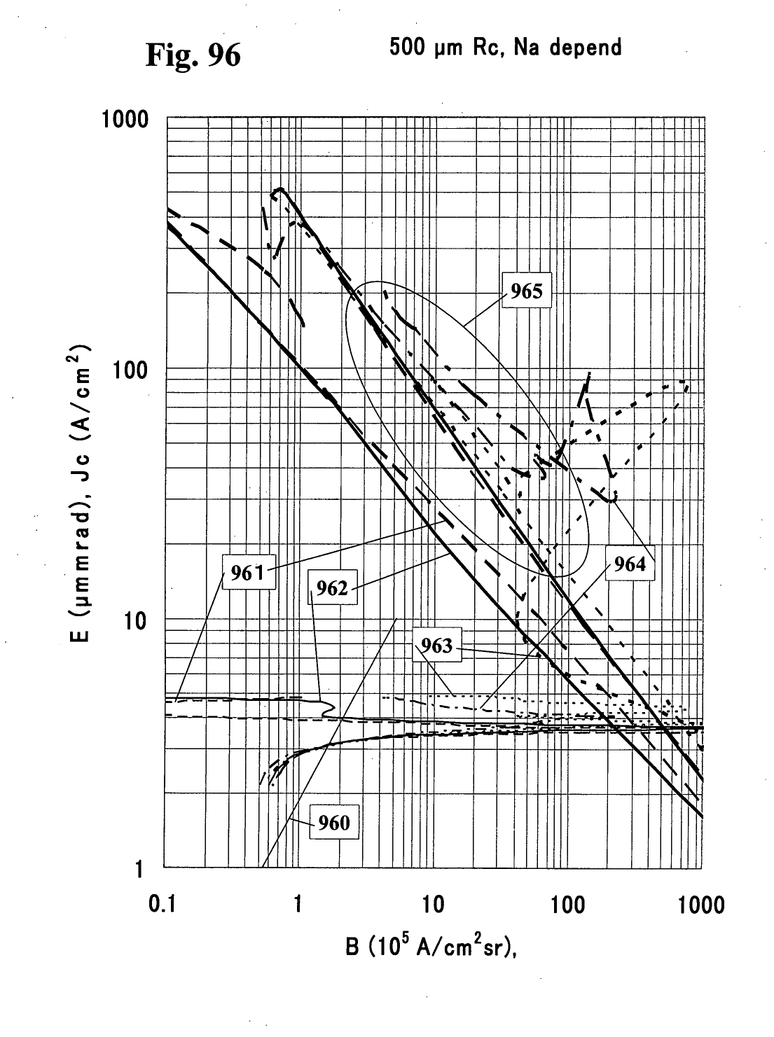

FIG. 96 is the brightness vs. Emittance curves (roughly decreasing function of B) and the brightness vs. cathode current density curves for the simulated results of FIG. 95, wherein the abscissa is the brightness and the ordinate is the Emittance, or the cathode current density. The curves 961, 962, 963, and 964 correspond to the aperture sizes of 73.8, 61.5, 49.5, and 37 μm, respectively. The line 960 is Langmuir limit. For all aperture conditions the brightness larger than Langmuir limit is obtained. In the area of 965 the smaller aperture tends to larger Emittance for the same brightness.

### EFFECT OF THIS INVENTION

As above explained the best mode of the electron beam apparatus for this invention, this invention enable to obtain the electron gun which gives the brightness larger than Langmuir limit and the electron beam with small energy width. Therefore, finely focused multiple beam with large beam current are formed around an optical axis, and the SEs from the electron beam far from the optical axis can be detected easily, the distance between the electron gun and the specimen is short, and then the space charge effect is small. And when the small aperture is deposited back surface of the anode and remove the peripheral beam, the energy width increase due to the space charge effect become small.

TABLE I
Title High Emittance Gun 3f.dat 4.5 kV

| | |
|---|---|
| Cathode | |
| Region | 22 61 |
| Temperature | 1850 |
| Work function | 2.35 |
| Richardson constant | 43 |
| Space Charge | on |
| Rays | 15 |
| Cycles | 30 |
| Time step factor | 0.33 |
| Convergence | 0.002 |
| Save Trajectories | on |
| Relativity | on |
| Rotational Symmetry | |
| Mesh | |

| | 1 | 5 | 41 | 71 | 81 | 141 | 201 |
|---|---|---|---|---|---|---|---|
| 1 | 4.5 | 4.55 | 6. | 6.3 | 6.4 | 10. | 15. |
| 20 | 0.5 | .55 | 2.0055 | 2.3 | 6.4 | 10. | 15. |
| 22 | 0.5 | .55 | 2.0011365 | 2.3 | 6.4 | 10. | 15. |
| 61 | 0.5 | .55 | 2. | 2.3 | 6.4 | 10. | 15. |
| 1 | 14.5 | 14.5 | 4. | 4. | 4. | 4. | 4. |
| 20 | .08 | .09 | .42 | .22 | .3 | .3 | .3 |
| 22 | .03 | .04 | .4 | .1 | .28 | .28 | .28 |
| 61 | 0. | 0. | 0. | 0. | 0. | 0. | 0. |
| 1 | 0. | 0. | −4.4 | 0. | 0. | 0. | 0. |
| 20 | 0. | 0. | −4.4 | 0. | 0. | 0. | 0. |
| 22 | 0. | 0. | −4.4 | 0. | 0. | 0. | 0. |
| 61 | 0. | 0. | 0. | 0. | 0. | 0. | 0. |
| 1 | 0. | 0. | 0. | 0. | 0. | 0. | 0. |
| 20 | 0. | 0. | 0. | 0. | 0. | 0. | 0. |
| 22 | 0. | 0. | −.3 | 0. | 0. | 0. | 0. |
| 61 | 0. | 0. | 0. | 0. | 0. | 0. | 0. |

| 1 | 1 | 1 | 20 | −53. |
|---|---|---|---|---|
| 41 | 71 | 1 | 22 | 7000. |
| 71 | 81 | 1 | 22 | 7000. |
| 141 | 196 | 1 | 20 | 4500. |
| 20 | | | | −53. |
| 22 | | | | 0. |
| 61 | | | | 0. |
| 41 | | | | 7000. |
| 81 | | | | 7000. |
| 141 | | | | 4500. |
| 201 | | | | 4500. |
| 1 | | | | 4500. |
| 61 | 4500. | | | |

| | |
|---|---|
| 3f.con | |
| Time step factor | 0.3 |
| Rays | 490 |

TABLE II
Title X ray Gun x8.dat

| | |
|---|---|
| Cathode | |
| Region | 2210 61 |
| Temperature | 1800 |
| Work function | 2.64 |
| Richardson constant | 70 |
| Space Charge | on |
| Rays | 15 |
| Cycles | 30 |
| Time step factor | 0.33 |
| Convergence | 0.001 |
| Save Trajectories | on |
| Relativity | on |
| Rotational Symmetry | |
| Mesh | |

| | 1 | 41 | 46 | 91 |
|---|---|---|---|---|
| 1 | 6. | 6. | 7. | 7.9 |
| 21 | 0.4174 | 4.1265 | 7. | 7.9 |
| 61 | 0. | 4. | 4.6 | 7.9 |
| 1 | 6.9 | 2. | 1.5 | 1.5 |
| 21 | 2. | .7 | .6 | .7 |
| 61 | 0. | 0. | 0. | 0. |
| 1 | 0. | −2. | 0. | 0. |
| 21 | −5. | −2. | 0. | 0. |
| 61 | 0. | 0. | 0. | 0. |
| 1 | 0. | 0. | 0. | 0. |
| 21 | 0. | 0. | 0. | 0. |
| 61 | 0. | 0. | 0. | 0. |

| 1 | 1 | 1 | 20 | −1.2 |
|---|---|---|---|---|
| 1 | 21 | 1 | 1 | −1.2 |
| 41 | 46 | 1 | 21 | 20000. |
| 20 | | | | −1.2 |
| 21 | | | | 0. |
| 61 | | | | 0. |
| 31 | | | | −1.2 |
| 41 | | | | 20000. |
| 46 | | | | 20000. |
| 91 | | | | 3000. |
| 1 | | | | 3000. |
| 61 | | | | 3000. |

| | |
|---|---|
| x8.con | |
| Time step factor | 0.3 |
| Rays | 490 |

TABLE III

| | Dac: 1 mm | | Dac: 3 mm | | Dac: 5.5 mm | |
|---|---|---|---|---|---|---|
| Rc | Ie(Emax) | Ie(Bmax) | Ie(Emax) | Ie(Bmax) | Ie(Emax) | Ie(Bmax) |
| 15 | 0.381 | 0.3834 | 0.07 | 0.0748 | 0.0202 | 0.0286 |
| 30 | 1.4 | 1.42 | 0.268 | 0.285 | 0.0829 | 0.0981 |
| 60 | 5.65 | 5.72 | 1.08 | 1.26 | 0.288 | 0.404 |
| 120 | 10.75 | 12.1 | 3.76 | 4.42 | 1.21 | 1.75 |
| 240 | 14.64 | 16 | 6.26 | 10.2 | 3.92 | 5.67 |
| 480 | 22.33 | 24.86 | 11.5 | 17.3 | 9.29 | 13.29 |
| 960 | 31.6 | 38.61 | 21.2 | 34.7 | 12.7 | 26 |

TABLE 1V

| | Rc | | | | | |
|---|---|---|---|---|---|---|
| | 960 μm | | 15 μm | | 120 μm | |
| 1/(Dac) | Ie(Bmax) | Ie(Emax) | Ie(Bmax) | Ie(Emax) | Ie(Bmax) | Ie(Emax) |
| 0.1666 | 24.8 | 10.85 | 0.0207 | 0.0188 | 1.5 | 0.965 |
| 0.2 | 27.4 | 14.8 | 0.0244 | 0.0282 | 2.02 | 1.43 |
| 0.25 | 33.3 | 20.2 | 0.0455 | 0.0436 | 2.77 | 2.31 |
| 0.333 | 39.8 | 22.6 | 0.0749 | 0.0705 | 4.4 | 3.76 |
| 0.5 | 43.5 | 22.2 | 0.157 | 0.148 | 7.57 | 6.66 |

TABLE V
High Brightness Gun 20ff.dat 4.5 kV

| | |
|---|---|
| Cathode | |
| Region | 22 61 |
| Temperature | 1800 |
| Work function | 2.35 |
| Richardson constant | 43 |
| Space Charge | on |
| Rays | 15 |
| Cycles | 30 |
| Time step factor | 0.33 |
| Convergence | 0.002 |
| Save Trajectories | on |
| Relativity | on |
| Rotational Symmetry | |
| Mesh | |

| | 1 | 5 | 71 | 81 | 89 | 201 |
|---|---|---|---|---|---|---|
| 1 | 1.4 | 1.42 | 2. | 2.2 | 3. | 20. |
| 20 | 0.8 | .85 | 2. | 2.2 | 3. | 20. |
| 22 | 0.8 | .85 | 2. | 2.2 | 3. | 20. |
| 61 | 0.8 | .85 | 2. | 2.2 | 3. | 20. |
| | 1 | 5 | 71 | 81 | 89 | 201 |
| 1 | 10.5 | 10.5 | 10.5 | 10.5 | 10.5 | 10.5 |
| 20 | .3 | .31 | .42 | .42 | .5 | .5 |
| 22 | .2 | .21 | .4 | .2 | .48 | .48 |
| 61 | 0. | 0. | 0. | 0. | 0. | 0. |
| | 1 | 5 | 71 | 81 | 89 | 201 |
| 1 | 0. | 0. | 0. | 0. | 0. | 0. |
| 20 | 0. | 0. | 0. | 0. | 0. | 0. |
| 22 | 0. | 0. | 0. | 0. | 0. | 0. |
| 61 | 0. | 0. | 0. | 0. | 0. | 0. |
| | 1 | 5 | 71 | 81 | 89 | 201 |
| 1 | 0. | 0. | 0. | 0. | 0. | 0. |
| 20 | 0. | 0. | 0. | 0. | 0. | 0. |
| 22 | 0. | 0. | −2 | 0. | 0. | 0. |
| 61 | 0. | 0. | 0. | 0. | 0. | 0. |

| 1 | 1 | 1 | 20 | −641. |
|---|---|---|---|---|
| 71 | 89 | 1 | 22 | 4500. |
| 20 | | | | −641. |
| 22 | | | | 0. |
| 61 | | | | 0. |
| 61 | | | | 4500. |
| 201 | | | | 4500. |
| 1 | | | | 4500. |
| 61 | | | | 4500. |

| | |
|---|---|
| 20ff.con | |
| Time step factor | 0.3 |
| Rays | 90 |

TABLE VI
Title High Brightness Gun 8ff.dat 4.5 kv

| | |
|---|---|
| Cathode | |
| Region | 22 61 |
| Temperature | 1800 |
| Work function | 2.36 |
| Richardson constant | 60 |
| Space Charge | on |
| Rays | 15 |
| Cycles | 30 |
| Time step factor | 0.33 |
| Convergence | 0.002 |
| Save Trajectories | on |
| Relativity | on |
| Rotational Symmetry | |
| Mesh | |

| | 1 | 5 | 41 | 71 | 81 | 141 | 201 |
|---|---|---|---|---|---|---|---|
| 1 | 1.4 | 1.42 | 2. | 2.2 | 3.6 | 18.4 | 35 |
| 20 | .8 | .85 | 2. | 2.2 | 3.6 | 18.4 | 35. |
| 22 | .8 | .85 | 2. | 2.2 | 3.6 | 18.4 | 35. |
| 61 | .8 | .85 | 2. | 2.2 | 3.6 | 18.4 | 35. |
| | 1 | 5 | 41 | 71 | 81 | 141 | 201 |
| 1 | 1. | 1. | 1. | 1. | 1. | 1. | 1. |
| 20 | .1 | .11 | .42 | .22 | .3 | .3 | .3 |
| 22 | .08 | .09 | .4 | .2 | .28 | .28 | .28 |
| 61 | 0. | 0. | 0. | 0. | 0. | 0. | 0. |
| 1 | 0. | 0. | 0. | 0. | 0. | 0. | 0. |
| 20 | 0. | 0. | 0. | 0. | 0. | 0. | 0. |
| 22 | 0. | 0. | 0. | 0. | 0. | 0. | 0. |
| 61 | 0. | 0. | 0. | 0. | 0. | 0. | 0. |
| 1 | 0. | 0. | 0. | 0. | 0. | 0. | 0. |
| 20 | 0. | 0. | 0. | 0. | 0. | 0. | 0. |
| 22 | 0. | 0. | −.2 | 0. | 0. | 0. | 0. |
| 61 | 0. | 0. | 0. | 0. | 0. | 0. | 0. |

| 1 | 1 | 1 | 20 | 10.2 |
|---|---|---|---|---|
| 41 | 81 | 1 | 22 | 4500. |
| 111 | 116 | 1 | 22 | 4500. |
| 121 | 126 | 1 | 22 | 14000. |
| 131 | 136 | 1 | 22 | 4500. |
| 20 | | | | 10.2. |
| 22 | | | | 0. |
| 61 | | | | 0. |
| 41 | | | | 4500. |
| 116 | | | | 4500. |
| 121 | | | | 14000. |
| 126 | | | | 14000. |
| 131 | | | | 4500. |
| 201 | | | | 4500. |
| 1 | | | | 4500. |
| 61 | | | | 4500. |

1. An electron gun consists of a cathode, a convex anode or a beam drawing electrode, and a truncated cone wehnelt, wherein;
a distance between the cathode and the anode or the beam drawing electrode is Dac (mm) and an emission current Ie (mA) is controlled in the following range;
0.388/Dac−0.046≦Ie≦92.8/Dac+9.28, where Dac≧3 mm, or
0.388/Dac−0.046≦Ie≦22/Dac+32.7, where Dac<3 mm.

2. The electron gun of claim 1, wherein
said emission current is controlled in the following range;
0.388/Dac−0.046≦Ie≦17.8/Dac−1.51.

3. The electron gun of claim 1, wherein
said emission current is controlled in the following range;
17.3/Dac−1.99≦Ie≦92.8/Dac+9.28, where Dac≧3 mm, or
17.3/Dac−1.99≦Ie≦22/Dac+32.7, where Dac<3 mm.

4. The electron gun of claim 1, wherein
said emission current is controlled in the following range;
0.388/Dac−0.046≦Ie≦117/Dac−8.35, where Dac≧4 mm, or
0.388/Dac−0.046≦Ie≦12/Dac+17.8, where Dac<4 mm.

5. The electron gun of claim 1, wherein
said emission current is controlled in the following range;
0.388/Dac−0.046≦Ie≦17.3/Dac−1.99.

6. The electron gun of claim 1, wherein
the anode hole size is smaller than the beam size at the anode hole position, and
the alignment between the wehnelt and the anode is estimated by the transmission efficiency of the anode.

7. The electron gun of claim 1, wherein
said wehnelt is designed as follows, suppose a first cone which has a top at a cross point an optical axis and the anode surface, and a bottom coincide with the cathode edge; and a second cone whose cone angle is 69.4 degrees larger than that of the first cone, and its cathode side coincide with the first cone. Outside of the second cone the wehnelt is deposited.

8. An electron gun consist of a cathode of which radius is Rc (μm), a flat anode or beam drawing electrode and a wehnelt, wherein
an emission current Ie (mA) is controlled in the range as follows,
0.4+0.0064Rc≦Ie≦0.116Rc, where Rc≦120 μm, or
0.4+0.0064Rc≦Ie≦10.5+0.0296Rc, where Rc>120 μm.

9. The electron gun of claim 8, wherein
an electric field between the cathode and the anode is from 1.6 to 5.53 kV/mm.

10. The electron gun of claim 8, wherein
said emission current Ie is controlled in the range as follows,
2.6+0.0254Rc≦Ie≦10.5+0.0296Rc, where Rc>120 μm, or
2.6+0.0254Rc≦Ie≦0.116Rc, where Rc≦120 μm.

11. The electron gun of claim 8, wherein
said emission current Ie is controlled in the range as follows,
0.4+0.0064Rc≦Ie≦2.6+0.0254Rc.

12. The electron gun of claim 8, wherein
Said cathode radius is larger than 20 μm and smaller than 500 μm.

13. The electron gun of claim 8, wherein
said cathode is flat or convex or concave spherical shape whose radius of curvature is larger than 1.5 mm, and wherein the cathode radius is from 20 to 500 μm, and a distance from the cathode to the anode is from 0.8 to 3 mm.

14. An electron gun consist of a concave cathode of which radius of curvature is Rcc (mm), a convex anode or beam drawing electrode of which radius of curvature is Rac (mm), wherein a distance from the cathode to the anode: Dac (mm) satisfy the following relation; that is,
1.1Dac≦Rcc≦0.933(Dac+Rac).

15. The electron gun of claim 14, wherein
an emission current Ie (A) is controlled in the range as,
0.733Rc−0.5−Ie≦0.159Rc³+0.35, where Rc≦2.5 mm, or
0.733Rc−0.5≦Ie≦0.255Rc³−1.17, where Rc>2.5 mm.

16. The electron gun of claim 14, wherein
an emission current is controlled in the range as,
0.733Rc−0.5≦Ie≦0.132R³−0.059

17. The electron gun of claim 14, wherein
trajectories started normally from the central part of the cathode don't cross to the optical axis from the cathode to a minimum beam diameter.

18. The electron gun of claim 14, wherein
the anode or the beam drawing electrode traps more than 70 percent of the emission current.

19. The electron gun of claim 14, wherein
Said cathode is a photo cathode whose work function is Φw, wherein said cathode is excited by the laser beam and wherein
hλ/C−Φw≦0.2 eV.

20. The electron gun of claim 14, wherein
said wehnelt is a truncated double cone shape or a truncated cone and a flat plate.
